(19) United States
(12) Patent Application Publication
(10) Pub. No.: US 2023/0193038 A1
(43) Pub. Date: Jun. 22, 2023

(54) METHODS OF DIGITAL PRINTING USING MODIFIED INDIGO COMPOUNDS

(71) Applicants: Sudhakar Puvvada, Cary, NC (US); Dennis Scheer, Greensboro, NC (US); Paul Hoertz, Hillsborough, NC (US); VP Jeanswear LP, Greensboro, NC (US)

(72) Inventors: Sudhakar Puvvada, Cary, NC (US); Dennis Scheer, Greensboro, NC (US); Paul Gerard Hoertz, Hillsborough, NC (US)

(21) Appl. No.: 16/956,145

(22) PCT Filed: Dec. 20, 2018
(86) PCT No.: PCT/US2018/066695

§ 371 Date: Jun. 19, 2020

Related U.S. Application Data
(60) Provisional application No. 62/609,060, filed on Dec. 21, 2017.

(51) Int. Cl. C09B 7/02; C09D 11/30; D06P 5/30; D06P 1/22

(52) U.S. Cl. CPC C09B 7/02; C09D 11/30; D06P 5/30; D06P 1/228

(57) ABSTRACT

The present disclosure provides methods for digital printing using modified indigo dye compounds.

### CROSS-REFERENCE TO RELATED APPLICATIONS

This application claims the benefit of U.S. Provisional Patent Application No. 62/609,060, filed Dec. 21, 2017, which is incorporated herein by reference.

### TECHNICAL FIELD

This invention relates to methods of digital printing using modified indigo compounds.

### BACKGROUND

Digital printing of indigo in its soluble form (i.e. leuco-indigo) is innately difficult unless performed under a nitrogen atmosphere. A typical leuco-indigo solution containing indigo, sodium hydroxide, and hydrosulfite could be made stable when it is not agitated in a container such as an inkjet cartridge. However, upon agitation in the presence of air, leuco-indigo is rapidly oxidized by air, forming indigo blue particles. Thus, the leuco-indigo solution could be made stable within a digital printer. However, when the picoliter-sized droplets exit the face of the printhead during the jetting process, rapid oxidation will occur and over time blue solid indigo particles will collect on the printhead, eventually leading to clogs in the printheads and interruptions in the manufacturing process.

On a small scale, the printer or the area within the printer where the ink is jetted onto the fabric could be purged with an inert gas such as nitrogen, carbon dioxide, or argon or printing could occur under a vacuum to eliminate oxygen from the system. However, this is impractical in large-scale digital textile printing systems such as the MS Lario and the like (i.e. multiple fixed print heads in series).

From an ink formulation standpoint, the indigo concentrations (˜10-30%) that are needed to add the depth of shade and color that is needed to reach parity with typical denim fashions using a minimal number of print head passes introduces greater instability issues within the formulation as compared to leuco-indigo.

Alternative approaches use an ink formulations to print indigo pigments directly onto fabric. Given the appropriate indigo formulations with pigment particle sizes that allow for reliable printing through the nozzles of the print heads, indigo can be printed using the Colaris approach. For example, one method is to print indigo formulations that contain curable polymers, analogous to what is currently done in the industry for pigment formulations. In this case, the particles do not penetrate the fibers to a large extent and therefore can wash away quickly, hence the need for adequate curing of the polymer. This type of coating typically alters the handle of the fabric and may not be suitable for printing denim. In other methods, the fabric printed with indigo pigments are padded with a reducing agent such as Rongalit or hydrosulfite (or the like) and then steamed at 100-105° C. This allows the indigo to be converted to leuco-indigo for better penetration into the fibers and better washfastness, ozone resistance, crockfastness, etc.

What is needed in the art are methods of using indigo compounds for digital printing.

### BRIEF DESCRIPTION OF THE DRAWINGS

The present application is further understood when read in conjunction with the appended drawings. For the purpose of illustrating the subject matter, these are shown in the drawings exemplary embodiments of the subject matter; however, the presently disclosed subject matter is not limited to the specific compositions, methods, devices, and systems disclosed. In addition, the drawings are not necessarily drawn to scale.

FIG. 1 is an image of a digitally printed denim sample prepared using an aqueous-based ink containing 12% Compound 8.

FIG. 2 is an image of a digitally printed denim sample prepared using a solvent-based ink containing 20% Compound 8.

FIG. 3 is an image of a digitally printed denim sample prepared using a solvent-based ink containing 40% Compound 8.

### SUMMARY

The disclosure provides methods of digitally printing an image onto a substrate. The methods comprise applying a dye compound to a substrate, the dye compound comprising an indigo derivative, or a salt thereof, having one or more modification over the chemical structure of indigo, wherein the indigo derivative has a water-solubility of greater than 0.2% w/v in the absence of a reducing agent and in the presence oxygen, and converts to indigo upon removing the modification. In some embodiments, the formulation further comprises one or more of a component for digital printing such as an ink. In other embodiments, the methods further comprise additional such as pretreating the substrate, drying the substrate, or hydrolyzing the substrate. In further embodiments, the methods include jetting the dye compound from a digital printer.

The disclosure also provides methods of digitally printing an image onto a substrate. The methods comprise applying a dye compound to a substrate, wherein the dye compound is of Formula (I) or (II), wherein R¹-R⁴, R⁷, R⁸, n, and m are defined herein.

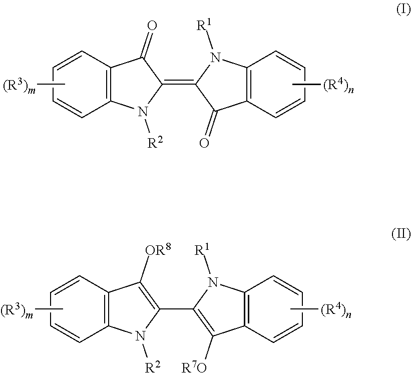

The disclosure further provides printed substrates prepared according to the methods described herein.

The disclosure also provides digital printing inks, comprising (i) water or a solvent and (ii) a dye compound a dye compound provided herein, such as a compound of Formula (I) or (II), wherein R¹-R⁴, R⁷, R⁸, n, and m are defined herein.

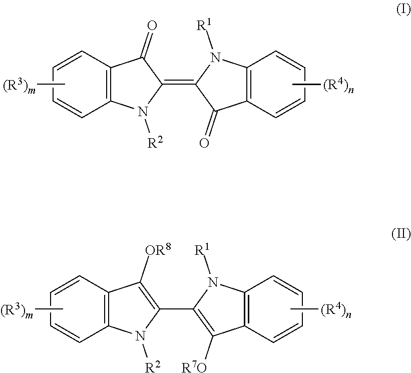

Other aspects and embodiments of the invention will be readily apparent from the following detailed description of the invention.

### DETAILED DESCRIPTION OF ILLUSTRATIVE EMBODIMENTS

Embodiments of the present disclosure are directed to improved methods of digital printing a substrates using a modified indigo compound in place of leuco-indigo. In looking to the digital printing methods in the art, the inventors identified many disadvantages. For example, the current methods can result in rapid oxidation of leuco-indigo under atmospheric conditions and, therefore, can result in penetration of the dye that is less than desirable. Further, the methods in the art can require the use of a reducing agent, pretreatment with thickener that negatively affect the fabric, and/or can require steam to improve penetration of the dye.

In solving these problems, the inventors used modified indigo compounds that can be directly dissolved in digital ink formulations. As a major advantage, digital printing performed using these inks can be performed under normal atmospheric conditions. As such, there are fewer limitations to the content of the ink formulations. For example, the digital ink formulation can be aqueous or solvent. The digital inks may also be ecosolvent based, thus being useful for printing textiles used for signage. The digital inks, thus, do not require auxiliary chemicals such as reducing agents, binders, thickening agents, surfactants, buffers, or pH modifiers. Furthermore, high concentrations of the dye compound can be used the methods and included in the digital inks, thus providing more deeply shaded substrates.

The digital printing application of these inks also is widely preferred. In one example, the digital printing inks described herein may be applied to uncoated fabrics, thereby affording an unaltered handle of the fabric, or natural fabrics that have not been pretreated with bleach or caustic scouring (especially solvent-based inks), thereby precluding the need for unnecessary and costly steps. The use of the modified dye compounds in digital inks also permits the use of less water during the rinsing step as compared with inks in the art and avoids the need for post-treatment steps such as steam treating. In doing so, a truer indigo color may be obtained and a negligible loss of color occurs overall due to color loss during post-processing steps and washing.

In contrast with leuco-indigo, the modified indigo compounds described herein are stable in the presence of oxygen. Accordingly, contact with atmospheric oxygen will not cause the modified indigo compound to convert to indigo. As such, the modified indigo compound is suitable for digital printing using conventional digital printing methods without protecting the dye from contact with atmospheric oxygen, such as through the use of reducing agents or the like.

Preferably, this modification is environmentally friendly and atom efficient. It also may be quickly and completely removable when exposed to a simple reagent or condition in order to leave standard indigo on the fabric.

The oxygen stability of the modified indigo compound renders it highly advantageous for digital printing, in which the dye comes into substantial contact with the atmosphere in which the process is performed. In contrast, the modified indigo compounds may be applied to textiles through digital printing that takes place in air, i.e. without the need for an inert gas environment.

Since the digital printing process preferably comprises printing a fabric with a solution containing the modified indigo compound, stability of the modified indigo compound in a solution is important commercially. Notably, the modified indigo compounds of the present disclosure are capable of remaining in solution for a commercially significant amount of time before substantial conversion to indigo occurs. Further, the inventors observed increased stability for certain solvent-based ink formulations.

In some embodiments, the modified indigo compounds of the present disclosure remain in the ink formulation (at room temperature) for a period of at least five minutes before substantial conversion to water-insoluble indigo occurs. In other embodiments, the modified indigo compounds of the present disclosure remain in a solution for a period of at least ten minutes before substantial conversion to water-insoluble indigo occurs. In further embodiments, the modified indigo compounds of the present disclosure remain in solution for a period of at least thirty minutes before substantial conversion to the water-insoluble indigo compound occurs. In yet other embodiments, the modified indigo compounds of the present disclosure remain in solution for a period of at least one hour before substantial conversion to water-insoluble indigo occurs. In still further embodiments, the modified indigo compounds of the present disclosure remain in solution for a period of at least three hours before substantial conversion to water-insoluble indigo occurs. In other embodiments, the modified indigo compounds of the present disclosure remain in solution for a period of at least ten hours before substantial conversion to water-insoluble indigo occurs. In further embodiments, the modified indigo compounds of the present disclosure remain in solution for a period of at least fifteen hours before substantial conversion to water-insoluble indigo occurs. In yet other embodiments, the modified indigo compounds of the present disclosure remain in solution for a period of at least twenty hours before substantial conversion to water-insoluble indigo occurs. In still further embodiments, the modified indigo compounds of the present disclosure remain in solution for a period of at least one day before substantial conversion to water-insoluble indigo occurs. In other embodiments, the modified indigo compounds of the present disclosure remain in solution for a period of at least one and one-half days before substantial conversion to water-insoluble indigo occurs. In further embodiments, the modified indigo compounds of the present disclosure remain in solution for a period of at least two days before substantial conversion to water-insoluble indigo occurs. In still other embodiments, the modified indigo compounds of the present disclosure remain in solution for a period of at least three days before substantial conversion to water-insoluble indigo occurs. In yet further embodiments, the modified indigo compounds of the present disclosure remain in solution for a period of at least five days before substantial conversion to water-insoluble indigo occurs. In other embodiments, the modified indigo compounds of the present disclosure remain in solution for a period of at least one week before substantial conversion to water-insoluble indigo occurs. In further embodiments, the modified indigo compounds of the present disclosure remain in solution for a period of at least ten days before substantial conversion to water-insoluble indigo occurs. In still further embodiments, the modified indigo compounds of the present disclosure remain in solution for a period of at least two weeks before substantial conversion to water-insoluble indigo occurs. In yet other embodiments, the modified indigo compounds of the present disclosure remain in solution for a period of at least three weeks before substantial conversion to water-insoluble indigo occurs. In further embodiments, the modified indigo compounds of the present disclosure remain in solution for a period of at least one month (i.e. 30 days) before substantial conversion to water-insoluble indigo occurs.

The modified indigo compound may also have improved water solubility relative to conventional leuco-indigo.

The modified indigo compounds of the present disclosure also have increased water solubility when compared to leuco-indigo. Accordingly, digital printing with the modified indigo compound provides a process in which one or more dye can be placed on the fabric per period of contact relative to conventional digital printing methods. In some embodiments, for example, the concentration of the modified indigo compound in an ink may be at least 0.3 wt. %, at least 0.5 wt. %, at least 0.6 wt. %, at least 0.8 wt. %, at least 1 wt. %, at least 2 wt. %, at least 3 wt. %, at least 5 wt. %, at least 10 wt. %, at least 15 wt. %, or at least 20 wt. %.

The improved water solubility of the modified indigo compounds of the present disclosure also simplifies the process by which printing is controlled, and, more particularly, by which the modified indigo compound is maintained at a substantially constant concentration within ink. This, in turn, minimizes the inclusion of additional chemicals, which leads to decreased costs and a lower environmental impact.

As described above, the modified indigo compounds disclosed herein have a beneficial combination of (a) greater oxygen stability than leuco-indigo (such as may be measured at room temperature) and (b) greater water solubility than leuco-indigo (such as may be measured at room temperature). In some embodiments, the modified indigo compounds may further have (c) greater affinity to cotton than leuco-indigo.

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” or “substantially” it will be understood that the particular value forms another embodiment. In general, use of the term “about” or “substantially” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about” or “substantially”. In other cases, the gradations used in a series of values may be used to determine the intended range available to the term “about” or “substantially” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

### I. The Compounds

In solving the problems in the art, the inventors developed modified dye molecules that are likely to bond more strongly to cotton than in current digital printing processes, are soluble in water, can be converted to the ink, i.e., indigo, in one simple step after printing, are cost effective or provide a cost saving over the current process, more stable than leuco-indigo, and/or readily dissolves in water, unlike standard, indigo, and readily converts back to indigo quickly and easily without skying.

The present disclosure provides dye compounds for use in digital printing of substrates. The dye compounds comprise an indigo derivative, or a salt thereof, having one or more modification over the chemical structure of indigo. The inventors found that these compounds convert to indigo via hydrolysis. In some embodiments, hydrolysis is accomplished using a hydrolyzing agent, heat, steam, or combinations thereof. Advantageously, these compounds were found to be substantially stable in the presence of an oxidant such as in aqueous solutions, which property is not shared with leuco-indigo. Preferably, the compounds were found to be substantially stable in the presence of oxygen. These compounds were also found to be more stable in the air than other indigo derivatives such as leuco-indigo.

The term “substantially stable” refers to the ability of the compound to maintain its structure and properties thereof. In some embodiments, a compound's stability is maintained without being reduced, oxidized, or reacting with another component of the formulation or method discussed herein. In other embodiments, the compound is stable since it maintains its water solubility. In further embodiments, the compound is stable since it does not convert to indigo. Desirably, less than about 50 wt. %, such as less than about 45, less than about 40, less than about 35, less than about 30, less than about 25, less than about 20, less than about 15, less than about 10, or less than about 5 wt. % of the compound in a solution degrades under atmospheric conditions over a period of about 12 hours in the absence of a reducing agent. Degradation can be measured using any analytical technique which is capable of quantifying a chemical compound including, without limitation, gas chromatography, UV-visible spectrophotometry, nuclear magnetic resonance, mass spectroscopy, or combinations thereof. In some embodiments, about 0.001 to about 50 wt. % of the compound, about 0.001 to about 45, about 0.001 to about 40, about 0.001 to about 35, about 0.001 to about 30, about 0.001 to about 25, about 0.001 to about 20, about 0.001 to about 15, about 0.001 to about 10, or about 0.001 to about 5 wt. % of the compound in a solution degrades under atmospheric conditions over a period of about 12 hours in the absence of a reducing agent. In further embodiments, 0.001 to about 5 wt. % of the compound in a solution degrades under atmospheric conditions over a period of about 12 hours in the absence of a reducing agent.

The inventors also found that the compounds described herein have greater water solubility than indigo. In some embodiments, the dye compounds have a water solubility of about 0.2% w/v or greater. In preferred embodiments, the water solubility is about 0.2% w/v or greater in the absence of a reducing agent. In other preferred embodiments, the water solubility is about 0.2% w/v or greater in the presence of oxygen. In yet further embodiments, the water solubility is about 10 to about 100%, about 20 to about 100, about 30 to about 100, about 40 to about 100, about 50 to about 100, about 60 to about 100, about 70 to about 100, about 80 to about 100, about 90 to about 100, about 95 to about 100, about 98 to about 100, about 99 to about 100, or about 100 w/v. The water solubility of the compounds described herein may be measured using techniques known to those skilled in the art including, without limitation, dissolution with agitation, followed by filtration of centrifugation to isolate the soluble solids. The insoluble solids are then dried and weighed and the solubility calculated.

The term “indigo” as used herein refers to the following compound.

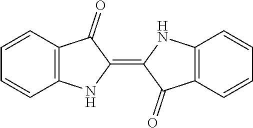 [SMILES: O=C1/C(=C2\Nc3ccccc3C2=O)Nc2ccccc21]

Similarly, the term “leuco-indigo” is used interchangeably with “indigo white” and refers to the following compound. In some embodiments, leuco-indigo exists in the neutral form.

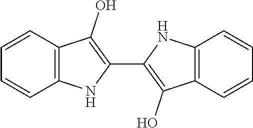 [SMILES: Oc1c(-c2[nH]c3ccccc3c2O)[nH]c2ccccc12]

Leuco-indigo may also exist in a deprotonated form, such as a form which is deprotonated on one or both oxygen atoms. Thus, the term “leuco-indigo” can include the mono-anionic and di-anionic forms including the monosodium, monopotassium, monolithium, disodium, dipotassium, or dilithium analogs of the following:

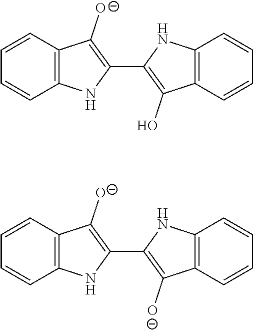 [SMILES: [O-]c1c(-c2[nH]c3ccccc3c2O)[nH]c2ccccc12 ; [O-]c1c(-c2[nH]c3ccccc3c2[O-])[nH]c2ccccc12]

Thus, the one or more modification is designed to enhance the aqueous solubility of the dye derivative lacking the modification. The term, “enhance” as used herein refers to improving the solubility to the dye derivative lacking the modification, improving the affinity of the indigo compound to a substrate, as defined herein, providing an indigo compound that converts to indigo upon removing the modification, or combinations thereof. In some embodiments, the modification is removed by hydrolysis.

In some embodiments, the modification enhances the aqueous water-solubility of the indigo derivative. The modification is made at any position on the indigo backbone or the indigo derivative. In some embodiments, one or more modification is a substituent on indigo or the indigo derivative. In other embodiments, the substituent is on one or more carbon atom. In further embodiments, the substituent is on one or both nitrogen atom. In yet other embodiments, the substituent is on one or both oxygen atoms. The modification may be selected by one skilled in the art and includes, without limitation, acyl, alkyl, alkoxy, amide, amine, anhydride, aryl, carbamate, CN, cycloalkyl, ester, halide, heteroaryl, heterocyclyl, imine, mesylate, NO₂, oxime, sulfonate, tosylate, or urea, wherein each substituent is optionally substituted. In some embodiments, the modification results in an indigo compound which is rotationally symmetrical about an axis. In other embodiments, the modification results in an indigo compound which is rotationally asymmetrical about an axis. However, the modification results in a dye compound that is not the methylsulfonate salt of (E)-3,3′-(3,3′-dioxo-[2,2′-biindoline-1,1′-diyl]-1,1′-dicarbonyl)bis(1-methylpyridin-1-ium).

The term “wt. %” or “weight %” as used herein refers to the weight of the referenced compound based on the total weight of the solution. For example, the amount of Compound A in a solution contain 0.01 wt. % of Compound A is based on the based on the total weight of the components in the solution.

The term “alkyl” is used herein to refer to both straight- and branched-chain saturated aliphatic hydrocarbon groups. In one embodiment, an alkyl group has 1 to about 10 carbon atoms, i.e., C₁₋₁₀alkyl. In another embodiment, an alkyl group has 1 to about 6 carbon atoms, i.e., C₁₋₆alkyl. In a further embodiment, an alkyl group has 1 to about 4 carbon atoms, i.e., C₁₋₄alkyl. The alkyl may be unsubstituted or substituted as described herein. The substitution may be on any carbon-atom, as permitted by the stability and valency of the substituent. In some examples, the alkyl is a methyl, ethyl, propyl, butyl, pentyl, hexyl, heptyl, octyl, nonyl, or decyl.

The term “alkoxy” as used herein refers to the O-(alkyl) group, where the point of attachment is through the oxygen-atom and the alkyl group is defined above. In some examples, the alkyl is a methoxy, ethoxy, propoxy, butoxy, pentoxy, hexoxy, heptoxy, octoxy, nonoxy, or decoxy.

“Ester” refers to a —COOR group and is bound through the C-atom. R includes, but is not limited to, alkyl, cycloalkyl, aryl, heteroaryl, or heterocyclyl.

“Acyl” refers to a —C(O)R group which is bound through the C-atom. R includes, but is not limited to, alkyl, cycloalkyl, aryl, heteroaryl, or heterocyclyl.

“Carboxyl” refers to a —C(O)OH group which is bound through the C-atom.

“Amine” refers to —NH₂, —NHR, or —NR₂ which is bound through the N-atom. Each R, independently, includes, but is not limited to, alkyl, cycloalkyl, aryl, heteroaryl, or heterocyclyl.

“Amide” refers to a —C(O)NR₂ group which is bound through the C-atom. Each R, independently, includes, but is not limited to, H, alkyl, cycloalkyl, aryl, heteroaryl, or heterocyclyl.

“Sulfate” refers to a —SO₃R group which is bound through the S-atom. Each R includes, but is not limited to, H, alkyl, cycloalkyl, aryl, heteroaryl, or heterocyclyl.

“Sulfonate” refers to a —SO₂R group which is bound through the S-atom. Each R includes, but is not limited to, H, alkyl, cycloalkyl, aryl, heteroaryl, or heterocyclyl.

“Carbamate” refers to a —OC(O)NR₂ group which is bound through the O-atom. Each R, independently, includes, but is not limited to, H, alkyl, cycloalkyl, aryl, heteroaryl, or heterocyclyl.

“Urea” refers to a —NRC(O)NR₂ group which is bound through the N-atom. Each R, independently, includes, but is not limited to, H, alkyl, cycloalkyl, aryl, heteroaryl, or heterocyclyl.

“Imine” refers to a —C(R)═NR group which is bound through the C-atom. R includes, but is not limited to, H, alkyl, cycloalkyl, aryl, heteroaryl, or heterocyclyl.

“Oxime” refers to a —C(R)═NOH group which is bound through the C-atom. R includes, but is not limited to, H, alkyl, cycloalkyl, aryl, heteroaryl, or heterocyclyl.

“Thioether” refers to a —SR group which is bound through the C-atom. R includes, but is not limited to, H, alkyl, cycloalkyl, aryl, heteroaryl, or heterocyclyl.

“Anhydride” refers to a —C(O)OC(O)R which is bound through the C-atom. R includes, but is not limited to, H, alkyl, cycloalkyl, aryl, heteroaryl, or heterocyclyl.

The term “halogen” are “halide” are used interchangeably and refer to Cl, Br, F, or I groups.

“Cycloalkyl” refers to a monocyclic or polycyclic radical that contains carbon and hydrogen, and may be saturated or partially unsaturated. In some embodiments, cycloalkyl groups include 3 to about 12 ring atoms, i.e., C₃₋₁₂cycloalkyl. In other embodiments, cycloalkyl groups include 3 to about 8 ring atoms, i.e., C₃₋₈cycloalkyl. In further embodiments, cycloalkyl groups include 5 to about 7 ring atoms, i.e., C₅₋₇cycloalkyl. Examples of cycloalkyl groups include, but are not limited to cyclopropyl, cyclobutyl, cyclopentyl, cyclopentenyl, cyclohexyl, cyclohexenyl, cycloheptyl, cyclooctyl, cyclononyl, cyclodecyl, norbornyl, and the like. The cycloalkyl may be unsubstituted or substituted as described herein. The substitution may be on any carbon-atom, as permitted by the stability and valency of the substituent.

“Heterocyclyl” refers to a saturated ring that comprises 3 to 12 carbon atom, i.e., C₃₋₁₂heterocyclyl, and from 1 to 6 heteroatoms which are nitrogen, oxygen or sulfur. The heterocyclyl is a monocyclic, bicyclic, tricyclic or tetracyclic ring, which may include fused or bridged ring systems. The heteroatoms in the heterocyclyl may be optionally oxidized. The heterocyclyl may be attached to the rest of the molecule through any atom of the ring(s). In some embodiments, the heterocyclyl has 3 to about 18 ring atoms. In some embodiments, heterocyclyl groups include 4 to about 8 ring atoms. In other embodiments, heterocyclyl groups include 5 to about 7 ring atoms. In some preferred embodiments, the heterocyclyl includes, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, monosaccharidyl such as tetrahydropyranyl (glucose), thiomorpholinyl, thiamorpholinyl, 1-oxo-thiomorpholinyl, and 1,1-dioxo-thiomorpholinyl. The heterocyclyl may be unsubstituted or substituted as described herein. The substitution may be on a carbon-atom or heteroatom, as permitted by the stability and valency of the substituent.

The term “aryl” refers to 6-15 membered monocyclic, bicyclic, or tricyclic hydrocarbon ring systems, including bridged, spiro, and/or fused ring systems, in which at least one of the rings is aromatic. An aryl group may contain 6 (i.e., phenyl) or about 9 to about 15 ring atoms, such as about 6 to about 8 ring atoms or about 9 to about 11 ring atoms. In some embodiments, aryl groups include, but are not limited to, naphthyl, indanyl, indenyl, anthryl, phenanthryl, fluorenyl, 1,2,3,4-tetrahydronaphthalenyl, 6,7,8,9-tetrahydro-5H-benzocycloheptenyl, and 6,7,8,9-tetrahydro-5H-benzocycloheptenyl. The aryl may be unsubstituted or substituted as described herein. The substitution may be on any carbon-atom, as permitted by the stability and valency of the substituent.

The term “aryloxy” as used herein refers to the O-(aryl) group, where the point of attachment is through the oxygen-atom and the aryl group is defined above. In some examples, the alkyl is a phenoxy or naphthoxy.

“Heteroaryl” refers to a 5- to 18-membered unsaturated or partially unsaturated radical (e.g., C₅₋₁₃heteroaryl) that includes one or more ring heteroatoms selected from nitrogen, oxygen and sulfur. In some embodiments, the heteroaryl is monocyclic, bicyclic, tricyclic or tetracyclic. In other embodiments, the heteroatom(s) in the heteroaryl are optionally oxidized. The heteroaryl may be attached to the rest of the molecule through any atom of the ring(s). In some embodiments, the heteroaryl has 3 to about 18 ring atoms. In some embodiments, heteroaryl groups include 4 to about 8 ring atoms. In other embodiments, heteroaryl groups include 5 to about 7 ring atoms. Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl (benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pyridinyl, and thiophenyl (i.e. thienyl). In some embodiments, the heteroaryl is pyridyl. In other embodiments, the heteroaryl is imidazole. The heteroaryl may be unsubstituted or substituted as described herein. The substitution may be on a carbon-atom or heteroatom, as permitted by the stability and valency of the substituent. For example, one N-atom of an imidazole may be substituted. Further, any available carbon-atom may be doubly bonded to an oxygen, i.e., the carbon-atom contains an oxo (═O) group or formyl group (CH═O).

“Substituted” means that the referenced group may have one or more additional groups, radicals or moieties attached. Such groups include, independently, alkyl, cycloalkyl, aryl, heteroaryl, heterocyclyl, alkoxy, aryloxy, OH, CN, halide, NO₂, SO₃R (where R is H, halide, alkyl, aryl, cycloalkyl, heteroaryl, or heterocyclyl) such as SO₃H or SO₃Cl, C(O)OR (where R is H, alkyl, aryl, cycloalkyl, heteroaryl, or heterocyclyl), OC(O)OR (where R is H, alkyl, aryl, cycloalkyl, heteroaryl, or heterocyclyl) such as OCO₂alkyl, OC(O)R (where R is H, alkyl, aryl, cycloalkyl, heteroaryl, or heterocyclyl) such as OC(O)alkyl, PO₃R₂ (where R is H, alkyl, aryl, cycloalkyl, heteroaryl, or heterocyclyl), NR₂ (where R is H, alkyl, aryl, cycloalkyl, heteroaryl, or heterocyclyl), or a quaternary amine such as R═(CH₂)_{z}N⁺(R¹⁰)₃X⁻, wherein z is 1 or greater (such as z is 1 to 10, 1 to 5, 2 to 10, 2 to 8, or 1, 2, 3, 4, 5, 6, 7, 8, 9, or 10), R¹⁰ is H, alkyl, aryl, cycloalkyl, heteroaryl, or heterocyclyl, and X is a counteranion as described herein. Examples of R═(CH₂)_{z}N⁺(R¹⁰)₃X⁻ include, without limitation, R¹⁰—N(CH₃)₃, R¹⁰—N(CH₂CH₃)₃, R¹⁰—NH(CH₃)₂, R¹⁰—NH(CH₂CH₃)₂, R¹⁰—NH₂CH₃, R¹⁰—NH₂(CH₂CH₃), or R¹⁰—NH₃. The substituents themselves may be substituted, for example, a cycloalkyl substituent may itself have a halide substituent at one or more of its ring carbons. In some embodiments, the substituents noted above may be further substituted with NR₃ (where R is H, OH, alkyl, aryl, cycloalkyl, heteroaryl, or heterocyclyl) such as N(CH₃)₃ or the like. For example, the substituent may be betainyl (OC(O)CH₂N(CH₃)₃), cholinyl (OCH₂CH₂N(CH₃)₃), or carnitinyl (OC(O)CH₂CH(OH)CH₂N(CH₃)₃). The term “optionally substituted” means optional substitution with the specified groups, radicals or moieties.

As used herein, the term “counteranion” as used herein refers to an anion which balances the charge of the base molecule. In some embodiments, any anion which provides a stable salt may be selected. In other embodiments, the anion is acetate, propionate, lactate, citrate, tartrate, succinate, fumarate, maleate, malonate, mandelate, phthalate, Cl, Br, I, F, phosphate, nitrate, sulfate, methanesulfonate, ethanesulfonate, phosphonate, naphthalenesulfonate, benzenesulfonate, toluenesulfonate, camphorsulfonate, methanesulfate, ethanesulfate, naphthalenesulfate, benzenesulfate, toluenesulfate, camphorsulfate, bisulfate, sulfite, or bisulfite.

In other aspects, the indigo compounds have an affinity to a substrate, as defined herein. The term “affinity to a substrate” as used herein refers to the ability of the dye compound to dye a substrate as described herein as well as leuco-indigo. In some embodiments, the affinity of the indigo compounds to a textile is equal to or within a factor of about 2 to about 3 compared with leuco-indigo. In some embodiments, the affinity is to a textile such as cotton. Such measurements may be made by quantifying the indigo content using post-treatment methods such as sodium hydrosulfite, followed by UV-Vis spectrophotometry as described in Hauser, Improved Determination of Indigo, Textile Chemist and Coloris & American Dyestuff Reporter, 32(2):33, December 2000, which is incorporated herein by reference.

In further aspects, the indigo compounds convert to indigo upon removing the modification.

In yet other aspects, the indigo compound is not:
(i) N,N′-dinicotinoyl-[2,2′-biindolinylidene]-3,3′-dione;
(i) the N″,N′″-methylpyridinium bis(methylsulfate) salt of N,N′-dinicotinoyl-[2,2′-biindolinylidene]-3,3′-dione;
(iii) N,N′-diacetyl-[2,2′-biindolinylidene]-3,3′-dione;
(iv) N,N′-dipropionyl-[2,2′-bi-indolinylidene]-3,3′-dione;
(v) N,N′-di-isobutyryl-[2,2′-biindolinylidene]-3,3′-dione;
(vi) N,N′-dipivaloyl-[2,2′-biindolinylidene]-3,3′-dione;
(vii) N,N′-bis(cyclohexylcarbonyl)-2,2′-bi-indolinylidene-3,3′-dione;
(viii) N,N′-bis(3-phenylpropionyl)-2,2′-bi-indolinylidene-3,3′-dione;
(ix) N,N′-bis(ethoxycarbonylacetyl)-2,2′-bi-indolinylidene-3,3′-dione;
(x) N,N′-bis(2-phenylacetyl)-[2,2′-bi-indolinylidene]-3,3′-dione;
(xi) N,N′-bis-(p-methoxyphenylacetyl)2,2′-bi-indolinylidene-3,3′-dione;
(xii) N,N′-bis(1-naphthylacetyl)-2,2′-bi-indolinylidene-3,3′-dione;
(xiii) N,N′-bis(2-phenylbutyryl)-2,2′-indolinylidene-3,3′-dione; or
(xiv) (E)-1,1′-di(adamantane-1-carbonyl)-[2,2′-biindolinylidene]-3,3′-dione.

Thus, in some embodiments, the compound is of Formula (I) or a salt thereof.

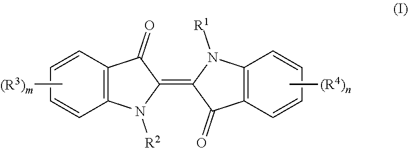

R¹ and R² may be the same or differ. In some embodiments, one of R¹ and R² is H. In further embodiments, one of R¹ and R² is SO₃H.

R¹ and R² may be, independently, H, SO₃R^{C}, SO₂R^{C}, PO₃(R^{C})₂, C(O)-(optionally substituted C₁₋₉glycolyl), C(O)-(optionally substituted C₁₋₆alkyl), C(O)-(optionally substituted C₁₋₆hydroxyalkyl), C(O)O-(optionally substituted C₁₋₉glycolyl), C(O)-(optionally substituted heteroaryl), C(O)-(optionally substituted aryl), C(O)-(optionally substituted heterocyclyl), C(O)NR^{A}R^{B}, C(O)O-(optionally substituted C₁₋₆alkyl), C(O)O-(optionally substituted C₁₋₆hydroxyalkyl), C(O)O-(optionally substituted heteroaryl), C(O)O-(optionally substituted aryl), or C(O)O-(optionally substituted heterocyclyl). In some embodiments, R¹ and R² are, independently, H, SO₃R^{C}, SO₂R^{C}, PO₃(R^{C})₂, C(O)-(optionally substituted C₁₋₉glycolyl), C(O)-(optionally substituted C₁₋₆hydroxyalkyl), C(O)-(optionally substituted C₁₋₉glycolyl), C(O)-(optionally substituted aryl), C(O)-(optionally substituted heterocyclyl), C(O)NR^{A}R^{B}, C(O)O-(optionally substituted C₁₋₆alkyl), C(O)O-(optionally substituted C₁₋₆hydroxyalkyl), C(O)O-(optionally substituted heteroaryl), C(O)O-(optionally substituted aryl), or C(O)O-(optionally substituted heterocyclyl).

In some embodiments, R¹ is C(O)-(optionally substituted alkyl) such as C(O)(C₁₋₆alkyl substituted with an ester such as C(O)—(C₁₋₆alkoxy) or C(O)(C₁₋₆alkyl substituted with aryl such.

In other embodiments, R¹ is C(O)-(optionally substituted alkyl) such as C(O)(C₁₋₆alkyl substituted with an ester such as C(O)methoxy, C(O)propoxy, C(O)butoxy, C(O)pentoxy, or C(O)hexoxy) or C(O)(C₁₋₆alkyl substituted with an aryl such as phenyl substituted with alkyl, cycloalkyl, aryl, heteroaryl, heterocyclyl, alkoxy, aryloxy, OH, CN, or halide, substituted naphthyl, indanyl, indenyl, anthryl, phenanthryl, fluorenyl, 1,2,3,4-tetrahydronaphthalenyl, 6,7,8,9-tetrahydro-5H-benzocycloheptenyl, or 6,7,8,9-tetrahydro-5H-benzocycloheptenyl; C(O)—(C₃₋₆alkyl such as n-propyl, n-butyl, i-butyl, pentyl, or hexyl). In further embodiments, R¹ is C(O)NR^{A}R^{B}, where R^{A} and R^{B} are, independently, H, optionally substituted C₁₋₆alkyl, optionally substituted C₁₋₆hydroxyalkyl, or optionally substituted aryl. In still other embodiments, R¹ is C(O)-(optionally substituted heteroaryl). In yet further embodiments, R¹ is C(O)O-(optionally substituted heteroaryl). In other embodiments, R¹ is C(O)-(optionally substituted aryl). In further embodiments, R¹ is C(O)O-(optionally substituted aryl). In yet other embodiments, R¹ is C(O)-(optionally substituted heterocyclyl). In other embodiments, R¹ is SO₃H. Preferably, R¹ is C(O)-(optionally substituted pyridyl), such as C(O)-(optionally substituted 2-pyridyl), C(O)-(optionally substituted 3-pyridyl), or C(O)-(optionally substituted 4-pyridyl). In further embodiments, the pyridyl is substituted with one or more C₁₋₆alkyl, such as methyl or ethyl. Preferably, the pyridyl is substituted on the N-atom of the pyridyl ring. In other embodiments, R¹ is C(O)-(optionally substituted aryl) such as C(O)-(optionally substituted phenyl). Preferably, the phenyl of the R¹ group is substituted with one or more SO₃H, SO₃Cl, NO₂, NH₂, OH, halide, alkyl, aryl, cycloalkyl, heteroaryl, or heterocyclyl. In yet further embodiments, R¹ is C(O)NR^{A}R^{B}, wherein one or both of R^{A} and R^{B} is H, optionally substituted C₁₋₆hydroxyalkyl such as methylhydroxy, ethylhydroxy, propylhydroxy, butylhydroxy, pentylhydroxy, or hexylhydroxy, or optionally substituted C₁₋₆alkyl such as CH₂C(O)OH, CH₂CH₂C(O)OH, CH₂CH₂CH₂C(O)OH. In still other embodiments, R¹ is C(O)O-(optionally substituted heterocyclyl) such as C(O)O-(optionally substituted succinic anhydride). In further embodiments, R¹ is C(O)O-(optionally substituted alkyl) such as C(O)O(alkyl substituted with heterocyclyl) such as C(O)O(alkyl substituted with a monosaccharide such as glucosyl). In other embodiments, R¹ is C(O)(optionally substituted C₁₋₆hydroxyalkyl) such as C(O)CH₂OH, C(O)CH₂CH₂OH, C(O)CHOHCH₂OH, C(O)CH₂CHOHCH₃, or C(O)CH₂CHOHCH₂OH. In yet other embodiments, R¹ is C(O)O(optionally substituted C₁₋₆hydroxyalkyl) such as C(O)OCH₂OH, C(O)OCH₂CH₂OH, C(O)OCHOHCH₂OH, C(O)OCH₂CHOHCH₃, or C(O)OCH₂CHOHCH₂OH. In further embodiments, R¹ is C(O)O(optionally substituted C₁₋₉glycol) such as C(O)OCH₂CH₂OCH₃, C(O)(OCH₂CH₂)₂OCH₃, or C(O)(OCH₂CH₂)₃OCH₃. In still further embodiments, R¹ is SO₃R^{C}, where R^{C} is H, OH, optionally substituted C₁₋₆alkyl, optionally substituted C₃₋₈cycloalkyl, optionally substituted aryl, optionally substituted heteroaryl, or optionally substituted heterocyclyl such as H, OH, optionally substituted C₁₋₆alkyl, or optionally substituted aryl. For example, R^{C} in SO₃R^{C} is OH. In other embodiments, R¹ is SO₂R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₂R^{C} is aryl substituted with C(O)OH.

In some embodiments, R² is C(O)-(optionally substituted alkyl) such as C(O)(C₁₋₆alkyl substituted with an ester such as C(O)C₁₋₆alkoxy). In other embodiments, R² is C(O)-(optionally substituted alkyl) such as C(O)(C₁₋₆alkyl substituted with an ester such as C(O)methoxy, C(O)propoxy, C(O)butoxy, C(O)pentoxy, or C(O)hexoxy) or C(O)(C₁₋₆alkyl substituted with an aryl such as (phenyl substituted with alkyl, cycloalkyl, aryl, heteroaryl, heterocyclyl, alkoxy, aryloxy, OH, CN, or halide), substituted naphthyl, indanyl, indenyl, anthryl, phenanthryl, fluorenyl, 1,2,3,4-tetrahydronaphthalenyl, 6,7,8,9-tetrahydro-5H-benzocycloheptenyl, or 6,7,8,9-tetrahydro-5H-benzocycloheptenyl; C(O)—(C₃₋₆alkyl such as n-propyl, n-butyl, i-butyl, pentyl, or hexyl). In other embodiments, R² is C(O)O-(optionally substituted alkyl). In further embodiments, R² is C(O)NR^{A}R^{B}, where R^{A} and R^{B} are, independently, H or optionally substituted C₁₋₆alkyl, or optionally substituted aryl. In still other embodiments, R² is C(O)-(optionally substituted heteroaryl). In yet further embodiments, R² is C(O)O-(optionally substituted heteroaryl). In other embodiments, R² is C(O)-(optionally substituted aryl). In further embodiments, R² is C(O)O-(optionally substituted aryl). In yet other embodiments, R² is C(O)-(optionally substituted heterocyclyl). In still further embodiments, R² is C(O)O-(optionally substituted heterocyclyl). In other embodiments, R² is SO₃H. Preferably, R² is C(O)-(optionally substituted pyridyl), such as C(O)-(optionally substituted 2-pyridyl), C(O)-(optionally substituted 3-pyridyl), or C(O)-(optionally substituted 4-pyridyl). In further embodiments, the pyridyl is substituted with one or more C₁₋₆alkyl, such as methyl or ethyl. Preferably, the pyridyl is substituted on the N-atom of the pyridyl ring. In other embodiments, R² is C(O)-(optionally substituted aryl) such as C(O)-(optionally substituted phenyl). Preferably, the phenyl of the R² group is substituted with one or more SO₃H, SO₃Cl, NO₂, NH₂, OH, halide, alkyl, aryl, cycloalkyl, heteroaryl, heterocyclyl and as substituents. In yet further embodiments, R² is C(O)NR^{A}R^{B}, wherein one or both of R^{A} and R^{B} is H, optionally substituted C₁₋₆hydroxyalkyl such as methylhydroxy, ethylhydroxy, propylhydroxy, butylhydroxy, pentylhydroxy, or hexylhydroxy, or optionally substituted C₁₋₆alkyl such as CH₂C(O)OH, CH₂CH₂C(O)OH, CH₂CH₂CH₂C(O)OH. In still other embodiments, R² is C(O)O-(optionally substituted heterocyclyl) such as C(O)O-(optionally substituted succinic anhydride). In further embodiments, R² is C(O)O-(optionally substituted alkyl) such as C(O)O(alkyl substituted with heterocyclyl) such as C(O)O(alkyl substituted with a monosaccharide such as glucosyl). In other embodiments, R² is C(O)(optionally substituted C₁₋₆hydroxyalkyl) such as C(O)CH₂OH, C(O)CH₂CH₂OH, C(O)CHOHCH₂OH, C(O)CH₂CHOHCH₃, or C(O)CH₂CHOHCH₂OH. In yet other embodiments, R² is C(O)O(optionally substituted C₁₋₆hydroxyalkyl) such as C(O)OCH₂OH, C(O)OCH₂CH₂OH, C(O)OCHOHCH₂OH, C(O)OCH₂CHOHCH₃, or C(O)OCH₂CHOHCH₂OH. In further embodiments, R² is C(O)O(optionally substituted C₁₋₉glycol) such as C(O)OCH₂CH₂OCH₃, C(O)(OCH₂CH₂)₂OCH₃, or C(O)(OCH₂CH₂)₃OCH₃. In still further embodiments, R² is SO₃R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₃R^{C} is aryl substituted with C(O)OH. In other embodiments, R² is SO₂R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₂R^{C} is aryl substituted with C(O)OH.

In certain embodiments, R³ and R⁴ are selected such that they do not affect the properties afforded by the R¹ and/or R² groups, i.e., solubility and hydrolysis to name a few. In some embodiments, R³ and R⁴ are, independently, H, halide, optionally substituted C₁₋₆alkyl, optionally substituted C₁₋₆alkoxy, SO₃H, or optionally substituted aryl. In some embodiments, R³ is halide such as Cl, Br, F, or I. In some embodiments, R⁴ is halide such as Cl, Br, F, or I. In other embodiments, R³ is C₁₋₆alkyl such as methyl, ethyl, propyl, butyl, pentyl, or hexyl. In further embodiments, R³ is C₁₋₆alkoxy, such as methoxy, ethoxy, propoxy, butoxy, pentoxy, or hexoxy. In still other embodiments, R³ is SO₃H. In yet further embodiments, R⁴ is C₁₋₆alkyl such as methyl, ethyl, propyl, butyl, pentyl, or hexyl. In other embodiments, R⁴ is C₁₋₆alkoxy, such as methoxy, ethoxy, propoxy, butoxy, pentoxy, or hexoxy. In further embodiments, R⁴ is SO₃H.

In the structure of Formula (I), m and n are, independently, 0 to 4. In some embodiments, m and n are the same. In other embodiments, m and n differ. In further embodiments, m is 0. In yet other embodiments, n is 0. In still other embodiments, m and n are 1. In yet further embodiments, m and n are 2. In other embodiments, m and n are 3. In further embodiments, m and n are 4.

In some aspects, R³ and R⁴ are not H, when R¹ and R² are both 1-methyl-pyrid-3-yl or pyrid-3-yl. However, the compound where R³ and R⁴ are H, when R¹ and R² are both 1-methyl-pyrid-3-yl or pyrid-3-yl, i.e., the following compounds, may be used in the methods described herein.
(i) N,N′-dinicotinoyl-[2,2′-biindolinylidene]-3,3′-dione;
(i) the N″,N′″-methylpyridinium bis(methylsulfate) salt of N,N′-dinicotinoyl-[2,2′-biindolinylidene]-3,3′-dione;
(iii) N,N′-diacetyl-[2,2′-biindolinylidene]-3,3′-dione;
(iv) N,N′-dipropionyl-[2,2′-bi-indolinylidene]-3,3′-dione;
(v) N,N′-di-isobutyryl-[2,2′-biindolinylidene]-3,3′-dione;
(vi) N,N′-dipivaloyl-[2,2′-biindolinylidene]-3,3′-dione;
(vii) N,N′-bis(cyclohexylcarbonyl)-2,2′-bi-indolinylidene-3,3′-dione;
(viii) N,N′-bis(3-phenylpropionyl)-2,2′-bi-indolinylidene-3,3′-dione;
(ix) N,N′-bis(ethoxycarbonylacetyl)-2,2′-bi-indolinylidene-3,3′-dione;
(x) N,N′-bis(2-phenylacetyl)-[2,2′-bi-indolinylidene]-3,3′-dione;
(xi) N,N′-bis-(p-methoxyphenylacetyl)2,2′-bi-indolinylidene-3,3′-dione;
(xii) N,N′-bis(1-naphthylacetyl)-2,2′-bi-indolinylidene-3,3′-dione;
(xiii) N,N′-bis(2-phenylbutyryl)-2,2′-indolinylidene-3,3′-dione; or
(xiv) (E)-1,1′-di(adamantane-1-carbonyl)-[2,2′-biindolinylidene]-3,3′-dione.

In some preferred embodiments, the compound of Formula (I) is Formulae (I-A)-(I-I):

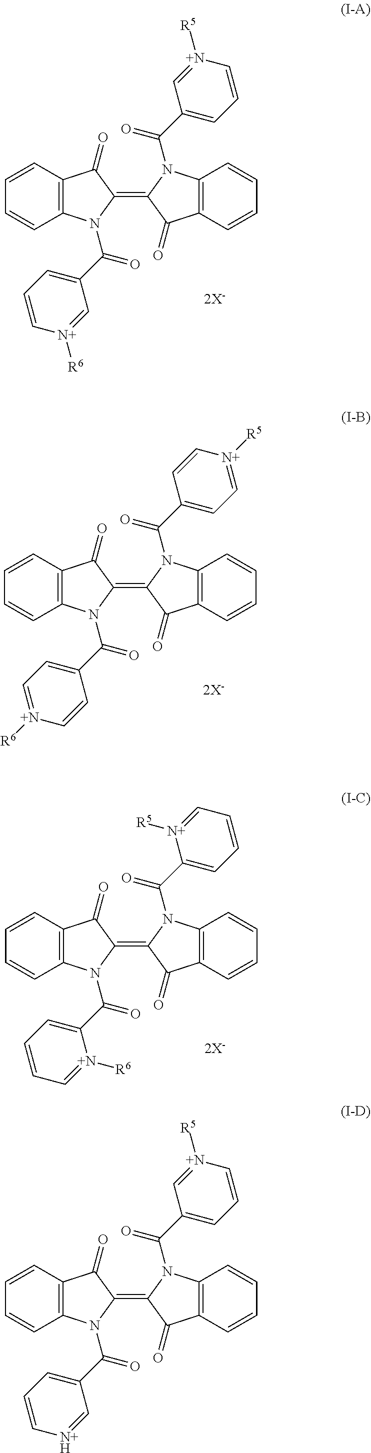

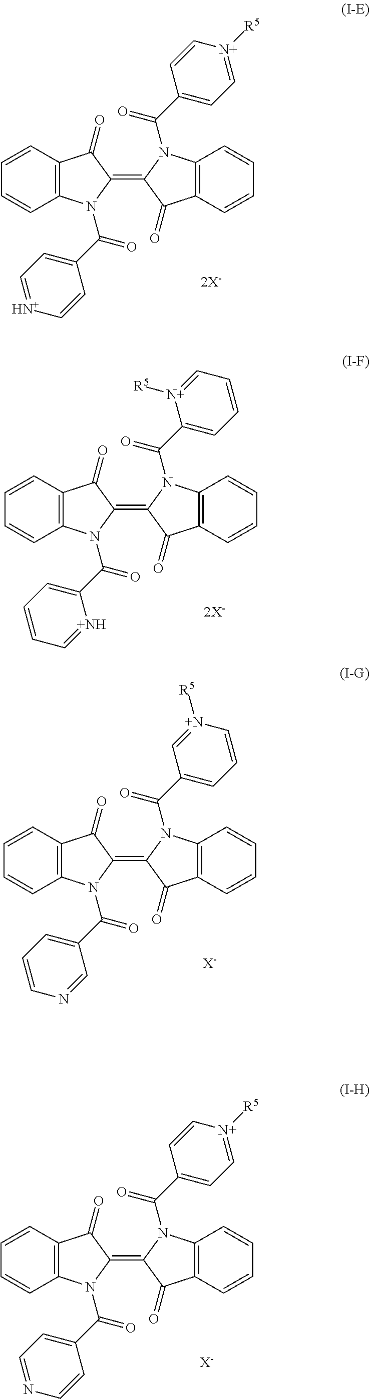

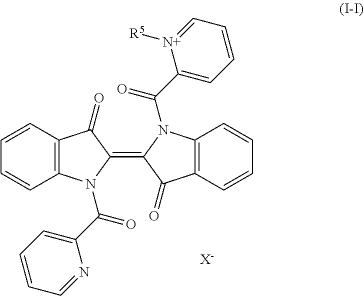

In these structures, R⁵ and R⁶ are, independently, H or C₁₋₆alkyl and X is halide, sulfate, C₁₋₆alkyl sulfate, bisulfate, or phosphate. In some embodiments, R⁵ and R⁶ are H. In other embodiments, R⁵ and R⁶ are C₁₋₆alkyl. In further embodiments, X is halide. In still other embodiments, X is C₁₋₆alkyl sulfate such as MeSO₄. In yet further embodiments, X is bisulfate.

In other embodiments, X is phosphate. For the compound of Formula (I-C), both R⁵ and R⁶ are not CH₃ when X is CH₃SO₄⁻.

In some embodiments, preferred compounds encompassed by Formula (I) include the following.

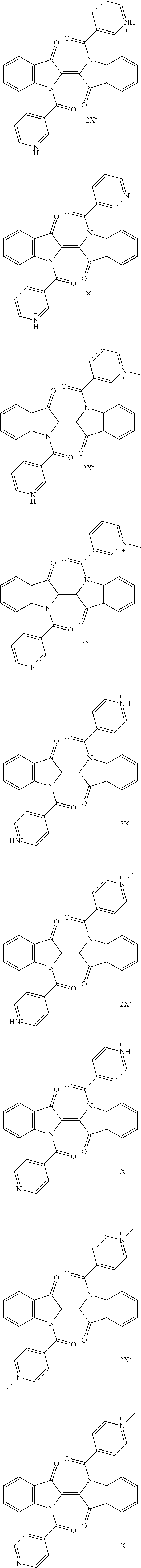

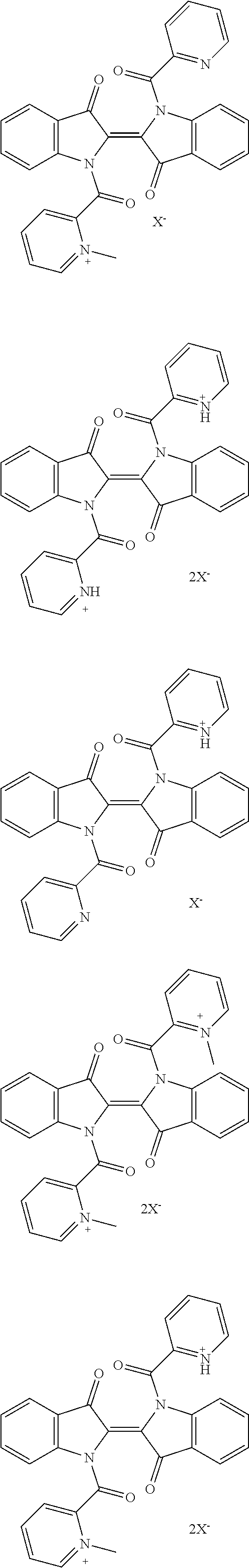

In other preferred embodiments, the compound of Formula (I) is the following:

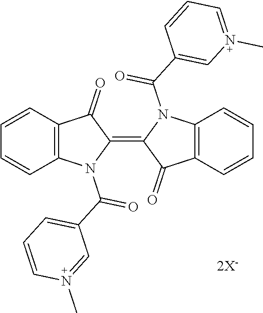

wherein X is not CH₃SO₄.

In some preferred embodiments, the compound of Formula (I) is Formulae (I-J)-(I-R):

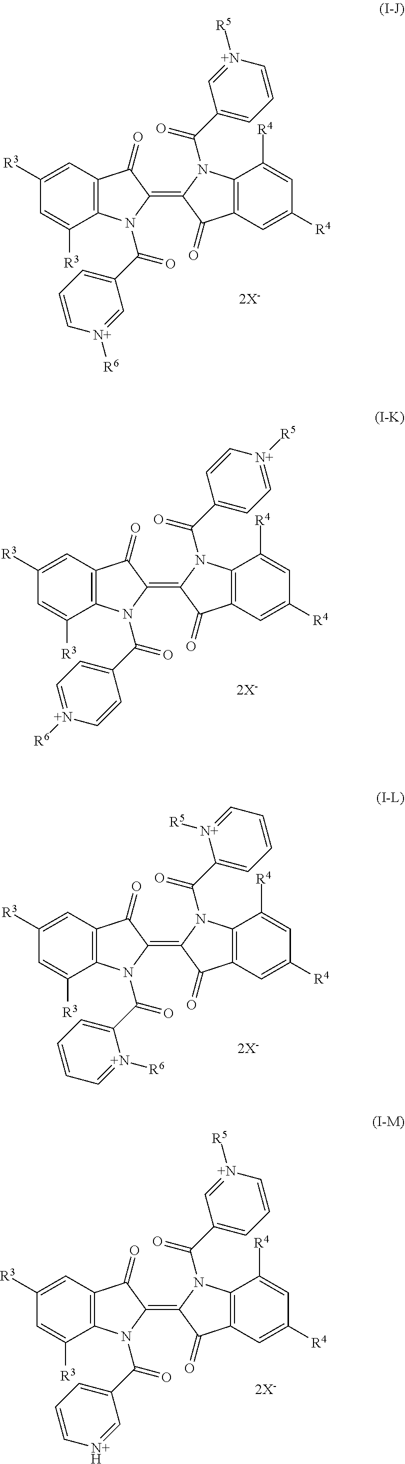

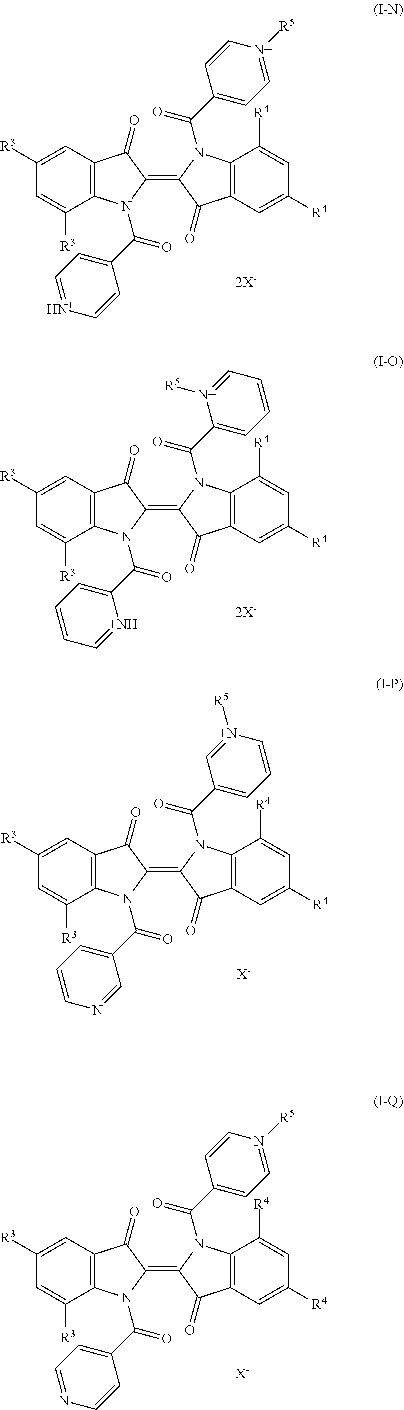

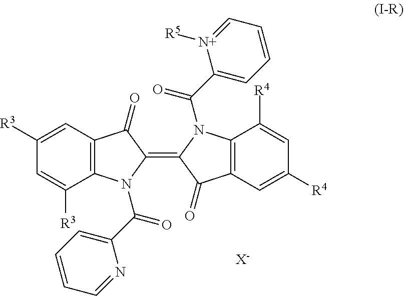

In these structures, R³ and R⁴ are, independently, halide, preferably Br, R⁵ and R⁶ are, independently, H or C₁₋₆alkyl and X is halide, sulfate, C₁₋₆alkyl sulfate, bisulfate, or phosphate. In some embodiments, R⁵ and R⁶ are H. In other embodiments, R⁵ and R⁶ are C₁₋₆alkyl. In further embodiments, X is halide. In still other embodiments, X is C₁₋₆alkyl sulfate. In yet further embodiments, X is bisulfate. In other embodiments, X is phosphate.

In other embodiments, preferred compounds encompassed by Formula (I) are the following.

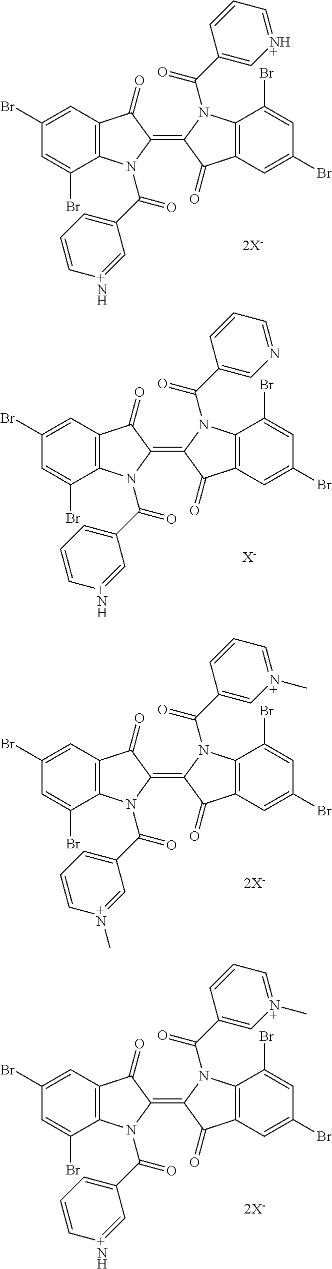

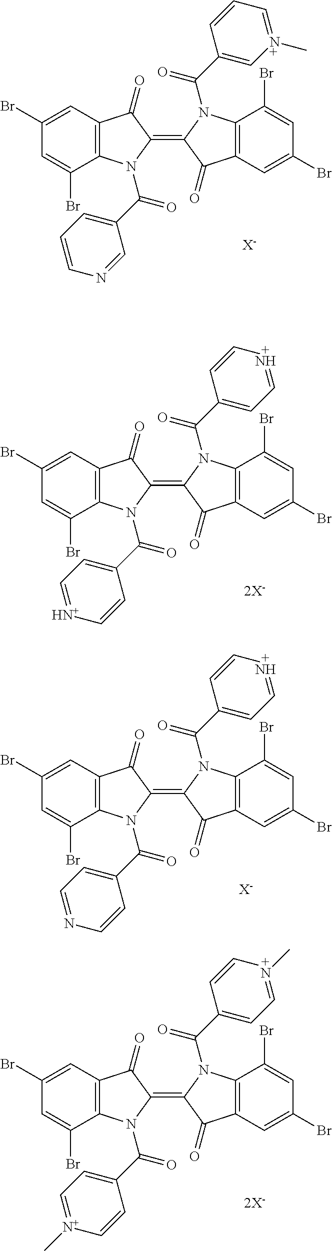

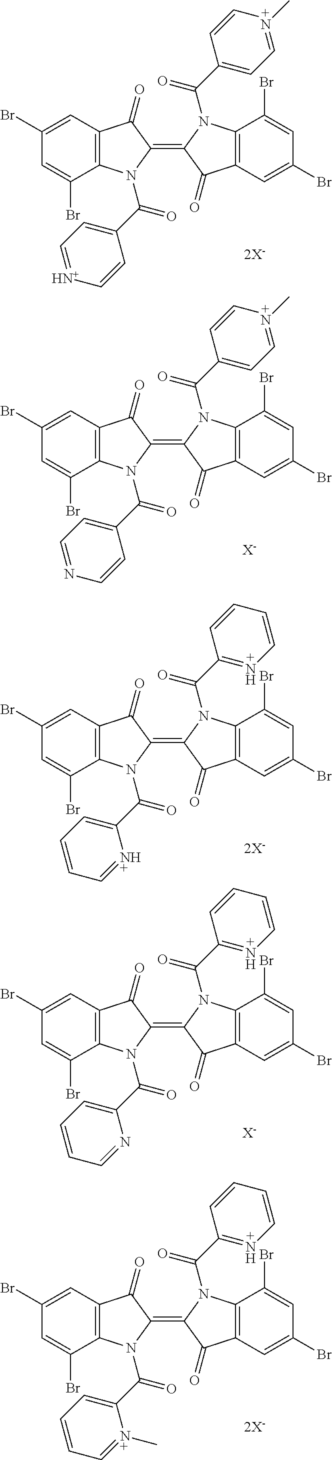

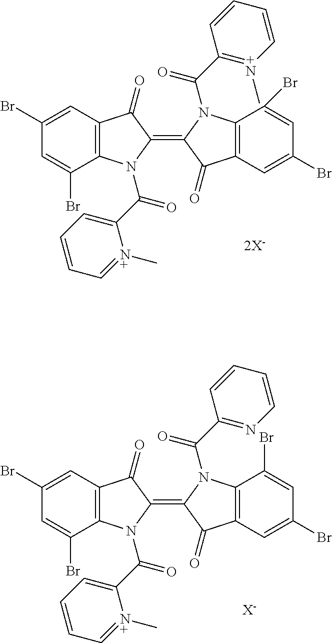 [SMILES: C[n+]1ccccc1C(=O)N1/C(=C2\C(=O)c3cc(Br)cc(Br)c3N2C(=O)c2cccc[n+]2C)C(=O)c2cc(Br)cc(Br)c21 ; "2X-" ; C[n+]1ccccc1C(=O)N1/C(=C2\C(=O)c3cc(Br)cc(Br)c3N2C(=O)c2ccccn2)C(=O)c2cc(Br)cc(Br)c21 ; "X-"]

In the above compounds, X is a counteranion as described herein. In further embodiments, preferred compounds encompassed by Formula (I) include the following or a salt thereof.

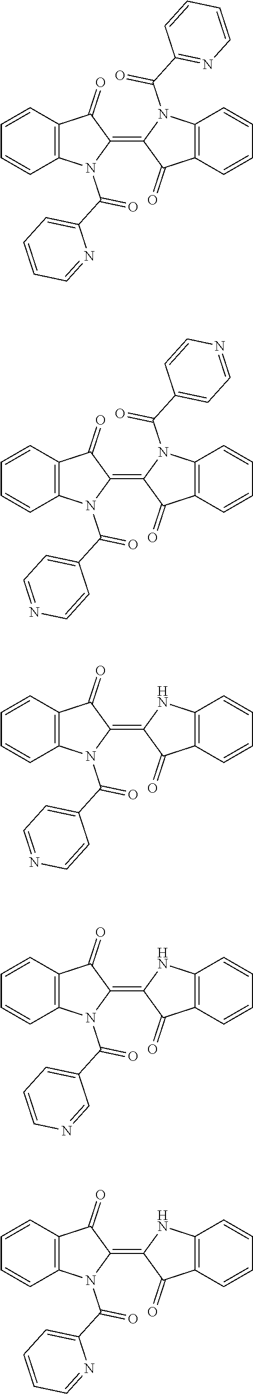 [SMILES: O=C1/C(=C2/C(=O)c3ccccc3N2C(=O)c2ccccn2)N(C(=O)c2ccccn2)c2ccccc21 ; O=C1/C(=C2/C(=O)c3ccccc3N2C(=O)c2ccncc2)N(C(=O)c2ccncc2)c2ccccc21 ; O=C1/C(=C2/C(=O)c3ccccc3N2C(=O)c2ccncc2)Nc2ccccc21 ; O=C1/C(=C2/C(=O)c3ccccc3N2C(=O)c2cccnc2)Nc2ccccc21 ; O=C1/C(=C2/C(=O)c3ccccc3N2C(=O)c2ccccn2)Nc2ccccc21]

In further embodiments, preferred compounds encompassed by Formula (I) are the following.

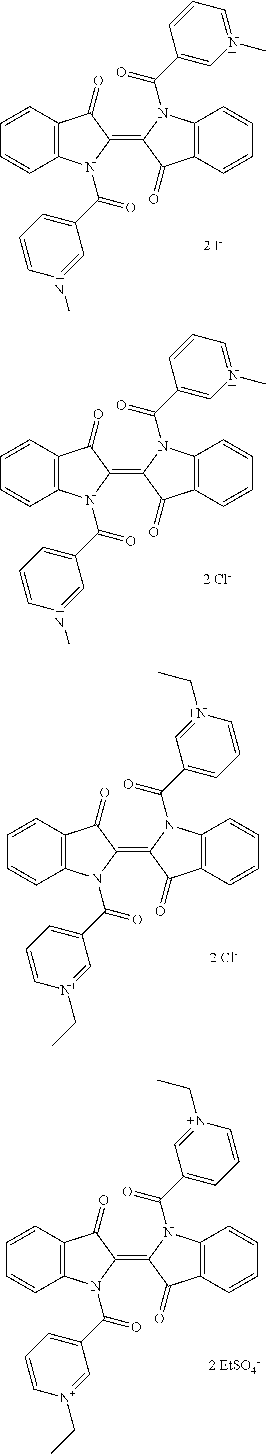

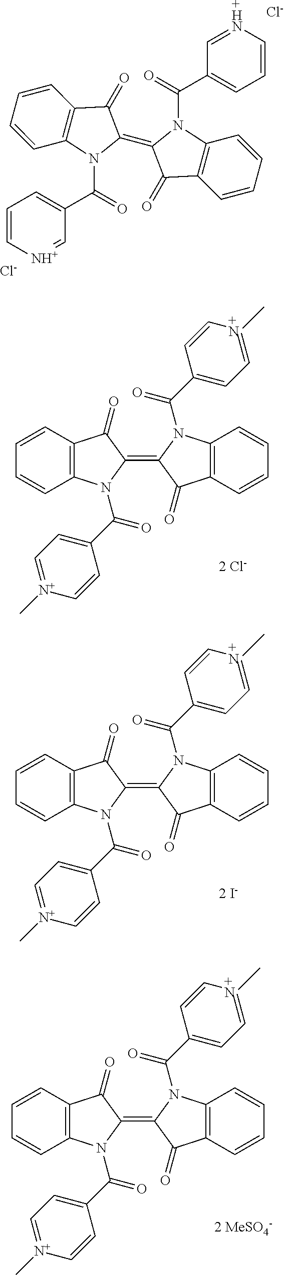

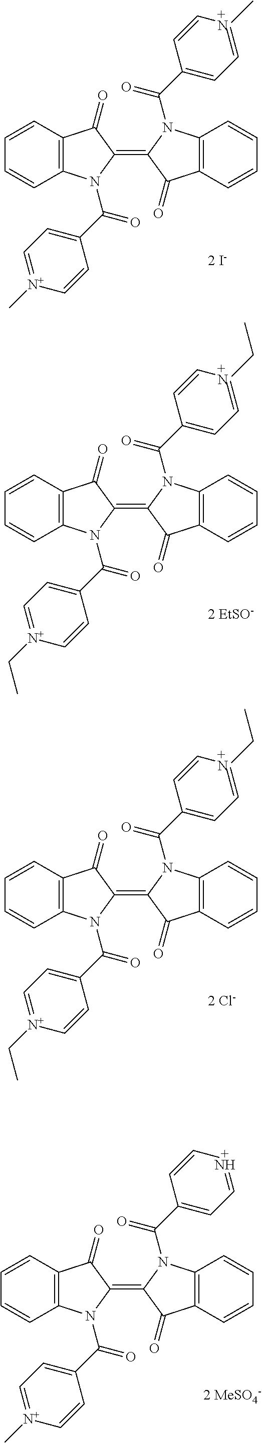

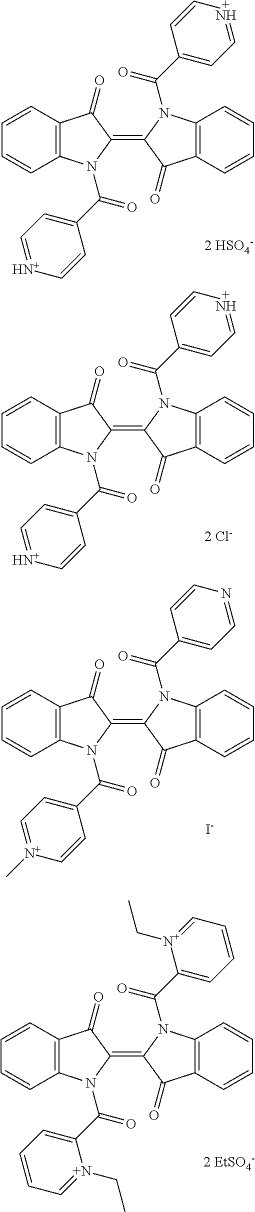

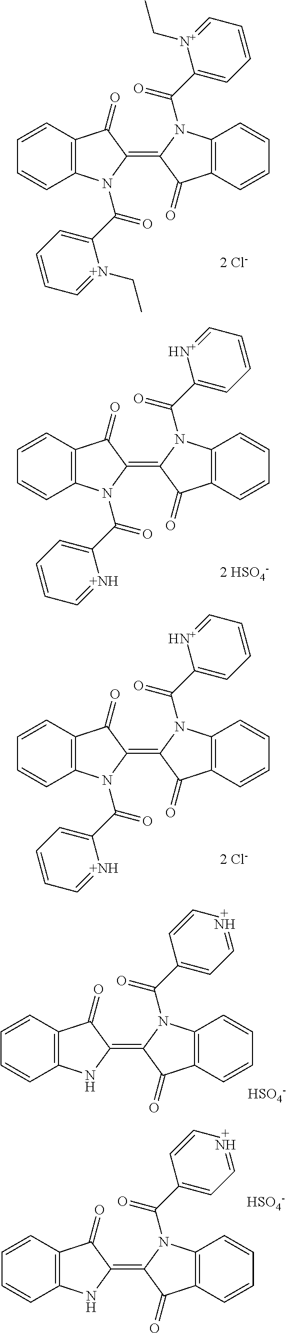

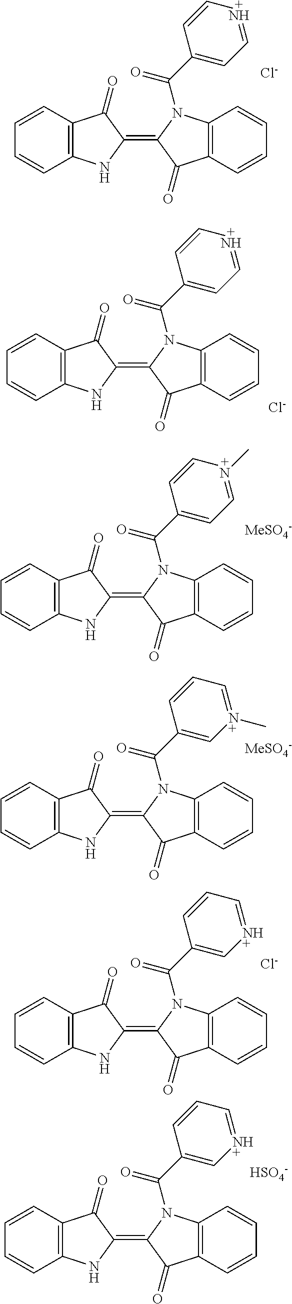

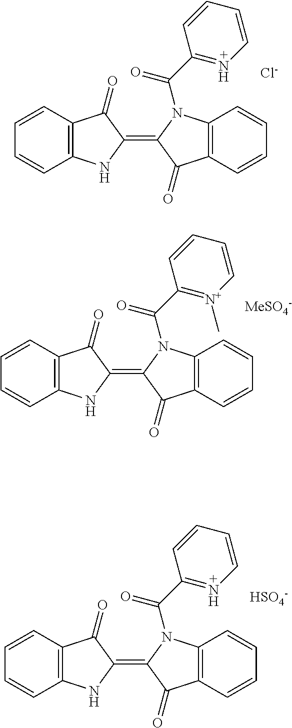

In still further embodiments, preferred compounds encompassed by Formula (I) is of Formula (I-S) or a salt thereof.

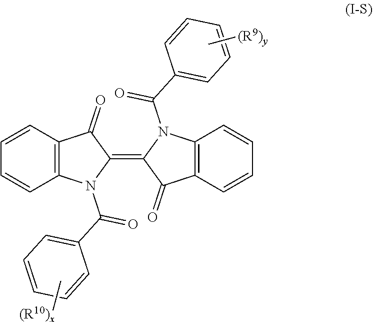

In this structure of Formula (I-S), R⁹ and R¹⁰ are, independently alkyl, cycloalkyl, aryl, heteroaryl, heterocyclyl, alkoxy, aryloxy, OH, CN, halide, NO₂, SO₃R (where R is H, halide, alkyl, aryl, cycloalkyl, heteroaryl, or heterocyclyl) such as SO₃H or SO₃Cl, C(O)OR (where R is H, alkyl, aryl, cycloalkyl, heteroaryl, or heterocyclyl), OC(O)OR (where R is H, alkyl, aryl, cycloalkyl, heteroaryl, or heterocyclyl) such as OCO₂alkyl, OC(O)R (where R is H, alkyl, aryl, cycloalkyl, heteroaryl, or heterocyclyl) such as OC(O)alkyl, PO₃R₂ (where R is H, alkyl, aryl, cycloalkyl, heteroaryl, or heterocyclyl), NR₂ (where R is H, alkyl, aryl, cycloalkyl, heteroaryl, or heterocyclyl), or a quaternary amine, x is 0-5, and y is 0-5. In some embodiments, R⁹ and R¹⁰ are SO₃H or SO₃Cl. In other embodiments, R⁹ and R¹⁰are NO₂, NH₂, OH, halide, C₁₋₆alkyl, aryl, C₃₋₈cycloalkyl, heteroaryl, or heterocyclyl. In further embodiments, x is 1. In yet other embodiments, y is 1. In still further embodiments, x and y are 1. In yet other embodiments, preferred compounds encompassed by Formula (I) are the following or a salt thereof.

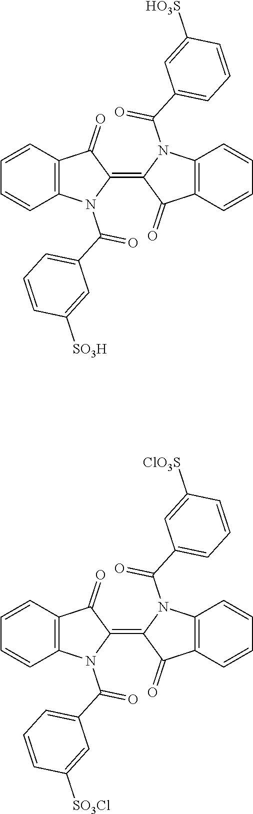

In further embodiments, preferred compounds encompassed by Formula (I) is of Formula (I-T) or a salt thereof.

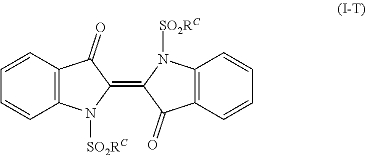

In this structure of Formula (I-T), each R^{C} is, independently, H, optionally substituted C₁₋₆alkyl, optionally substituted C₃₋₈cycloalkyl, optionally substituted aryl, optionally substituted heteroaryl, or optionally substituted heterocyclyl. In some aspects, each R^{C} is H, optionally substituted C₁₋₆alkyl, or optionally substituted aryl. In some aspects, R^{C} is optionally substituted aryl such as optionally substituted phenyl. In further aspects, R^{C} is aryl substituted with C(O)OH.

In further embodiments, preferred compounds encompassed by Formula (I) is of Formula (I-T1) or a salt thereof.

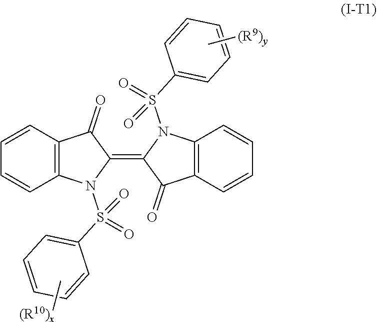

In this structure of Formula (I-T1), R⁹ and R¹⁰ are, independently alkyl, cycloalkyl, aryl, heteroaryl, heterocyclyl, alkoxy, aryloxy, OH, CN, halide, NO₂, SO₃R (where R is H, halide, alkyl, aryl, cycloalkyl, heteroaryl, or heterocyclyl) such as SO₃H or SO₃Cl, C(O)R (where R is H, NH₂, alkyl, aryl, cycloalkyl, heteroaryl, or heterocyclyl), C(O)OR (where R is H, alkyl, aryl, cycloalkyl, heteroaryl, or heterocyclyl), OC(O)OR (where R is H, alkyl, aryl, cycloalkyl, heteroaryl, or heterocyclyl) such as OCO₂alkyl, OC(O)R (where R is H, alkyl, aryl, cycloalkyl, heteroaryl, or heterocyclyl) such as OC(O)alkyl, PO₃R₂ (where R is H, alkyl, aryl, cycloalkyl, heteroaryl, or heterocyclyl), NR₂ (where R is H, alkyl, aryl, cycloalkyl, heteroaryl, or heterocyclyl), or a quaternary amine, x is 0-5, and y is 0-5. In some embodiments, R⁹ and R¹⁰ are C(O)OR such as CO₂H, C(O)NH₂, or NO₂. In other embodiments, R⁹ and R¹⁰ are C₁₋₆alkyl. In further embodiments, x is 1. In yet other embodiments, y is 1. In still further embodiments, x and y are 1.

In some embodiments, a preferred compound encompassed by Formula (I) is the following or a salt thereof:

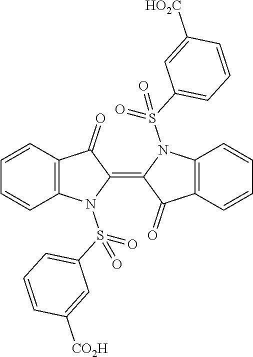 [SMILES: O=C(O)c1cccc(S(=O)(=O)N2/C(=C3\C(=O)c4ccccc4N3S(=O)(=O)c3cccc(C(=O)O)c3)C(=O)c3ccccc32)c1]

In further embodiments, preferred compounds encompassed by Formula (I) is of Formula (I-V) or a salt thereof.

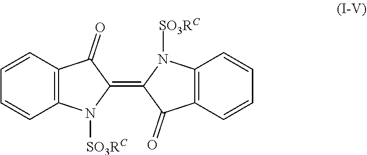

In this structure of Formula (I-U), each R^{C} is, independently, H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. In other aspects, R^{C} is H.

In some embodiments, a preferred compound encompassed by Formula (I) is the following or a salt thereof.

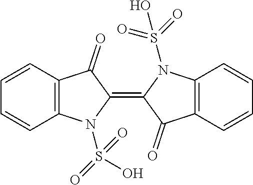 [SMILES: O=C1/C(=C2/C(=O)c3ccccc3N2S(=O)(=O)O)N(S(=O)(=O)O)c2ccccc21]

In further embodiments, preferred compounds encompassed by Formula (I) is of Formula (I-W) or a salt thereof.

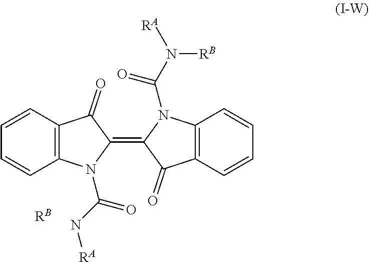

In this structure of Formula (I-W), one or both of R^{A} and R^{B} is H, optionally substituted C₁₋₆hydroxyalkyl, optionally substituted C₁₋₆alkyl, or optionally substituted aryl. In some embodiments, one or both of R^{A} and R^{B} is methylhydroxy, ethylhydroxy, propylhydroxy, butylhydroxy, pentylhydroxy, or hexylhydroxy. In other embodiments, one or both of R^{A} and R^{B} is CH₂C(O)OH, CH₂CH₂C(O)OH, or CH₂CH₂CH₂C(O)OH.

In further embodiments, preferred compounds encompassed by Formula (I) are the following or a salt thereof.

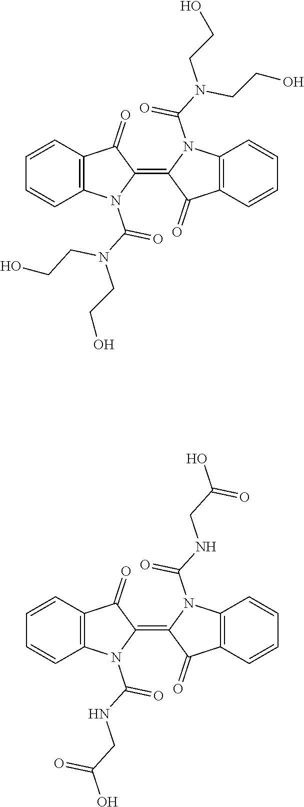 [SMILES: O=C1/C(=C2/C(=O)c3ccccc3N2C(=O)N(CCO)CCO)N(C(=O)N(CCO)CCO)c2ccccc21 ; O=C(O)CNC(=O)N1/C(=C2\C(=O)c3ccccc3N2C(=O)NCC(=O)O)C(=O)c2ccccc21]

In further embodiments, preferred compounds encompassed by Formula (I) is of Formula (I-X) or a salt thereof.

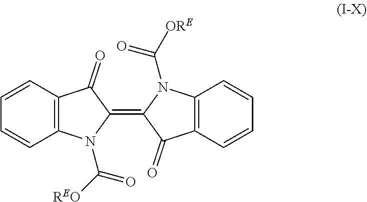

In this structure of Formula (I-X), one or both R^{E} is H, optionally substituted C₁₋₆alkyl, C₁₋₆hydroxyalkyl, optionally substituted aryl, optionally substituted C₃₋₈cycloalkyl, optionally substituted heteroaryl, or optionally substituted heterocyclyl. In some aspects, R^{E} is optionally substituted C₁₋₆alkyl such as C(O)O(alkyl substituted with heterocyclyl), e.g., C(O)O(alkyl substituted with a monosaccharide such as glucosyl). In other aspects, R^{E} is optionally substituted C₁₋₆hydroxyalkyl such as C(O)OCH₂OH, C(O)OCH₂CH₂OH, C(O)OCHOHCH₂OH, C(O)OCH₂CHOHCH₃, or C(O)OCH₂CHOHCH₂OH. In further aspects, R^{E} is optionally substituted heterocyclyl such as optionally substituted succinic anhydride. In yet other aspects, R^{E} is optionally substituted C₁₋₉glycol such as C(O)OCH₂CH₂OCH₃, C(O)(OCH₂CH₂)₂OCH₃, or C(O)(OCH₂CH₂)₃OCH₃.

In other embodiments, preferred compounds encompassed by Formula (I) are the following or a salt thereof.

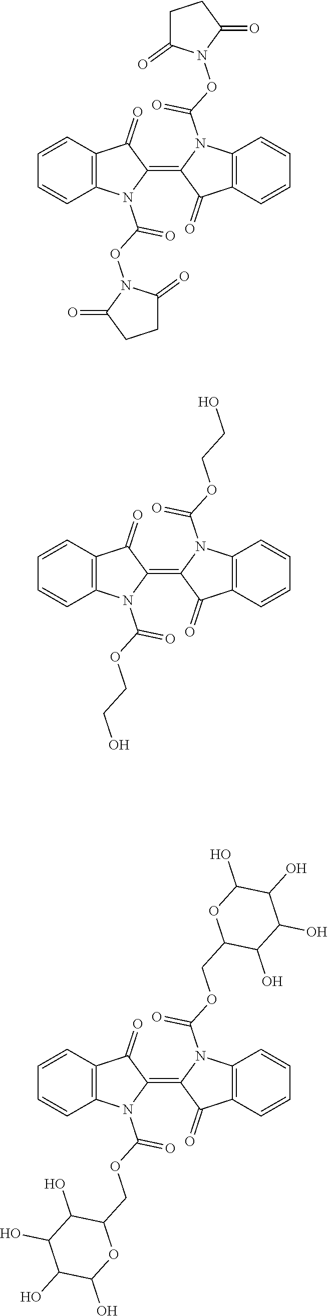 [SMILES: O=C1/C(=C2/C(=O)c3ccccc3N2C(=O)ON2C(=O)CCC2=O)N(C(=O)ON2C(=O)CCC2=O)c2ccccc21 ; O=C1/C(=C2/C(=O)c3ccccc3N2C(=O)OCCO)N(C(=O)OCCO)c2ccccc21 ; O=C1/C(=C2/C(=O)c3ccccc3N2C(=O)OCC2OC(O)C(O)C(O)C2O)N(C(=O)OCC2OC(O)C(O)C(O)C2O)c2ccccc21]

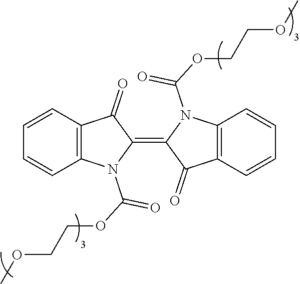

In further embodiments, preferred compounds encompassed by Formula (I) is of Formula (I-Y) or a salt thereof.

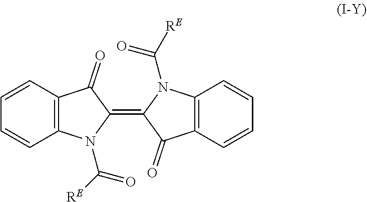

In this structure of Formula (I-X), one or both R^{E} is H, optionally substituted C₁₋₆alkyl (such as substituted methyl, n-propyl, substituted i-propyl, alkyl substituted with phenyl substituted with alkyl, cycloalkyl, aryl, heteroaryl, heterocyclyl, alkoxy, aryloxy, OH, CN, or halide), alkyl substituted with naphthyl, alkyl substituted with indanyl, alkyl substituted with indenyl, alkyl substituted with anthryl, alkyl substituted with phenanthryl, alkyl substituted with fluorenyl, alkyl substituted with 1,2,3,4-tetrahydronaphthalenyl, alkyl substituted with 6,7,8,9-tetrahydro-5H-benzocycloheptenyl, or alkyl substituted with 6,7,8,9-tetrahydro-5H-benzocycloheptenyl), optionally substituted C₁₋₆hydroxyalkyl, optionally substituted heterocyclyl, or optionally substituted C₁₋₆hydroxyalkyl. In some aspects, R^{E} is optionally substituted C₁₋₆hydroxyalkyl such as C(O)CH₂OH, C(O)CH₂CH₂OH, C(O)CHOHCH₂OH, C(O)CH₂CHOHCH₃, or C(O)CH₂CHOHCH₂OH. In other aspects, R^{E} is optionally substituted C₁₋₆alkyl such as C₁₋₆alkyl substituted with an ester, e.g., C(O)methoxy, C(O)propoxy), C(O)butoxy, C(O)pentoxy, or C(O)hexoxy.

In other embodiments, preferred compounds encompassed by Formula (I) is the following or a salt thereof.

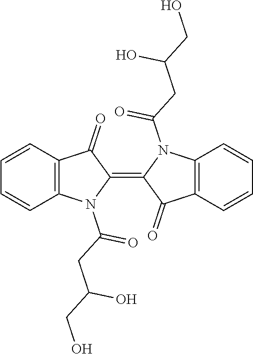 [SMILES: O=C1/C(=C2/C(=O)c3ccccc3N2C(=O)CC(O)CO)N(C(=O)CC(O)CO)c2ccccc21]

In further embodiments, the compound is of Formula (II) or a salt thereof:

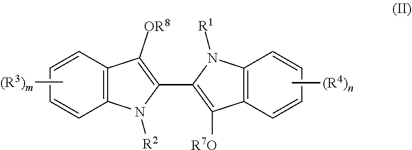

In the structure of Formula (II), all of R¹, R², R⁷, and R⁸ are not H. R¹ and R² may be the same or different. In some embodiments, R¹ or R² is H. In other embodiments, R¹ and R² are H.

R¹ and R² are, independently, H, SO₃R^{C}, SO₂R^{C}, PO₃(R^{C})₂, C(O)-(optionally substituted C₁₋₉glycolyl), C(O)-(optionally substituted C₁₋₆alkyl), C(O)-(optionally substituted C₁₋₆hydroxyalkyl), C(O)-(optionally substituted C₁₋₉glycolyl), C(O)-(optionally substituted heteroaryl), C(O)-(optionally substituted aryl), C(O)-(optionally substituted heterocyclyl), C(O)NR^{A}R^{B}, C(O)O-(optionally substituted C₁₋₆alkyl), C(O)O-(optionally substituted C₁₋₆hydroxyalkyl), C(O)O-(optionally substituted heteroaryl), C(O)O-(optionally substituted aryl), or C(O)O-(optionally substituted heterocyclyl);

In some embodiments, R¹ is C(O)-(optionally substituted alkyl) such as C(O)(C₁₋₆alkyl substituted with an ester such as C(O)C₁₋₆alkoxy). In other embodiments, R¹ is C(O)O-(optionally substituted alkyl). In further embodiments, R¹ is C(O)NR^{A}R^{B}, where R^{A} and R are, independently, H or optionally substituted C₁₋₆alkyl, or optionally substituted aryl. In still other embodiments, R¹ is C(O)-(optionally substituted heteroaryl). In yet further embodiments, R¹ is C(O)O-(optionally substituted heteroaryl). In other embodiments, R¹ is C(O)-(optionally substituted aryl). In further embodiments, R¹ is C(O)O-(optionally substituted aryl). In yet other embodiments, R¹ is C(O)-(optionally substituted heterocyclyl). In still further embodiments, R¹ is C(O)O-(optionally substituted heterocyclyl). In other embodiments, R¹ is SO₃H. Preferably, R¹ is C(O)-(optionally substituted pyridyl), such as C(O)-(optionally substituted 2-pyridyl), C(O)-(optionally substituted 3-pyridyl), or C(O)-(optionally substituted 4-pyridyl). In further embodiments, the pyridyl is substituted with one or more C₁₋₆alkyl, such as methyl or ethyl. Preferably, the pyridyl is substituted on the N-atom of the pyridyl ring. In other embodiments, R¹ is C(O)-(optionally substituted aryl) such as C(O)-(optionally substituted phenyl). Preferably, the phenyl of the R¹ group is substituted with one or more SO₃H, SO₃Cl, NO₂, NH₂, OH, halide, alkyl, aryl, cycloalkyl, heteroaryl, heterocyclyl and as substituents. In yet further embodiments, R¹ is C(O)NR^{A}R^{B}, wherein one or both of R^{A} and R^{B} is H, optionally substituted C₁₋₆hydroxyalkyl such as methylhydroxy, ethylhydroxy, propylhydroxy, butylhydroxy, pentylhydroxy, or hexylhydroxy, or optionally substituted C₁₋₆alkyl such as CH₂C(O)OH, CH₂CH₂C(O)OH, CH₂CH₂CH₂C(O)OH. In still other embodiments, R¹ is C(O)O-(optionally substituted heterocyclyl) such as C(O)O-(optionally substituted succinic anhydride). In further embodiments, R¹ is C(O)O-(optionally substituted alkyl) such as C(O)O(alkyl substituted with heterocyclyl) such as C(O)O(alkyl substituted with a monosaccharide such as glucosyl). In other embodiments, R¹ is C(O)(optionally substituted C₁₋₆hydroxyalkyl) such as C(O)CH₂OH, C(O)CH₂CH₂OH, C(O)CHOHCH₂OH, C(O)CH₂CHOHCH₃, or C(O)CH₂CHOHCH₂OH. In yet other embodiments, R¹ is C(O)O(optionally substituted C₁₋₆hydroxyalkyl) such as C(O)OCH₂OH, C(O)OCH₂CH₂OH, C(O)OCHOHCH₂OH, C(O)OCH₂CHOHCH₃, or C(O)OCH₂CHOHCH₂OH. In further embodiments, R¹ is C(O)(optionally substituted C₁₋₉glycol) such as C(O)OCH₂CH₂OCH₃, C(O)(OCH₂CH₂)₂OCH₃, or C(O)(OCH₂CH₂)₃OCH₃. In still further embodiments, R¹ is SO₃R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₃R^{C} is aryl substituted with C(O)OH. In other embodiments, R¹ is SO₂R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₂R^{C} is aryl substituted with C(O)OH.

In some embodiments, R² is C(O)-(optionally substituted alkyl) such as C(O)(C₁₋₆alkyl substituted with an ester such as C(O)C₁₋₆alkoxy). In other embodiments, R² is C(O)O-(optionally substituted alkyl). In further embodiments, R² is C(O)NR^{A}R^{B}, where R^{A} and R are, independently, H or optionally substituted C₁₋₆alkyl, or optionally substituted aryl. In still other embodiments, R² is C(O)-(optionally substituted heteroaryl). In yet further embodiments, R² is C(O)O-(optionally substituted heteroaryl). In other embodiments, R² is C(O)-(optionally substituted aryl). In further embodiments, R² is C(O)O-(optionally substituted aryl). In yet other embodiments, R² is C(O)-(optionally substituted heterocyclyl). In still further embodiments, R² is C(O)O-(optionally substituted heterocyclyl). In other embodiments, R² is SO₃H. Preferably, R² is C(O)-(optionally substituted pyridyl), such as C(O)-(optionally substituted 2-pyridyl), C(O)-(optionally substituted 3-pyridyl), or C(O)-(optionally substituted 4-pyridyl). In further embodiments, the pyridyl is substituted with one or more C₁₋₆alkyl, such as methyl or ethyl. Preferably, the pyridyl is substituted on the N-atom of the pyridyl ring. In other embodiments, R² is C(O)-(optionally substituted aryl) such as C(O)-(optionally substituted phenyl). Preferably, the phenyl of the R² group is substituted with one or more SO₃H, SO₃Cl, NO₂, NH₂, OH, halide, alkyl, aryl, cycloalkyl, heteroaryl, heterocyclyl and as substituents. In yet further embodiments, R² is C(O)NR^{A}R^{B}, wherein one or both of R^{A} and R^{B} is H, optionally substituted C₁₋₆hydroxyalkyl such as methylhydroxy, ethylhydroxy, propylhydroxy, butylhydroxy, pentylhydroxy, or hexylhydroxy, or optionally substituted C₁₋₆alkyl such as CH₂C(O)OH, CH₂CH₂C(O)OH, CH₂CH₂CH₂C(O)OH. In still other embodiments, R² is C(O)O-(optionally substituted heterocyclyl) such as C(O)O-(optionally substituted succinic anhydride). In further embodiments, R² is C(O)O-(optionally substituted alkyl) such as C(O)O(alkyl substituted with heterocyclyl) such as C(O)O(alkyl substituted with a monosaccharide such as glucosyl). In other embodiments, R² is C(O)(optionally substituted C₁₋₆hydroxyalkyl) such as C(O)CH₂OH, C(O)CH₂CH₂OH, C(O)CHOHCH₂OH, C(O)CH₂CHOHCH₃, or C(O)CH₂CHOHCH₂OH. In yet other embodiments, R² is C(O)O(optionally substituted C₁₋₆hydroxyalkyl) such as C(O)OCH₂OH, C(O)OCH₂CH₂OH, C(O)OCHOHCH₂OH, C(O)OCH₂CHOHCH₃, or C(O)OCH₂CHOHCH₂OH. In further embodiments, R² is C(O)(optionally substituted C₁₋₉glycol) such as C(O)OCH₂CH₂OCH₃, C(O)(OCH₂CH₂)₂OCH₃, or C(O)(OCH₂CH₂)₃OCH₃. In still further embodiments, R² is SO₃R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₃R^{C} is aryl substituted with C(O)OH. In other embodiments, R² is SO₂R^{C}, where R^{C} is H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. For example, R^{C} in SO₂R^{C} is aryl substituted with C(O)OH.

In some embodiments, R³ and R⁴ are, independently, H, halide, optionally substituted C₁₋₆alkyl, optionally substituted C₁₋₆alkoxy, SO₃H, or optionally substituted aryl. In some embodiments, R³ is halide such as Cl, Br, F, or I. In some embodiments, R⁴ is halide such as Cl, Br, F, or I. In other embodiments, R³ is C₁₋₆alkyl such as methyl, ethyl, propyl, butyl, pentyl, or hexyl. In further embodiments, R³ is C₁₋₆alkoxy, such as methoxy, ethoxy, propoxy, butoxy, pentoxy, or hexoxy. In still other embodiments, R³ is SO₃H. In yet further embodiments, R⁴ is C₁₋₆alkyl such as methyl, ethyl, propyl, butyl, pentyl, or hexyl. In other embodiments, R⁴ is C₁₋₆alkoxy, such as methoxy, ethoxy, propoxy, butoxy, pentoxy, or hexoxy. In further embodiments, R⁴ is SO₃H.

In some embodiments, R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl). Preferably, both R⁷ and R⁸ are not SO₃H. In other embodiments, R⁷ and R⁸ are, independently, H, SO₃R^{C}, SO₂R^{C}, PO₃(R^{C})₂, C(O)NR^{A}R^{B}, C(O)-(optionally substituted C₁₋₉glycolyl), C(O)-(optionally substituted heteroaryl), C(O)-(optionally substituted heterocyclyl), C(O)-(optionally substituted C₁₋₆hydroxyalkyl), C(O)O-(optionally substituted aryl), C(O)O-(optionally substituted C₁₋₆alkyl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl).

In some embodiments, R⁷ and R⁸ are, independently, H, SO₃H, or C(O)C₁₋₆alk-C(O)C₁₋₆alkoxy. In further embodiments, R⁷ or R⁸ is H. In further embodiments, R⁷ and R⁸ are H. In other embodiments, R⁷ or R⁸ is SO₃H. In yet further embodiments, R⁷ and R⁸ are SO₃H. In still other embodiment, R⁷ and R⁸ are not both when both R¹ and R² are H. In further embodiments, R⁷ is C(O)C₁₋₆alk-C(O)C₁₋₆alkoxy such as C(O)CH₂C(O)CH₂CH₃. In yet other embodiments, R⁸ is H. In still further embodiments, R⁸ is SO₃H. In other embodiments, R⁷ is C(O)C₁₋₆alk-C(O)C₁₋₆alkoxy such as C(O)CH₂C(O)CH₂CH₃. In still further embodiments, one or both of R⁷ and R⁸ are C(O)(optionally substituted heteroaryl) such as C(O)(optionally substituted pyridyl). In other embodiments, one or both of R⁷ and R⁸ are C(O)(optionally substituted C₁₋₆alkyl) such as C(O)(C₁₋₆alkyl substituted with C(O)O(C₁₋₆alkyl) such as C(O)OCH₂CH₃), C(O)-(substituted methyl), C(O)-(substituted t-butyl), C(O)-(optionally substituted ethyl), C(O)-(unsubstituted propyl), C(O)-(propyl substituted with alkyl, cycloalkyl, heteroaryl, heterocyclyl, alkoxy, aryloxy, OH, CN, or halide), C(O)-(optionally substituted n-butyl), C(O)-(optionally substituted i-butyl), C(O)-(optionally substituted pentyl), or C(O)-(optionally substituted hexyl). Thus, in this example, one of R⁷ or R⁸ is C(O)C₁₋₆alkC(O)C₁₋₆alkoxy such as C(O)CH₂C(O)OCH₂CH₃ and the other is H. In other examples, R⁷ and R⁸ is C(O)C₁₋₆alk-C(O)C₁₋₆alkoxy such as C(O)CH₂C(O)OCH₂CH₃. In further embodiments, one or both of R⁷ and R⁸ are C(O)-(optionally substituted aryl) such as C(O)-(phenyl substituted with alkyl, cycloalkyl, aryl, heteroaryl, heterocyclyl, alkoxy, aryloxy, OH, CN, or halide), C(O)-(substituted naphthyl), C(O)-(optionally substituted indanyl), C(O)-(optionally substituted indenyl), C(O)-(optionally substituted anthryl), C(O)-(optionally substituted phenanthryl), C(O)-(optionally substituted fluorenyl), C(O)-(optionally substituted 1,2,3,4-tetrahydronaphthalenyl), C(O)-(optionally substituted 6,7,8,9-tetrahydro-5H-benzocycloheptenyl), or C(O)-(optionally substituted 6,7,8,9-tetrahydro-5H-benzocycloheptenyl). For example one or both of R⁷ and R⁸ is C(O)(phenyl is substituted with CO₂H).

In the structure of Formula (II), m and n are, independently, 0 to 4. In some embodiments, m and n are the same. In other embodiments, m and n differ. In further embodiments, m is 0. In yet other embodiments, n is 0. In still other embodiments, m and n are 1. In yet further embodiments, m and n are 2. In other embodiments, m and n are 3. In further embodiments, m and n are 4.

In some aspects, the compound of Formula (II) is not:
(i) 1H,1′H-[2,2′-biindole]-3,3′-diyl diacetate;
(ii) 3,3′-bis(phenylacetoxy)-2,2′-bi-indolyl;
(iii) 3,3′-bis(p-methoxyphenylacetoxy)-2,2′-bi-indolyl;
(iv) 3,3′-bis(1-napthylacetoxy)-2,2′-bi-indolyl;
(v) 3,3′-bis(phenylbutyryloxy)-2,2′-bi-indolyl;
(vi) 3,3′-bis(pivaloyloxy)-2,2′-bi-indolyl;
(vii) 3,3′-bis(1-adamantylcarbonyloxy)-2,2′-bi-indolyl;
(viii) 3,3′-bis(ethoxycarbonylacetoxy)-2,2′-bi-indolyl.

In further embodiments, preferred compounds encompassed by Formula (II) is of Formula (II-A) or a salt thereof.

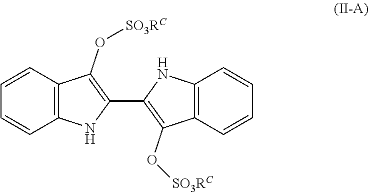

In this structure of Formula (II-A), each R^{C} is, independently, H, optionally substituted C₁₋₆alkyl, optionally substituted C₃₋₈cycloalkyl, optionally substituted aryl, optionally substituted heteroaryl, or optionally substituted heterocyclyl such as H, optionally substituted C₁₋₆alkyl, or optionally substituted aryl. In some aspects, one R^{C} is H. In further aspects, both R^{C} are H.

In some embodiments, a preferred compound encompassed by Formula (II) is the following or a salt thereof.

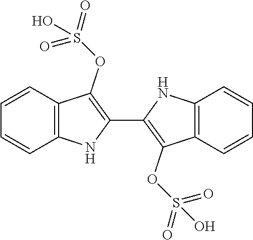 [SMILES: O=S(=O)(O)Oc1c(-c2[nH]c3ccccc3c2OS(=O)(=O)O)[nH]c2ccccc12]

In further embodiments, a preferred compound encompassed by Formula (II) is of Formula (II-B) or a salt thereof.

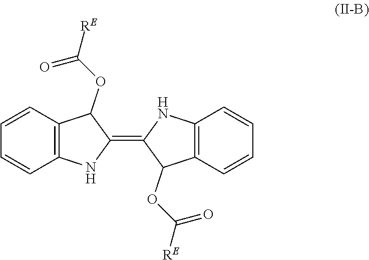

In this structure of Formula (II-B), one or both R^{E} is H, optionally substituted C₁₋₆alkyl, or optionally substituted heteroaryl, provided that both R^{E} are not H. In some aspects, one or both R^{E} is optionally substituted C₁₋₆alkyl such as C₁₋₆alkyl substituted with an ester. In other aspects, one R^{E} is optionally substituted C(O)C₁₋₆alk-C(O)C₁₋₆alkoxy such as C(O)CH₂C(O)CH₂CH₃ and the other is H. In further aspects, both R^{E} are optionally substituted C(O)C₁₋₆alk-C(O)C₁₋₆alkoxy such as C(O)CH₂C(O)CH₂CH₃. In yet other aspects, one R^{E} is H. In further aspects, one or both R^{E} is optionally substituted heteroaryl such as optionally substituted pyridyl. In yet other aspects, one or both R^{E} is substituted methyl, ethyl, propyl, n-butyl, substituted t-butyl, i-butyl, pentyl, or hexyl. In further aspects, one or both of R^{E} is substituted phenyl substituted with alkyl, cycloalkyl, aryl, heteroaryl, heterocyclyl, aryloxy, OH, CN, or halide; substituted naphthyl; optionally substituted indanyl; optionally substituted indenyl; optionally substituted anthryl; optionally substituted phenanthryl; optionally substituted fluorenyl; optionally substituted 1,2,3,4-tetrahydronaphthalenyl; optionally substituted 6,7,8,9-tetrahydro-5H-benzocycloheptenyl; or optionally substituted 6,7,8,9-tetrahydro-5H-benzocycloheptenyl.

In still other embodiments, preferred compounds encompassed by Formula (II) are the following or a salt thereof.

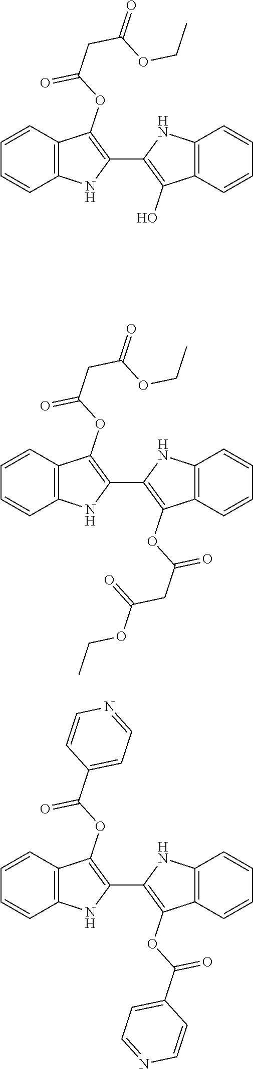

The compounds discussed above may also be used in the form of salts derived from acceptable acids, bases, alkali metals and alkaline earth metals. Thus, the compounds described herein may exist as the free base or a salt thereof. Preferably, the salts are formed via ionic interactions, covalent interactions, or combinations thereof. For example, the salts may be formed by alkylating a heteroatom such as a N-atom within the compound and having a counteranion ionically bound to the heteroatom. The counteranion may be selected by those skilled in the art and includes those anions from the acids identified above and below.

The salts can be formed from organic and inorganic acids including, e.g., carboxylic acids such as acetic, propionic, lactic, citric, tartaric, succinic, fumaric, maleic, malic, malonic, mandelic, and phthalic acids, hydrochloric (Cl⁻), hydrobromic (Br⁻), hydroiodic (I⁻), hydrofluoric (F⁻), phosphoric, nitric, sulfuric, methanesulfonic, phosphoric, naphthalenesulfonic, benzenesulfonic, toluenesulfonic, camphorsulfonic, and similarly known acceptable acids. In some embodiments, the salt is a sulfate salt, alkylsulfate salt, bisulfate salt, phosphate salt, halide salt, sulfite salt, or bisulfite salt. In further embodiments, the compounds are a sulfate salt. In other embodiments, the compound exists as an alkylsulfate salt such as a methylsulfate or ethylsulfate salt. In further embodiments, the compound exists as a halide salt such as an iodide salt, chloride salt, bromide salt, or fluoride salt. In other embodiments, the compound exists as a bisulfate salt. In yet further embodiments, the compound exists as a phosphate salt.

In other embodiments, salts may also be formed from inorganic bases, desirably alkali metal salts including, e.g., sodium, lithium, or potassium, such as alkali metal hydroxides. Examples of inorganic bases include, without limitation, sodium hydroxide, potassium hydroxide, calcium hydroxide, and magnesium hydroxide.

Salts may also be formed from organic bases, such as ammonium salts, mono-, di-, and trimethylammonium, mono-, di- and triethylammonium, mono-, di- and tripropylammonium, ethyldimethylammonium, benzyldimethylammonium, cyclohexylammonium, benzyl-ammonium, dibenzylammonium, piperidinium, morpholinium, pyrrolidinium, piperazinium, 1-methylpiperidinium, 4-ethylmorpholinium, 1-isopropylpyrrolidinium, 1,4-dimethylpiperazinium, 1 n-butyl piperidinium, 2-methylpiperidinium, 1-ethyl-2-methylpiperidinium, mono-, di- and triethanolammonium, ethyl diethanolammonium, n-butylmonoethanolammonium, tris(hydroxymethyl)methylammonium, phenylmono-ethanolammonium, diethanolamine, ethylenediamine, choline, betaine, carnitine, and the like. In one example, the base is selected from among sodium hydroxide, lithium hydroxide, potassium hydroxide, and mixtures thereof.

The compounds discussed herein may also encompass tautomeric forms of the structures provided herein, where such forms may be formed.

Embodiments of modified indigo compounds that have been found particularly useful for the digital printing of fabrics are those that comprise an indigo compound in which at least one of the amine groups is functionalized with an amido-pyridine or a salt thereof. For example, in some embodiments, the modified indigo compound may be selected from a compound having the following base structure, or a salt thereof.

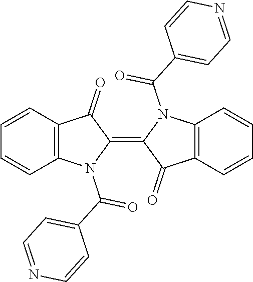 [SMILES: O=C1/C(=C2/C(=O)c3ccccc3N2C(=O)c2ccncc2)N(C(=O)c2ccncc2)c2ccccc21]

By the compound having the above-shown base structure, it is meant that each position in the above structure may include additional unshown substituents. For instance, in some embodiments, the nitrogen atom of each pyridine ring may comprise an alkane substituent, such as a methyl group, an ethyl group, or a propyl group, which is represented by R¹ and R² in the structure below. In some embodiments, the salt is formed by the nitrogen atom of the each pyridine ring acting as an anion, with the cation being selected from the group consisting of the halogens (e.g. chlorine, bromine, iodine, methyl chloride, and the like) and the sulfates, such as methyl sulfate, ethyl sulfate, and the like. For example, the anion may comprise one of the following structures.

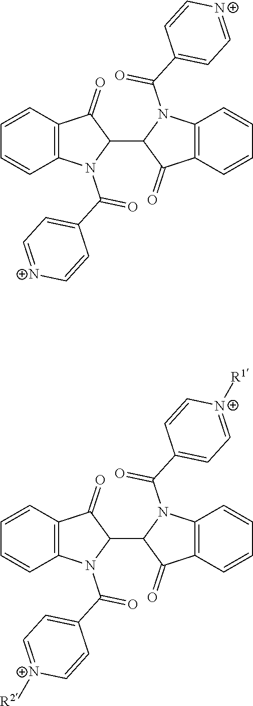

Particularly preferred modified indigo compound salts are shown below.

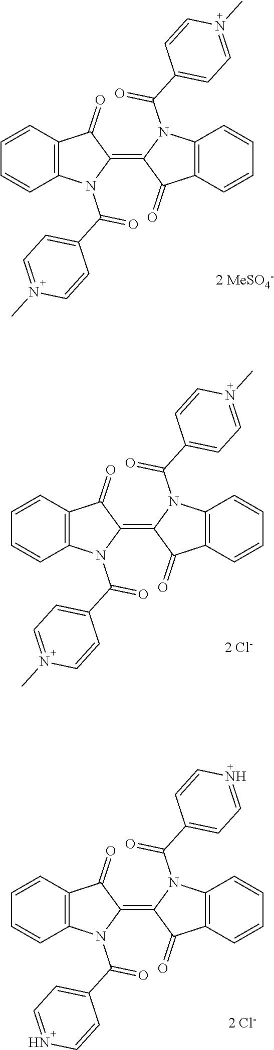

In addition to being readily convertible to indigo by the mechanisms described herein, each of these compounds has been found to have a particularly beneficial combination of oxygen stability, water stability, and water solubility that make them particularly suitable for digital printing as described herein.

In some embodiments, a bridge may link the pyridine ring with the rest of the modified indigo compound. For example, in some embodiments, the modified indigo compound may be selected from a compound having the following base structure, or a salt thereof:

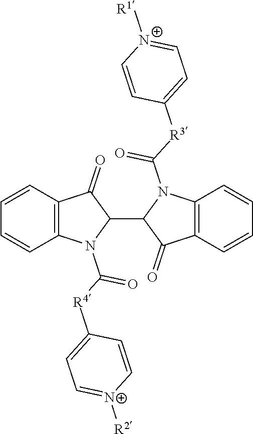

in which R^{3′} and R^{4′} may be an alkyl group, such as methyl, ethyl, propyl, or the like, or an alkoxide group. By the compound having the above-shown base structure, it is meant that each position in the above structure may include additional unshown substituents. Moreover, in the above structure, the nitrogen atom of each pyridine ring may comprise an alkane substituent, such as a methyl group, an ethyl group, or a propyl group, which is represented by R^{1′} and R^{2′}. In other embodiments, R^{1′} and R^{2′} in the above structure may simply be hydrogen. In some embodiments, the salt may be formed by the nitrogen atom of each pyridine ring acting as an anion, with the cation being selected from the group consisting of the halogens (e.g. chlorine, bromine, iodine, methyl chloride, and the like) and the sulfates, such as methyl sulfate, ethyl sulfate, and the like.

In contrast to the structures described above, in which the nitrogen atom of the pyridine ring is in the 3 position, the nitrogen atom of the pyridine ring may also be located in either the 2 or 4 positions. In some embodiments, for instance, the modified indigo compound may be selected from a compound having the following base structure, or a salt thereof:

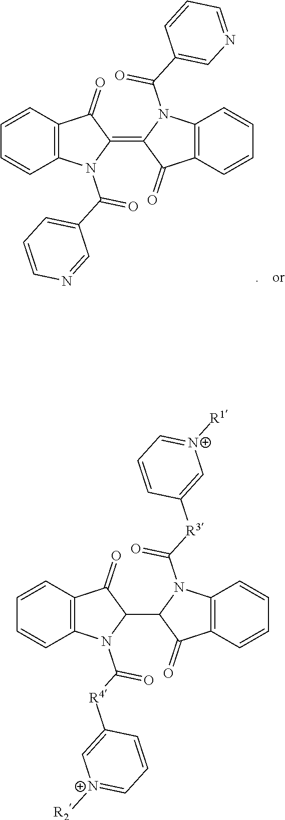

As with the above, by the compound having the above-shown base structure, it is meant that each position in the above structure may include additional unshown substituents. For instance, in some embodiments, the nitrogen atom of each pyridine ring may comprise an alkane substituent, such as a methyl group, an ethyl group, or a propyl group, which may be represented by R^{1′} and R^{2′} in the above structure. In other embodiments, R^{1′} and R^{2′} in the above structure may simply be hydrogen. Moreover, in some embodiments, the bridge linking the pyridine ring with the rest of the modified indigo compound represented by R³ and R^{4′} in the above structure may be lacking.

In other embodiments, R³ and R^{4′} may be an alkyl group, such as methyl, ethyl, propyl, or the like, or an alkoxide group. In some embodiments, the salt is formed by the nitrogen atom of each pyridine ring acting as an anion, with the cation being selected from the group consisting of the halogens (e.g. chlorine, bromine, iodine, methyl chloride, and the like) and the sulfates, such as methyl sulfate, ethyl sulfate, and the like. For example, in some embodiments, the modified indigo compound may be selected from the following salts:

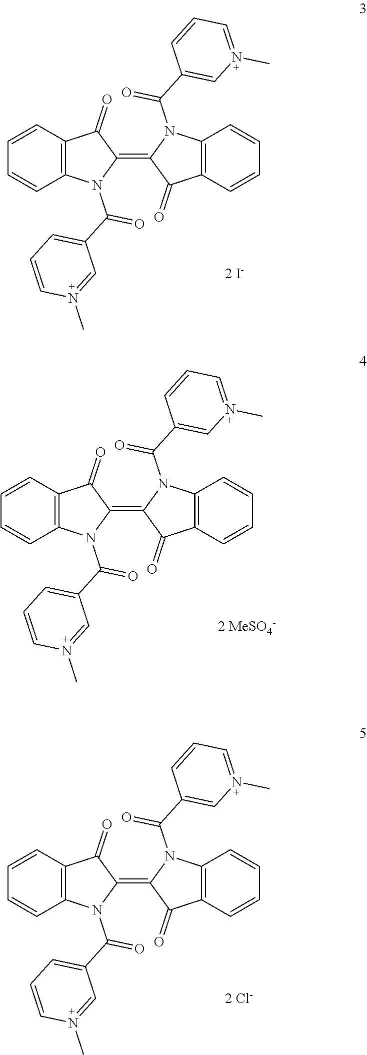

In contrast to the structures described above, in which the nitrogen atom of the pyridine ring is in the 2, 3, or 4 positions, the nitrogen atom of the pyridine ring may also be located in either the 1 or 5 positions. In some embodiments, for instance, the modified indigo compound may be selected from a compound having the following base structure, or a salt thereof:

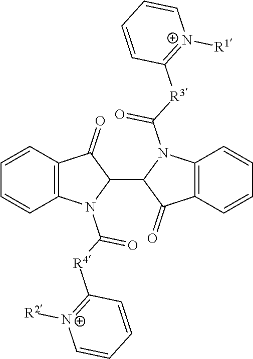

Again, by the compound having the above-shown base structure, it is meant that each position in the above structure may include additional unshown substituents. For instance, in some embodiments, the nitrogen atom of each pyridine ring may comprise an alkane substituent, such as a methyl group, an ethyl group, or a propyl group, which may be represented by R^{1′} and R^{2′} in the above structure. In other embodiments, R^{1′} and R^{2′} in the above structure may simply be hydrogen. Moreover, in some embodiments, the bridge linking the pyridine ring with the rest of the modified indigo compound represented by R^{3′} and R^{4′} in the above structure may be lacking. In other embodiments, R^{3′} and R^{4′} may be an alkyl group, such as methyl, ethyl, propyl, or the like, or an alkoxide group.

### II. Methods of Production

The compounds described above may be prepared by known chemical synthesis techniques. Among such preferred techniques known to one of skill in the art are included the synthetic methods described in conventional textbooks relating to the construction of synthetic compounds.

The above compounds comprising an indigo compound in which at least one of the amine groups is functionalized with an amido-pyridine or a salt thereof may generally be prepared according to Schemes 1-3.

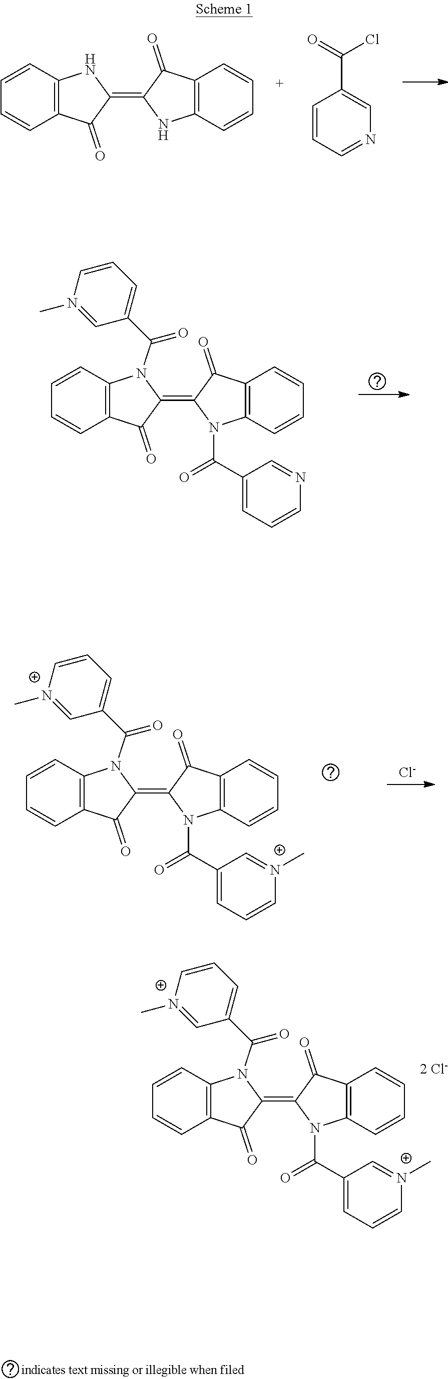

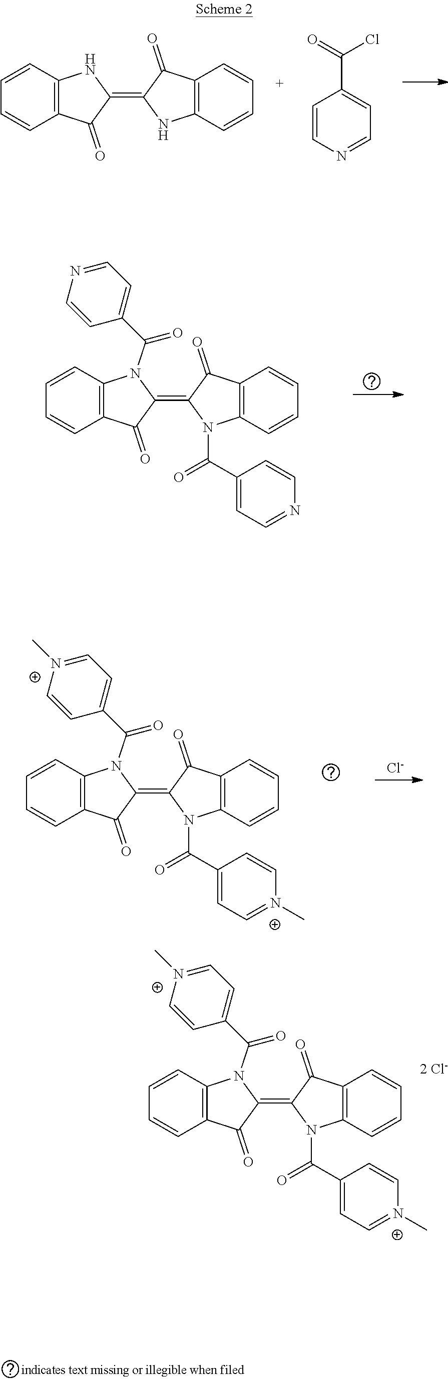

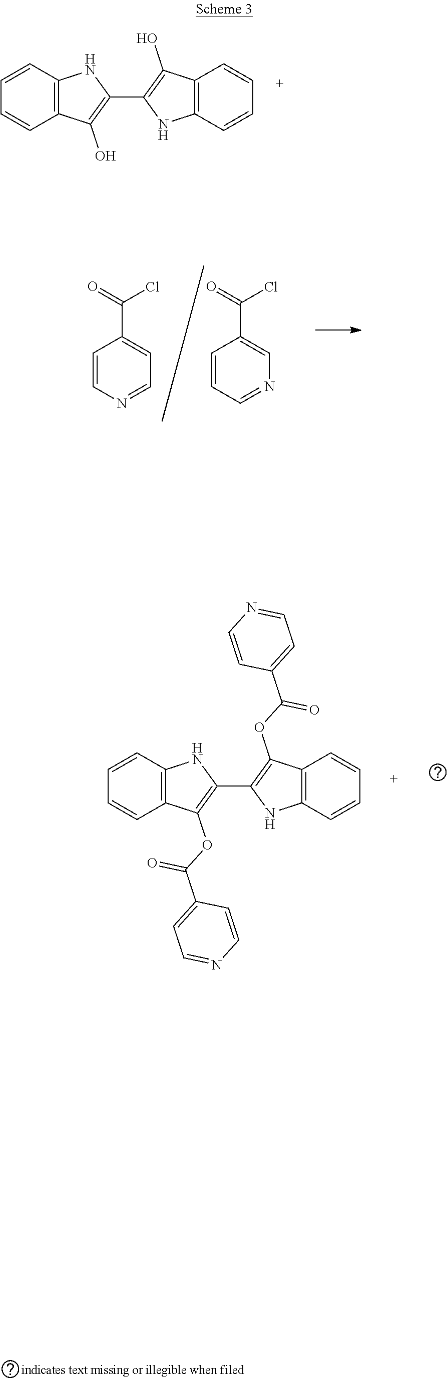 [SMILES: Oc1c(-c2[nH]c3ccccc3c2O)[nH]c2ccccc12 ; O=C(Cl)c1ccncc1 ; O=C(Cl)c1cccnc1 ; O=C(Oc1c(-c2[nH]c3ccccc3c2OC(=O)c2ccncc2)[nH]c2ccccc12)c1ccncc1]

In some embodiments, it may be desirable to dry the modified indigo compound at the conclusion of this process, so as to remove all or substantially all of the water. In doing so, one may prepare a powder comprising the modified indigo compound. This powder may be easily shipped and stored and will not convert to indigo during shipping and/or storage. Moreover, the powder may easily be dissolved at the mill to form the dye. Alternatively, the modified indigo compound may be added to a non-aqueous solvent for shipping and/or storage.

In some embodiments, the modified indigo compound may be prepared at the manufacturing location of the ink formulations and/or at the digital printing facility and/or immediately before the digital printing process. For instance, in some embodiments, one or more steps in the preparation process may be performed immediately prior to use of the modified indigo compound for formulating inks to be used in digital printing. As an example, the following compound.

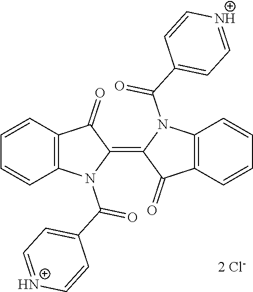 [SMILES: O=C1/C(=C2/C(=O)c3ccccc3N2C(=O)c2cc[nH+]cc2)N(C(=O)c2cc[nH+]cc2)c2ccccc21]

may be prepared by contacting the base structure (represented by the following:

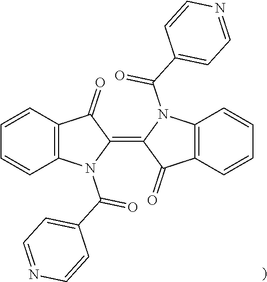 [SMILES: O=C1/C(=C2/C(=O)c3ccccc3N2C(=O)c2ccncc2)N(C(=O)c2ccncc2)c2ccccc21]

with an acid, such as hydrochloric acid. Such a step could easily be performed at the mill and immediately prior to use. This may be particularly beneficial where, for example, the intermediate structure may be more stable and/or easier to store than the modified indigo compound that is used in the digital printing process.

### III. Inks/Formulations Containing the Compound

Formulations useful herein, in one embodiment, contain a compound discussed above. As such, the formulations may be in the form of an ink, i.e., digital printing ink. Thus, the digital printing ink may be pre-prepared and the modified dye compound discussed herein added. Alternatively, a new ink may be prepared using the modified dye compound discussed herein and one or more components for used in digital printing. In some embodiments, the formulations contain a diluent. The term “diluent” as used herein refers to a liquid compound that is capable of solubilizing some or all of the compounds discussed herein. In some embodiments, the diluent is water. In other embodiments, the diluent contains water and an organic solvent such as low vapor pressure organic solvents. In further embodiments, the diluent contains an organic solvent. Examples of organic solvents include, without limitation, glycols such as ethylene glycol. diethylene glycol monomethyl ether, triethylene glycol monomethyl ether, diethylene glycol monoethyl ether, diethylene glycol dimethyl ether, diethylene glycol monobutyl ether, ethylene glycol monopropyl ether, triethylene glycol monomethyl ether, triethylene glycol monoethyl ether, tripropylene glycol monomethylether, tripropylene glycol monoethylether, 2-butoxyethanol, 2-ethoxyethanol, 2-methoxyethanol, ethyl lactate, N-propyl lactate, or butyrolactone, propylene glycol, alcohols such as glycerol, ketones, amines, or combinations thereof.

The formulations may also include optional suitable inert or inactive ingredients that are useful in formulations for digital printing of substrates. The formulations may further include standard dyeing or digital printing chemicals such as those described in Ujiie, “Digital Printing of Textiles,” Woodhead Publishing Series in Textiles, 1st Edition, 28 Apr. 2006; Shell, “Digital Textile Inkjet Printing: Current State of Technology,” SGIA Journal, 2017, 5-8; Chapman, “Digital Printing,” Textile World, May/June 2016, 32-36; and Andreottola, “Ink-Jet Formulation—The Art of Color Chemistry,” World Expo 2005, Aug. 24-26, 2005, Las Vegas, Nev., which are incorporated herein by reference.

In some embodiments, the chemicals may be utilized to prepare the substrate for digital printing, i.e., a pretreating step. In other embodiments, the standard digital printing chemicals are useful in the step of digital printing the substrate. In further embodiments, the standard digital printing chemicals are useful in digitally printing denim. In yet other embodiments, other digital printing chemicals are useful after digital printing is complete, i.e., a post-treating step such as a hydrolyzing step, neutralizing step, or a rinsing step. These compounds include, without limitation, one or more of an acid, cationic agent, chelating agent, color retention agent, coloring agent/colorant, dispersant, foaming agent, mercerization reagent, penetration enhancer, pH buffering agent, salt, stabilizing agent, solubilizing agent, surfactant, thickening agent, tracer, viscosity modifier, or wetting agent. In some embodiments, the additional components of the formulation include, without limitation, one or more of a surfactant, viscosity modifier, wetting agent, or thickening agent. One of skill in the art would be able to determine if a standard digital printing chemical may be used before, during, or after digital printing of the substrate.

In other embodiments, the formulation contains a cationic agent. In some embodiments the cationic agent is an ammonium salt such as diallyldimethylammonium chloride, polymerized diallyldimethylammonium chloride, [2-(acryloyloxy)ethyl] trimethylammonium chloride, 3-chloro-2-hydroxylpropyl trimethyl-ammonium chloride, or combinations thereof.

The formulation may further comprise a solubilizing agent. In some embodiments, the solubilizing is an organic solvent, surfactant, or emulsifier. In other embodiments, the organic solvent is a low vapor pressure organic solvent. Examples of organic solvents include, without limitation, diethylene glycol monomethyl ether, triethylene glycol monomethyl ether, diethylene glycol monoethyl ether, triethylene glycol monoethyl ether, propylene glycol, glycerol, or combinations thereof. In further embodiments, the surfactant is glyceryl monostearate, polyoxoethylated castor oil, polysorbates such as the Tween® surfactants, sodium lauryl sulfate, sodium dodecyl sulfate, sorbitan esters such as the Span® or Arlacel™ surfactants, stearyl alcohols, cetyl alcohols, triethanolamine, or the Triton™ X-100 surfactant, among others.

The formulation may also contain a stabilizing agent. Such agents may be selected by those skilled in the art and include, without limitation, NaCl, Na₂SO₄, a surfactant, or combinations thereof. In some embodiments, the surfactant is glyceryl monostearate, polyoxoethylated castor oil, polysorbates such as the Tween® surfactants, sodium lauryl sulfate, sodium dodecyl sulfate, sorbitan esters such as the Span® or Arlacel™ surfactants, stearyl alcohols, cetyl alcohols, triethanolamine, or the Triton™ X-100 surfactant, among others.

The formulation may further comprise one or more of a colorant. The particular colorant or use herein may be selected by one skilled in the art of digital printing. Thus, the colorant, in one embodiment, is a digital printing colorant. In some embodiments, the colorant is one or more of a pigment, reactive dye, acid dye, vat dye, direct dye, sulfur dye, natural dye, or basic dye.

Thus, in some embodiments, the disclosure provides digital printing inks that comprise one or more compound described herein, such as a compound of formula (I), (II), (IA), (IB), (IC), etc.

### IV. Methods of Using the Compounds

The methods of digital printing described herein are practical and feasible. Thus, the digital printing methods enhance design space, reduce cost, increase throughput and improve the sustainability of the denim production. In fact, the compounds discussed herein may be utilized in existing digital printing facilities with little to no change required for the mechanical equipment. The digital printing techniques described herein may selected by those skilled in the art including those recited in Ujiie, “Digital Printing of Textiles,” Woodhead Publishing Series in Textiles, 1st Edition, 28 Apr. 2006; Shell, “Digital Textile Inkjet Printing: Current State of Technology,” SGIA Journal, 2017, 5-8; Chapman, “Digital Printing,” Textile World, May/June 2016, 32-36; and Andreottola, “Ink-Jet Formulation—The Art of Color Chemistry,” World Expo 2005, August 24-26, 2005, Las Vegas, Nev., which are incorporated herein by reference.

In some embodiments, the digital printer uses multiple inks such as two, three, four, five or more inks. Furthermore, each ink may be a different color and/or intensity so as to provide the desired design palette. At least one ink contains a modified compound described herein. The digital printing may result in a substrate that is completely colored, i.e., covered with the dye compound. Alternatively, only a section of the substrate may be dyed, i.e., printed as described herein. In such embodiments, a particular pattern or image may be printed on the substrate as determined by one skilled in the art.

In some embodiments of the present disclosure, the process of digital printing with a modified indigo compound involves two basic steps. In a first step, a substrate such as a textile is printed with a dye solution that contains a modified indigo compound. In some embodiments, the printing is performed using a digital textile printer. One skilled in the art would be able to select a suitable digital textile printer. As a result of this contact, the substrate takes up an amount of the modified indigo compound. For example, when a cotton fabric is contacted with the dye solution, the dye solution both coats a surface of the fabric and penetrates some distance below the surface of the fabric. The amount of dye solution contained within the resulting fabric may be controlled by controlling the duration of the contact, the viscosity and the concentration of modified indigo in the dye solution. After printing, the substrate then undergoes further treatments as described below.

The methods are useful in printing a substrate by contacting one or more compound described herein with the substrate. The methods are also used in digital printing of a substrate using one or more of the compounds described herein with other colorants or the following compounds with the substrate:
(i) N,N′-dinicotinoyl-[2,2′-biindolinylidene]-3,3′-dione;
(i) the N″,N′″-methylpyridinium bis(methylsulfate) salt of N,N′-dinicotinoyl-[2,2′-biindolinylidene]-3,3′-dione;
(iii) N,N′-diacetyl-[2,2′-biindolinylidene]-3,3′-dione;
(iv) N,N′-dipropionyl-[2,2′-bi-indolinylidene]-3,3′-dione;
(v) N,N′-di-isobutyryl-[2,2′-biindolinylidene]-3,3′-dione;
(vi) N,N′-dipivaloyl-[2,2′-biindolinylidene]-3,3′-dione;
(vii) N,N′-bis(cyclohexylcarbonyl)-2,2′-bi-indolinylidene-3,3′-dione;
(viii) N,N′-bis(3-phenylpropionyl)-2,2′-bi-indolinylidene-3,3′-dione;
(ix) N,N′-bis(ethoxycarbonylacetyl)-2,2′-bi-indolinylidene-3,3′-dione;
(x) N,N′-bis(2-phenylacetyl)-[2,2′-bi-indolinylidene]-3,3′-dione;
(xi) N,N′-bis-(p-methoxyphenylacetyl)2,2′-bi-indolinylidene-3,3′-dione;
(xii) N,N′-bis(1-naphthylacetyl)-2,2′-bi-indolinylidene-3,3′-dione;
(xiii) N,N′-bis(2-phenylbutyryl)-2,2′-indolinylidene-3,3′-dione;
(xiv) (E)-1,1′-di(adamantane-1-carbonyl)-[2,2′-biindolinylidene]-3,3′-dione.
(xv) 1H,1′H-[2,2′-biindole]-3,3′-diyl diacetate;
(xvi) 3,3′-bis(phenylacetoxy)-2,2′-bi-indolyl;
(xvii) 3,3′-bis(p-methoxyphenylacetoxy)-2,2′-bi-indolyl;
(xviii) 3,3′-bis(1-napthylacetoxy)-2,2′-bi-indolyl;
(xix) 3,3′-bis(phenylbutyryloxy)-2,2′-bi-indolyl;
(xx) 3,3′-bis(pivaloyloxy)-2,2′-bi-indolyl;
(xxi) 3,3′-bis(1-adamantylcarbonyloxy)-2,2′-bi-indolyl; or
(xxii) 3,3′-bis(ethoxycarbonylacetoxy)-2,2′-bi-indolyl.

The term “substrate” as used herein refers to a material that may be dyed using the compounds described herein. The substrate contains natural substrates, synthetic substrates, or combinations thereof. In some embodiments, the substrate is natural. In other embodiments, the substrate is synthetic. In further embodiments, the substrate contains natural and synthetic components. In some embodiments, the substrate contains about 10% of a natural substrate and 90% of a synthetic substrate. In other embodiments, the substrate contains about 20% of a natural substrate and about 80% of a synthetic substrate. In further embodiments, the substrate contains about 30% of a natural substrate and about 70% of a synthetic substrate. In yet other embodiments, the substrate contains about 40% of a natural substrate and about 60% of a synthetic substrate. In still further embodiments, the substrate contains about 50% of a natural substrate and about 50% of a synthetic substrate. In other embodiments, the substrate contains about 60% of a natural substrate and about 40% of a synthetic substrate. In further embodiments, the substrate contains about 70% of a natural substrate and about 30% of a synthetic substrate. In yet other embodiments, the substrate contains about 80% of a natural substrate and about 20% of a synthetic substrate. In still further embodiments, the substrate contains about 90% of a natural substrate and about 10% of a synthetic substrate.

The natural substrate may be selected by those skilled in the art from, without limitation, plant or animal substrates. Plant fibers include cotton, kapok, hemp, bamboo, flax, sisal, jute, kenaf, ramie, bamboo, soybean, or coconut, among others. Animal substrates include silk, wool, leather, hair, feather, among others. In some embodiments, the animal substrate is silk, wool, leather, or feather. In other embodiments, the substrate comprises a synthetic fiber such as a synthetic polymer. The synthetic substrate may be prepared using viscose or lyocel processes, preferably or from regenerated/spun cellulose processes. Thus, the synthetic substrate includes, without limitation, rayon such as lyocel (TENCEL®), a polyamide such as nylon, polyester, polyacrylate, polyolefin, or spandex. In some embodiments, the synthetic substrate is a polyamide such as nylon. In other embodiments, the polyester is polyethylene terephthalate. In further embodiments, the polyolefin is polypropylene or polyethylene. In still other embodiments, the polyacrylate is a copolymer of polyacrylonitrile. In contrast to the methods used in the art for digitally printing synthetic substrates, the methods described herein do not require heating the substrate, e.g., to the substrate's T_{g}, during the digital printing process.

While the present disclosure is primarily described in relation to the digital printing of fabric, it should be understood that the modified indigo compounds and digital printing processes disclosed herein may also be used to dye any number of different textile materials, including without limitation fibers comprising cellulosic material, such as silk, wool, rayon, lyocel, flax, linen, ramie, and the like, as well as materials comprising combinations thereof.

The substrate may be in any physical form or shape that permits digital printing by the compounds described herein. Thus, the substrate is a number of fibers gathered together in another form. In some embodiments, the substrate is in the form of a sheet. In other embodiments, the substrate is a fabric such as a garment. Thus, the synthetic substrate may also be woven, knit, or non-woven. Thus, the fibers may be woven to form a sheet such as a textile. In some embodiments, the dye substrate or textile is denim. In further embodiments, the substrate is a fabric or textile such as clothing or garment.

The term “contacting” as used herein refers to a route of printing the substrate with the dye compound.

As previously discussed, the ink formulation is jetted from a digital ink printer. One of skill in the art would understand how to jet the ink formulation onto the substrate. In some embodiments, the ink formulation is jetted at a distance from the substrate of about less than about 5 mm, less than about 4 mm, less than about 3 mm, less than about 2 mm, or less than about 2 mm.

A printing ink or formulation as described above is utilized to dye the substrate. In some embodiments, each printing ink comprises about 0.5 wt. % to about 70 wt. %, based on the weight of the ink, of the compound. In other embodiments, the ink comprises about 1 wt. % to about 50 wt. %, based on the weight of the ink, of the compound. In further embodiments, the ink comprises about 2 wt. % to about 30 wt. %, based on the weight of the ink, of the compound. In still other embodiments, the ink contains about 5 to about 25 wt. %, based on the weight of the ink, of the compound. In yet further embodiments, the ink contains about 10 to about 20 wt. %, based on the weight of the ink, of the compound. In other embodiments, the ink contains about 12 to about 18 wt. %, based on the weight of the ink, of the compound. In further embodiments, the ink contains about 14 to about 16 wt. %, based on the weight of the ink, of the compound. Preferably, the ink contains about 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt. %, based on the weight of the ink, of the compound. More preferably, each ink contains about 1 to about 3 wt. % to about 70 wt. %, based on the weight of the ink, of the compound. Even more preferably, each ink contains about 2 wt. % to about 70 wt. %, based on the weight of the ink, of the compound.

In addition to the compound and water or an organic solvent, the ink may contain other additional components such as those described above for formulations containing the compound. These compounds include, without limitation, an acid, cationic agent, caustic agent, chelating agent, color retention agent, coloring agent, dispersant, foaming agent, hydrolyzing agent, mercerization reagent, penetration enhancer, pH buffering agent, salt, solubilizing agent, stabilizing agent, surfactant, thickening agent, tracer, viscosity modifier, wetting agent, or combinations thereof. These additional components may be in the form of inks that are printed in tandem with the modified dye compounds described herein. One of skill in the art would be able to determine if a standard digital printing chemical may be used before, during, or after printing the substrate. In some embodiments, the ink lacks a solubilizing agent. In other embodiments, the ink contains solubilizing agent. In further embodiments, the ink is acidic, i.e., has a pH of less than about 7. In some embodiments, the ink as a pH of about 0.5 to about 7, about 1 to about 7, about 1 to about 6, about 1 to about 5, about 1 to about 4, about 1 to about 3, about 1 to about 2, about 1, about 2, about 3, about 4, about 5, about 6, or about 7.

The dye compound formulation ink may also be deposited concurrently with one or more of a textile digital printing ink such as, without limitation, one or more of a pigment, reactive dye, acid dye, vat dye, direct dye, sulfur dye, natural dye, or basic dye.

In another step, the modified indigo compound that has been taken up by the dye-treated substrate is converted to indigo through a process of hydrolysis. In some embodiments, the substrate is contacted with a hydrolyzing agent, the hydrolyzing agent being capable of reacting with the modified indigo compound contained within the substrate to convert the modified indigo compound into indigo. The hydrolysis may be performed using instruments and techniques known to those skilled in the art including, without limitation, padding, spraying, or a bath.

In some embodiments, the substrate may be contacted with an alkali agent in order to hydrolyze the modified indigo compound so as to convert it into indigo. The contacting of the substrate with the alkali hydrolyzing agent may be performed in a number of different manners. For instance, the substrate may be dipped in a solution containing the alkali agent, e.g. an aqueous hydrolyzing bath, or a solution containing the alkali agent may be sprayed onto the substrate. By converting the modified indigo compound into indigo, an indigo-dyed substrate is produced.

In many digital printing processes, multiple iterations of this two-step process will be necessary in order to obtain a desirable shade of indigo. Accordingly, in many digital printing processes, once the modified indigo compound on the substrate is converted into indigo, the substrate will again be contacted with dye solution containing a modified indigo compound. One of skill in the art would be able to determine how many instances it is necessary to contact the substrate with the dye compound. Although the substrate may only require contacting it once with the dye compound, the substrate typically is contacted with the dye compound at least two times such as 1-3 times.

The methods described herein may also include applying a clear aqueous ink to the substrate. In some embodiments, the clear aqueous ink may be applied after the dye compound ink formulation. In other embodiments, the clear aqueous ink is applied concurrently with the dye compound ink formulation. The clear aqueous ink may be selected by one skilled in the art, including, without limitation, one or more of an anti-migrant, pH buffering agent, cationic agent, anionic agent, viscosity modifier, hydrolysis catalyst, alkali agent, chelating agent, salt, surfactant, thickening agent, or wetting agent. In some embodiments, the clear aqueous ink is an anti-migrant.

A further step includes hydrolyzing the dye compound in the dyed substrate to indigo. In some embodiments, hydrolysis of the dye compound is performed with a solution which contains water. In other embodiments, hydrolysis is performed with water. The water can be from a fresh source or may be reused. Thus, the water can contain other components including, without limitation, an acid, cationic agent, chelating agent color retention agent, coloring agent, dispersant, foaming agent, mercerization reagent, organic solvent, pH buffering agent, penetration enhancer, salt, stabilizing agent, solubilizing agent, surfactant, thickening agent, tracer, viscosity modifier, or wetting agent. In some embodiments, the rinse water contains an acid, cationic agent, chelating agent, dispersant, foaming agent, organic solvent, pH buffering agent, penetration enhancer, salt, solubilizing agent, surfactant, thickening agent, tracer, viscosity modifier, or wetting agent.

The hydrolysis is performed using any chemical compound or condition that is capable of converting the dye compound to indigo. In some embodiments, the hydrolysis is performed in aqueous compositions which contain a hydrolyzing agent. In other embodiments, the hydrolyzing agent may be selected by one skilled in the art and may include, without limitation, a base, heat, steam, or a combination thereof.

In some embodiments, the hydrolyzing agent is an alkali agent. Preferably, the alkali agent ensures that the pH of the hydrolysis is raised to greater than about 11. For example, the base is an oxide, hydroxide of alkali metals or alkaline earth metal, or carbonate of an alkali or alkaline earth metal. In some embodiments, the hydrolysis is performed with an oxide. In other embodiments, the hydrolysis is performed with a hydroxide of an alkali metal such as sodium hydroxide, potassium hydroxide, or lithium hydroxide. In further embodiments, the hydrolysis is performed with a carbonate such as sodium carbonate or potassium carbonate. In still other embodiments, the hydrolysis is performed with a hydroxide of an alkaline earth metal.

The hydrolysis may also be performed using an elevated temperature such as heat or steam. Thus, in some embodiments, the hydrolysis may be performed using heat such as by contacting the dyed substrate with a heat plate or blowing hot air on the dyed substrate. One skilled in the art would be able to select a suitable temperature for use in the hydrolysis of the dye compound. For example, the heat comprises a temperature of at least about 40° C. In some embodiments, the heat comprises a temperature of about 40 to about 200° C. In other embodiments, the heat comprises a temperature of about 40 to about 80° C. In further embodiments, the heat comprises a temperature of about 40 to about 70° C. In still further embodiments, the heat comprises a temperature of about 80 to about 200° C., such as about 100 to about 200° C., about 120 to about 200° C., about 150 to about 200° C., about 180 to about 200° C., about 80 to about 100° C., about 80 to about 120° C., about 80 to about 140° C., about 80 to about 160° C., about 80 to about 180° C., or about 80, 90, 100, 110, 120, 130, 140, 150, 160, 170, 180, 190, or about 200° C.

Similarly, steam may be used to effect the hydrolysis. In some embodiments, steam is sprayed onto the dyed substrate or the dyed substrate is passed through a unit comprising an atmosphere of steam. The temperature of the steam is desirably at a temperature recited above.

The hydrolysis may be effected using a spray or by submersing the substrate into a hydrolysis bath. Additionally, the hydrolysis may be performed by a component of the ink formulation. In some embodiments, the hydrolysis is performed with another ink, such as an alkali ink, that is present in the ink formulation.

After the hydrolysis is complete, additional digital printing steps and hydrolysis steps may be utilized until the desired dye penetration or color is attained by the substrate. It may also be desirable to dry the dyed substrate prior to hydrolyzing. Thus, in some embodiments, the substrate is dyed as described herein, dried, and hydrolyzed as described herein. In some embodiments, the digital printing step is repeated 1 to about 50, 2 to about 30, 5 to about 25, 10 to about 20, or 1 to about 2, 3, 4, 5, 6, 7, 8, 9, 10, 11, 12, 13, 14, 15, 16, 17, 18, 19, 20, 21, 22, 23, 24, or 25 times. Similarly, the hydrolysis step may be repeated the same number of times that the digital printing step is repeated. In some embodiments, the hydrolysis is repeated 1 to about 50, 2 to about 30, 5 to about 25, 10 to about 20, or 1 to about 2, 3, 4, 5, 6, 7, 8, 9, 10, 11, 12, 13, 14, 15, 16, 17, 18, 19, 20, 21, 22, 23, 24, or 25 times.

Following printing and hydrolyzing, the substrate may be rinsed or washed using techniques known to those skilled in the art. Similarly, the rinsing step may be performed between one or more of the digital printing and hydrolyzing steps. Preferably, one or more rinsing steps are performed after all digital printing and hydrolyzing steps are complete. However, in embodiments where the hydrolysis is performed using heat, such as an iron, hot air, or steam, a rinsing step may not be required. In situations where a rinsing step is performed, it may be is repeated 1 to about 50, 2 to about 30, 5 to about 25, 10 to about 20, or 1 to about 2, 3, 4, 5, 6, 7, 8, 9, 10, 11, 12, 13, 14, 15, 16, 17, 18, 19, 20, 21, 22, 23, 24, or 25 times.

Desirably, the rinsing is performed using an aqueous solution. In some embodiments, the aqueous rinsing solution contains water. In other embodiments, the aqueous rinsing solution contains water and additional components such as organic solvents including those described herein. In further embodiments, the aqueous rinsing solution comprises a neutralization agent. The term “neutralization agent” as used herein refers to a chemical compound that neutralizes the hydrolyzing agent, if used. For example, the neutralization agent adjusts the pH of the dyed substrate to a pH of about 5 to about 9, e.g., about 6 to about 8, about 6 to about 7, about 6, 6.5, 7, 6.5 7, 7.5, 8, 8.5, or 9. In some examples, the neutralization agent is an acid or a base, as determined by the pH of the rinsate solution. In other examples, the neutralization agent is an acid such as acetic acid. In further examples, the neutralization agent is a base such as ammonia. In still other examples, the neutralization agent is pH adjusted water. In further embodiments, the aqueous rinsing solution contains buffering agent.

The printing is performed until the desired color of the substrate is reached. The desired color may be determined by one skilled in the art using techniques and instruments such as color spectrophotometers.

In some embodiments, hydrolyzing the modified indigo compound may comprise subjecting the dye-treated substrate to a heat treatment at an elevated temperature. For example, the dye-treated substrate may be subjected to elevated temperatures of greater than 60° C., alternatively greater than 80° C., alternatively greater than 100° C. It is noted that the substrate itself need to obtain the stated temperature, but rather that the substrate be subjected to the elevated temperature for a period of time sufficient to bring about conversion of the modified indigo compound into indigo. To increase the speed at which hydrolysis occurs, the heat treatment may also comprise contacting the dye-treated fabric with a moisture-rich atmosphere. For example, in some embodiments the dye-treated fabric may be contacted with steam. The application of heat (and optionally moisture, e.g. steam) to the dye-treated fabric triggers the hydrolysis of the modified indigo compound, decreasing the time necessary for conversion to indigo to occur. In some embodiments, for example, the application of heat (e.g. air heat, contact heat, etc.) and optionally moisture may be controlled to convert the modified indigo compound into indigo in less than fifteen minutes, alternatively less than ten minutes, alternatively less than eight minutes, alternatively less than six minutes, alternatively less than five minutes, alternatively less than three minutes.

In some embodiments, the substrate such as a cotton fabric may be pre-treated with an anti-migrant, pH buffering agent, anionic agent, humectant, hydrolysis catalyst, agent that improves color yield, caustic agent, or cationic agent prior to being contacted with the dye containing the modified indigo compound. The particular caustic or cationic agent may be readily selected by one skilled in the art from such reagents that may be utilized to prepare the substrate for digital printing. Examples of caustic agents that might be used in such a pre-treatment include inorganic alkalis, such as hydroxides such as sodium hydroxide, or potassium hydroxide, carbonates such as sodium carbonate, and the like, and organic alkalis, including members of the amine family such as diethanolamine, trimethylamine, hexamethylenediamine, liquid ammonia, and the like, or combinations thereof. Examples of cationic agents that might be used in such a pretreatment include diallyldimethylammonium chloride (DADMAC), polymerized diallyldimethylammonium chloride (Poly-DADMAC), [2-(acryloyloxy)ethyl]trimethylammonium chloride (AOETMAC), 3-chloro-2-hydroxylpropyl trimethyl-ammonium chloride (CHPTAC, Quat 188), and the like, or combinations thereof.

The inventors have found that pre-treatments utilized prior to digital printing permits the use of lower temperatures to effect the hydrolysis as described above. For example, the use of a pretreatment permits the use of lower hydrolysis temperatures of about 4 0 to about 80° C. as needed by the particular digital printing method.

At any point in the process, the substrate may be dried, although such a step is not required. The drying temperature may be determined by one skilled in the art. In some embodiments, the drying is performed at elevated temperatures. In other embodiments, the drying is performed at a temperature of about 50 to about 120° C. In further embodiments, the drying is performed at a temperature of about 60 to about 120° C., about 60 to about 120° C., about 70 to about 100° C., about 80 to about 120° C., or about 70 to about 120° C.

### V. Kits Containing the Compound

Also provided are kits comprising an ink comprising one or more dye compound described herein and a reagent or device that converts the compound to indigo. Advantageously, because the above-described compounds are stable in a dried state, they can more easily be transported and/or stored for future use.

In some embodiments, the reagent that converts the compound to indigo is a base. In other embodiments, the reagent that converts the compound to indigo is a device that generates heat. In other embodiments, the reagent that converts the compound to indigo is a device that generates steam.

The kits may also include other ink formulations that may be combined with the ink formulations described herein that contain the modified dye compound. In other embodiments, the kits may include premixes to prepare the ink formulations.

The kits may also include cartridges that contain the ink formulation described herein. In some embodiments, the kits include 1, 2, 3, 4, 5, or more cartridges. Thus, the dye compounds described herein may be in one or more of these ink cartridges.

The dye compounds may be provided in neat form, i.e., in the absence of other reagents, or in a preblended ink formulation for use in the methods described herein. When provided as a preblended ink formulation, it may be provided as a concentrate for dilution or an in formulation that is at the appropriate concentration for immediate use, i.e., in an “as-is” formulation.

It can be seen that the described embodiments provide unique and novel inks that contain modified indigo compounds and a unique and novel process for printing a substrate using modified indigo compounds, each of which having a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### VI. Aspects

Aspect 1. A method of digital printing on a substrate, comprising applying an ink formulation comprising a dye compound to a substrate, the dye compound comprising an indigo derivative, or a salt thereof, having one or more modification over the chemical structure of indigo, wherein the indigo derivative has a water-solubility of greater than 0.2% w/v in the absence of a reducing agent and in the presence oxygen, and converts to indigo upon removing the modification, wherein the chemical structure of indigo is the following:

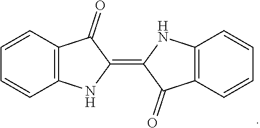 [SMILES: O=C1/C(=C2\Nc3ccccc3C2=O)Nc2ccccc21]

Aspect 2. The method of Aspect 1, wherein the formulation further comprises one or more of a component for digital printing.
Aspect 3. The method of Aspect 1 or 2, wherein the formulation comprises water.
Aspect 4. The method of any one of the preceding Aspects, wherein the formulation comprises an organic solvent.
Aspect 5. The method of Aspect 4, wherein the solvent is one or more of ethylene glycol, propylene glycol, glycerol, diethylene glycol dimethyl ether, diethylene glycol monomethyl ether, diethylene glycol monoethyl ether, diethylene glycol monobutyl ether, ethylene glycol monopropyl ether, triethylene glycol monomethyl ether, triethylene glycol monoethyl ether, tripropylene glycol monomethylether, tripropylene glycol monoethylether, 2-butoxyethanol, 2-ethoxyethanol, 2-methoxyethanol, ethyl lactate, N-propyl lactate, or butyrolactone
Aspect 6. The method of any one of the preceding Aspects, wherein the formulation further comprises one or more of a surfactant, viscosity modifier, wetting agent, thickening agent, chelating agent, color retention agent, penetration enhancer, pH buffering agent, salt, solubilizing agent, or stabilizing agent.
Aspect 7. The method of any one of the preceding Aspects, wherein the formulation comprises one or more of a colorant.
Aspect 8. The method of Aspect 7, wherein the colorant is one or more of a pigment, reactive dye, acid dye, vat dye, direct dye, sulfur dye, natural dye, or basic dye.
Aspect 9. The method of any one of the preceding Aspects, further comprising pretreating the substrate.
Aspect 10. The method of Aspect 9, wherein the pretreating comprises contacting the substrate with one or more of an anti-migrant, pH buffering agent, cationic agent, anionic agent, humectant, hydrolysis catalyst, agent that improves color yield, or alkali agent.
Aspect 11. The method of any one of the preceding Aspects, further comprising drying the substrate.
Aspect 12. The method of Aspect 11, wherein the substrate is dried at an elevated temperature.
Aspect 13. The method of Aspect 12, wherein the elevated temperature is about 50 to about 120° C.
Aspect 14. The method of any one of the preceding Aspects, further comprising hydrolyzing the substrate.
Aspect 15. The method of Aspect 14, wherein the hydrolyzing converts the dye compound to an ink.
Aspect 16. The method of Aspect 14 or 15, wherein the hydrolyzing is performed using a spray or by submersing the dye substrate into a hydrolysis bath.
Aspect 17. The method of any one of Aspects 14-16, wherein the hydrolyzing is performed using steam, heat, or a combination thereof.
Aspect 18. The method of any one of the preceding Aspects, further comprising applying a clear aqueous ink to the substrate.
Aspect 19. The method of Aspect 18, wherein the clear aqueous ink comprises one or more of an anti-migrant, pH buffering agent, cationic agent, anionic agent, viscosity modifier, hydrolysis catalyst, alkali agent, chelating agent, salt, surfactant, thickening agent, or wetting agent.
Aspect 20. The method of Aspect 18 or 19, wherein the clear aqueous ink is an anti-migrant.
Aspect 21. The method of any one of Aspects 18-20, wherein the anti-migrant is applied concurrently with the dye compound.
Aspect 22. The method of any one of Aspects 18-20, wherein the anti-migrant is applied after the dye compound.
Aspect 23. The method of any one of the preceding Aspects, comprising depositing the dye compound concurrently with one or more of a textile digital printing ink such as one or more of a pigment, reactive dye, acid dye, vat dye, direct dye, sulfur dye, natural dye, or basic dye.
Aspect 24. The method of any one of the preceding Aspects, wherein the dye compound converts to indigo through hydrolysis, such as using a hydrolyzing agent, heat, steam, or combinations thereof.
Aspect 25. The method of any one of the preceding Aspects, wherein the dye compound is substantially stable in the presence of oxygen such as in aqueous solutions.
Aspect 26. The method of any one of the preceding Aspects, wherein the dye compound has greater water solubility than indigo.
Aspect 27. The method of any one of the preceding Aspects, wherein the substrate is a textile.
Aspect 28. The method of any one of the preceding Aspects, wherein the substrate is a natural substrate such as a plant fiber such as cotton, kapok, hemp, bamboo, flax, sisal, jute, kenaf, ramie, bamboo, soybean, or coconut or an animal substrate such as silk, wool, leather, hair, or feather.
Aspect 29. The method of any one of the preceding Aspects, wherein the substrate is a synthetic substrate such as a polyamide such as nylon, polyester, acrylic, polyolefin, or spandex.
Aspect 30. The method of any one of the preceding Aspects, wherein the substrate is a fabric.
Aspect 31. The method of any one of the preceding Aspects, wherein the ink formulation comprising the dye compound is jetted from a digital printer.
Aspect 32. The method of any one of the preceding Aspects, wherein the dye compound is not:
   (i) N,N′-dinicotinoyl-[2,2′-biindolinylidene]-3,3′-dione;
   (ii) the N″,N′″-methylpyridinium bis(methylsulfate) salt of N,N′-dinicotinoyl-[2,2′-biindolinylidene]-3,3′-dione;
   (iii) N,N′-diacetyl-[2,2′-biindolinylidene]-3,3′-dione;
   (iv) N,N′-dipropionyl-[2,2′-bi-indolinylidene]-3,3′-dione;
   (v) N,N′-di-isobutyryl-[2,2′-biindolinylidene]-3,3′-dione;
   (vi) N,N′-dipivaloyl-[2,2′-biindolinylidene]-3,3′-dione;
   (vii) N,N′-bis(cyclohexylcarbonyl)-2,2′-bi-indolinylidene-3,3′-dione;
   (viii) N,N′-bis(3-phenylpropionyl)-2,2′-bi-indolinylidene-3,3′-dione;
   (ix) N,N′-bis(ethoxycarbonylacetyl)-2,2′-bi-indolinylidene-3,3′-dione;
   (x) N,N′-bis(2-phenylacetyl)-[2,2′-bi-indolinylidene]-3,3′-dione;
   (xi) N,N′-bis-(p-methoxyphenylacetyl)2,2′-bi-indolinylidene-3,3′-dione;
   (xii) N,N′-bis(1-naphthylacetyl)-2,2′-bi-indolinylidene-3,3′-dione;
   (xiii) N,N′-bis(2-phenylbutyryl)-2,2′-indolinylidene-3,3′-dione;
   (xiv) (E)-1,1′-di(adamantane-1-carbonyl)-[2,2′-biindolinylidene]-3,3′-dione;
   (xv) 1H,1′H-[2,2′-biindole]-3,3′-diyl diacetate;
   (xvi) 3,3′-bis(phenylacetoxy)-2,2′-bi-indolyl;
   (xvii) 3,3′-bis(p-methoxyphenylacetoxy)-2,2′-bi-indolyl;
   (xviii) 3,3′-bis(1-napthylacetoxy)-2,2′-bi-indolyl;
   (xix) 3,3′-bis(phenylbutyryloxy)-2,2′-bi-indolyl;
   (xx) 3,3′-bis(pivaloyloxy)-2,2′-bi-indolyl;
   (xxi) 3,3′-bis(1-adamantylcarbonyloxy)-2,2′-bi-indolyl; or
   (xxii) 3,3′-bis(ethoxycarbonylacetoxy)-2,2′-bi-indolyl.
Aspect 33. The method of any one of the preceding Aspects, wherein the one or more modification enhances the aqueous solubility of the dye compound lacking the modification.
Aspect 34. The method of any one of the preceding Aspects, wherein the one or more modification is a substituent on indigo or the indigo derivative.
Aspect 35. The method of Aspect 33, wherein the substituent is on one or both nitrogen atoms.
Aspect 36. The method of Aspect 33, wherein the substituent is on one or more carbon atom.
Aspect 37. The method of any one of Aspects 33-36, wherein the substituent is on one more both oxygen atoms.
Aspect 38. The method of any one of Aspects 33-37, wherein the substituent is an alkyl, cycloalkyl, alkoxy, halide, acyl, amine, ester, amide, aryl, heteroaryl, heterocyclyl, sulfonate, carbamate, urea, imine, oxime, anhydride, CN, NO₂, mesylate, or tosylate, wherein each is optionally substituted.
Aspect 39. The method of any one of the preceding Aspects, wherein the dye compound is of Formula (I) or (II):

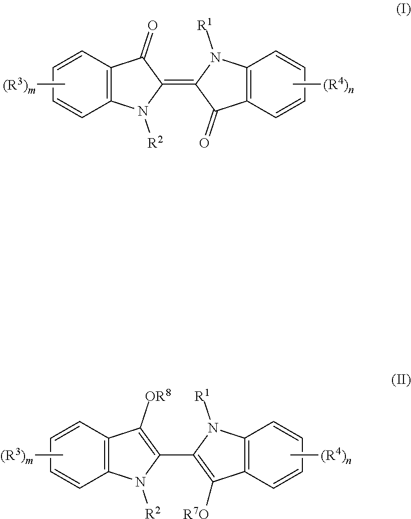

wherein:
   R¹ and R² are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted heteroaryl), C(O)-(optionally substituted heterocyclyl), C(O)-(optionally substituted C₁₋₆hydroxyalkyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), C(O)O-(optionally substituted heterocyclyl); or
   R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
   R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl);
   R^{A} and R^{B} are, independently, H or optionally substituted C₁₋₆alkyl, or optionally substituted aryl;
   R^{C} is H, optionally substituted C₁₋₆alkyl, optionally substituted C₃₋₈cycloalkyl, optionally substituted aryl, optionally substituted heteroaryl, or optionally substituted heterocyclyl;
   m and n are, independently, 0 to 4;
   or a salt thereof.
Aspect 40. The method of Aspect 39, wherein when the compound is of Formula (I), R³ and R⁴ are not H, when R¹ and R² are both 1-methyl-pyridyl-3-yl.
Aspect 41. The method of Aspect 39 or 40, wherein m is 0.
Aspect 42. The method of any one of Aspects 39-41, wherein n is 0.
Aspect 43. The method of Aspect 39 or 40, wherein R³ is a halide.
Aspect 44. The method of any one of Aspects 39, 40, or 43, wherein R⁴ is a halide.
Aspect 45. The method of any one of Aspects 39, 40, or 44, wherein R³ is C₁₋₆alkyl.
Aspect 46. The method of any one of Aspects 30, 40, 43, or 44, wherein R⁴ is C₁₋₆alkyl.
Aspect 47. The method of any one of Aspects 39-46, wherein one of R¹ or R² is H.
Aspect 48. The method of any one of Aspects 39-46, wherein one of R¹ and R² is SO₃H.
Aspect 49. The method of Aspect 39, wherein the dye compound is of Formula (I):

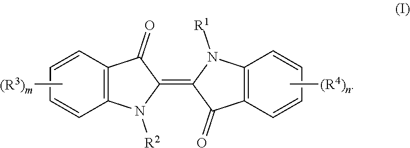

Aspect 50. The method of any one of Aspects 39-49, wherein one or both of R¹ and R² is C(O)-(optionally substituted heteroaryl).
Aspect 51. The method of any one of Aspects 39-50, wherein one or both of R¹ and R² is C(O)-(optionally substituted pyridyl), such as C(O)-(optionally substituted 2-pyridyl), C(O)-(optionally substituted 3-pyridyl), or C(O)-(optionally substituted 4-pyridyl).
Aspect 52. The method of Aspect 53, wherein the pyridyl is substituted with C₁₋₆alkyl.
Aspect 53. The method of Aspect 51 or 52, wherein the pyridyl is substituted with one or more methyl or ethyl.
Aspect 54. The method of any one of Aspects 51-53, wherein the pyridyl is substituted on the N-atom.
Aspect 55. The method of any one of Aspects 39-49, wherein one or both of R¹ and R² is C(O)-(optionally substituted aryl), such as C(O)-(optionally substituted phenyl).
Aspect 56. The method of any one of Aspects 39-49, wherein one or both of R¹ and R² is C(O)NR^{A}R^{B}, wherein one or both of R^{A} and R^{B} is H, optionally substituted C₁₋₆hydroxyalkyl, or optionally substituted C₁₋₆alkyl.
Aspect 57. The method of any one of Aspects 39-49, wherein one or both of R¹ and R² are C(O)O-(optionally substituted heterocyclyl) such as C(O)O-(optionally substituted pyrrolidone).
Aspect 58. The method of any one of Aspects 39-49, wherein one or both of R¹ and R² are, independently, C(O)O-(optionally substituted alkyl) such as C(O)O(alkyl substituted with heterocyclyl) such as C(O)O(alkyl substituted with glucosyl).
Aspect 59. The method of any one of Aspects 39-49, wherein one or both of R¹ and R² are, independently, C(O)(optionally substituted C₁₋₆hydroxyalkyl).
Aspect 60. The method of any one of Aspects 39-49, wherein one or both of R¹ and R² are, independently, C(O)O(optionally substituted C₁₋₆hydroxyalkyl).
Aspect 61. The method of any one of Aspects 39-49, wherein one or both of R¹ and R² are, independently, C(O)(optionally substituted C₁₋₉glycol).
Aspect 62. The method of Aspect 39, wherein the dye compound is of Formula (II):

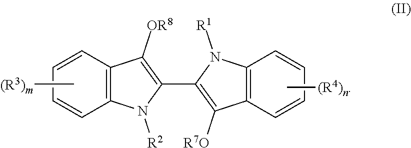

Aspect 63. The method of Aspect 62, wherein one or both of R¹ and R² are H.
Aspect 64. The method of Aspect 62 or 63, wherein one or both of R⁷ and R⁸ are H.
Aspect 65. The method of Aspect 62 or 63, wherein one of R⁷ and R⁸ are SO₃H.
Aspect 66. The method of Aspect 62 or 63, wherein one or both of R⁷ and R⁸ are C(O)(optionally substituted heteroaryl) such as C(O)(optionally substituted pyridyl).
Aspect 67. The method of Aspect 62 or 63, wherein one or both of R⁷ and R⁸ are C(O)(optionally substituted C₁₋₆alkyl).
Aspect 68. The method of Aspect 67, wherein the C₁₋₆alkyl is substituted with C(O)O(C₁₋₆alkyl) such as C(O)OCH₂CH₃.
Aspect 69. The method of Aspect 62 or 63 wherein one or both of R⁷ and R⁸ are C(O)-(optionally substituted aryl) such as C(O)-(optionally substituted phenyl).
Aspect 70. The method of Aspect 69, wherein the phenyl is substituted with CO₂H.
Aspect 71. The method of any one of the preceding Aspects, wherein the dye compound is an acid or base addition salt.
Aspect 72. The method of any one of the preceding Aspects, wherein the dye compound is a sulfate salt, alkylsulfate salt, bisulfate salt, phosphate salt, or halide salt.
Aspect 73. The method of Aspect 72, wherein the halide salt is an iodide salt, chloride salt, bromide salt, or fluoride salt.
Aspect 74. The method of Aspect 72, which is an alkylsulfate salt.
Aspect 75. The method of Aspect 74, which is a methylsulfate or ethylsulfate salt.
Aspect 76. The method of any one of Aspects 1-40, wherein the dye compound is of Formula (IA):

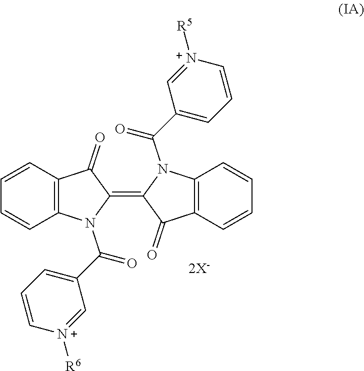

wherein:
   (i) R⁵ and R⁶ are, independently, H or C₁₋₆alkyl; and
   (ii) X is halide, sulfate, C₁₋₆alkylsulfate, bisulfate, or phosphate;
   (iii) with the proviso that both R⁵ and R⁶ are not CH₃ when X is CH₃SO₄⁻.
Aspect 77. The method of any one of Aspects 1-40, wherein the dye compound is of Formula (IB) or (IC):

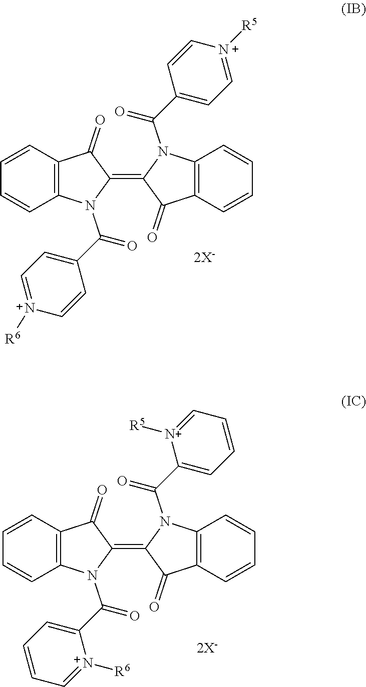

wherein:
   (i) R⁵ and R⁶ are, independently, H or C₁₋₆alkyl; and
   (ii) X is halide, sulfate, C₁₋₆alkylsulfate, bisulfate, or phosphate.
Aspect 78. The method of Aspect 1, wherein the dye compound is:

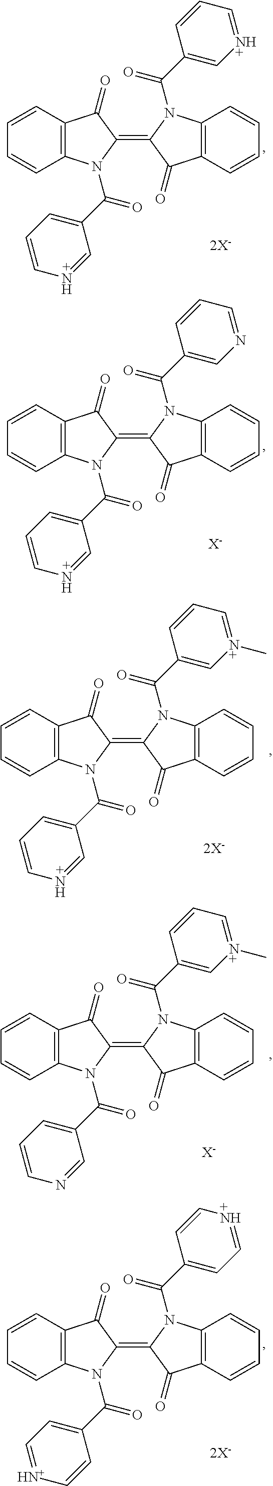

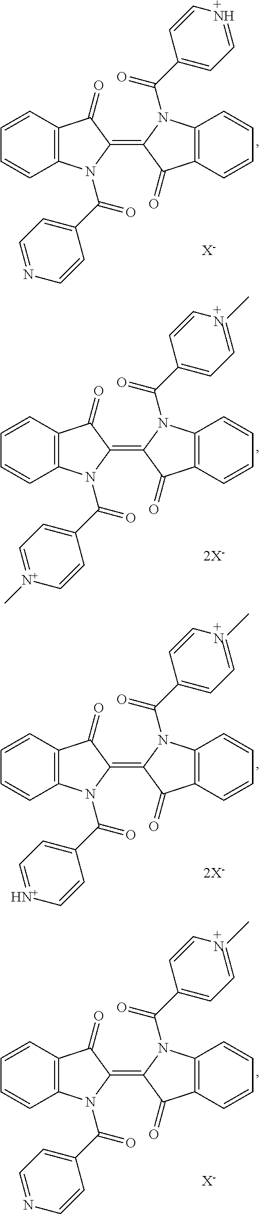

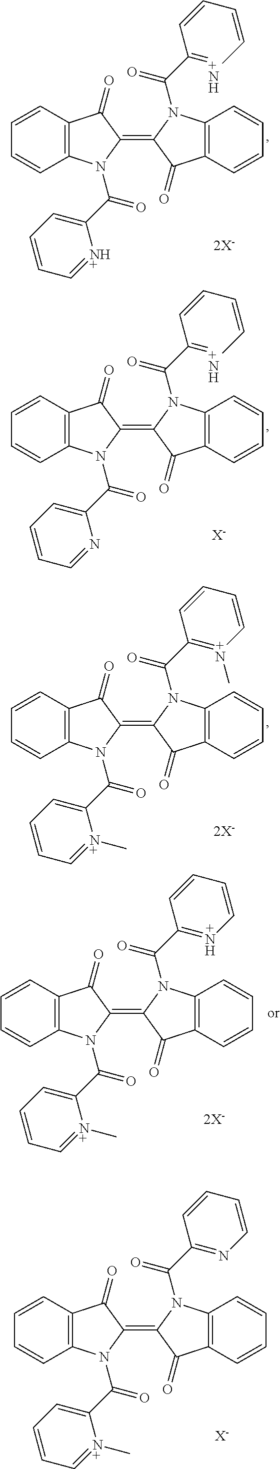

wherein X is a counteranion.
Aspect 79. The method of Aspect 1, wherein the dye compound is:

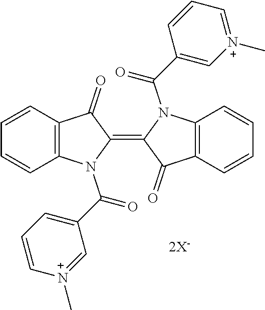

wherein X is acetate, propionate, lactate, citrate, tartrate, succinate, fumarate, maleate, malonate, mandelate, phthalate, Cl, Br, I, F, phosphate, nitrate, sulfate, ethanesulfonate, phosphonate, naphthalenesulfonate, benzenesulfonate, toluenesulfonate, camphorsulfonate, methanesulfate, ethanesulfonate, naphthalenesulfate, benzenesulfate, toluenesulfate, camphorsulfate, bisulfate, sulfite, or bisulfite.
Aspect 80. The method of Aspect 1, wherein the dye compound is:

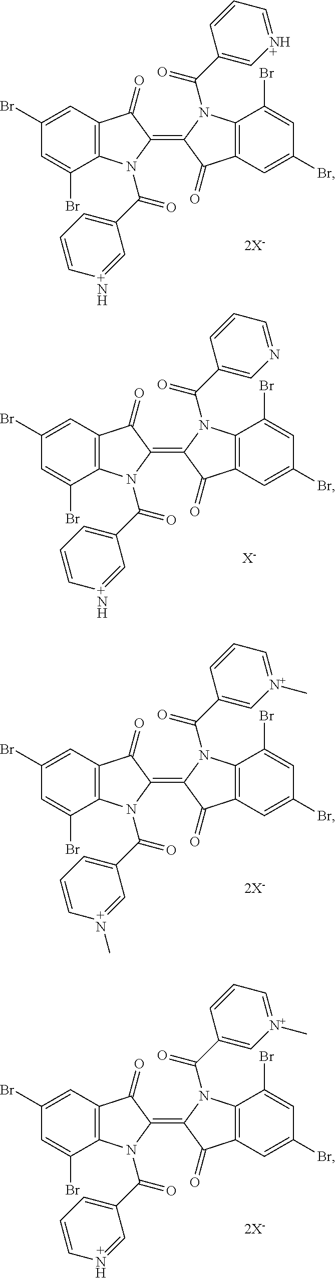

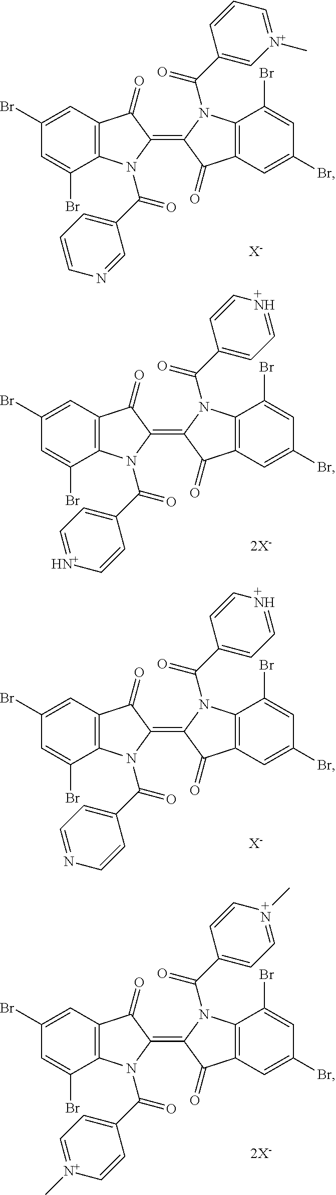

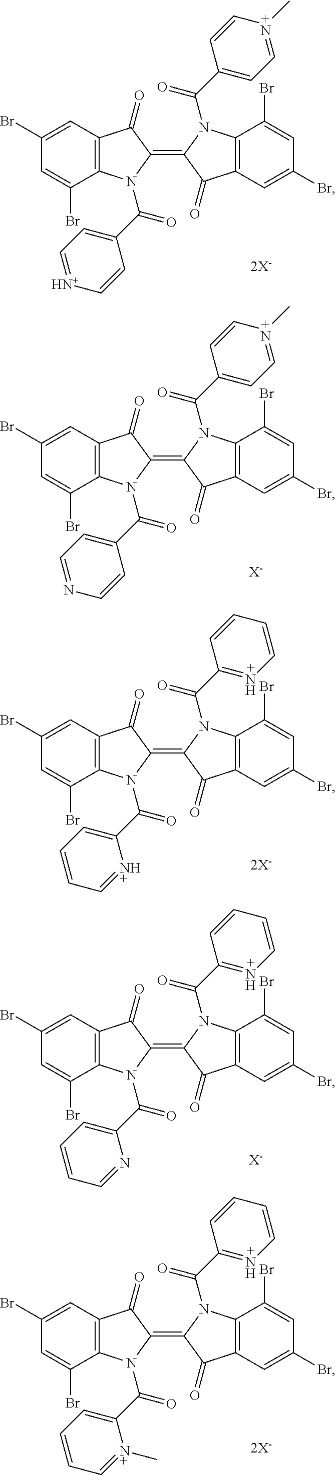

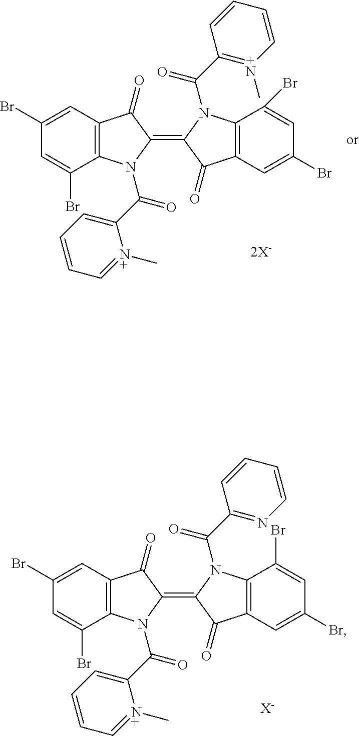

wherein, X is a counteranion.
Aspect 81. The method of Aspect 1, wherein the dye compound is:

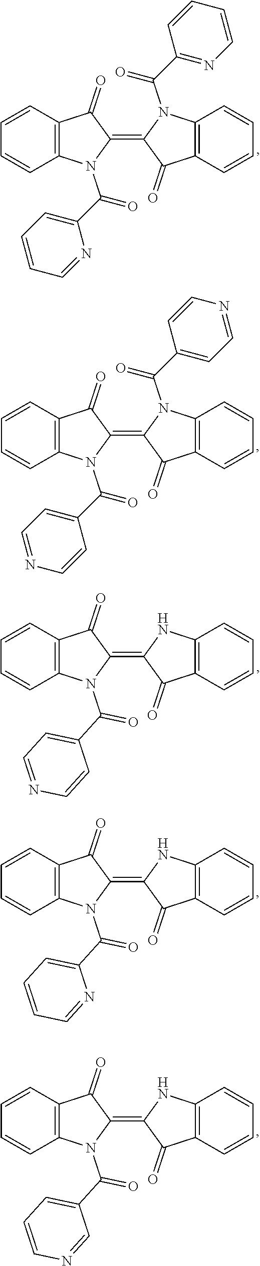

or a salt thereof.
Aspect 82. The method of Aspect 1, wherein the dye compound is:

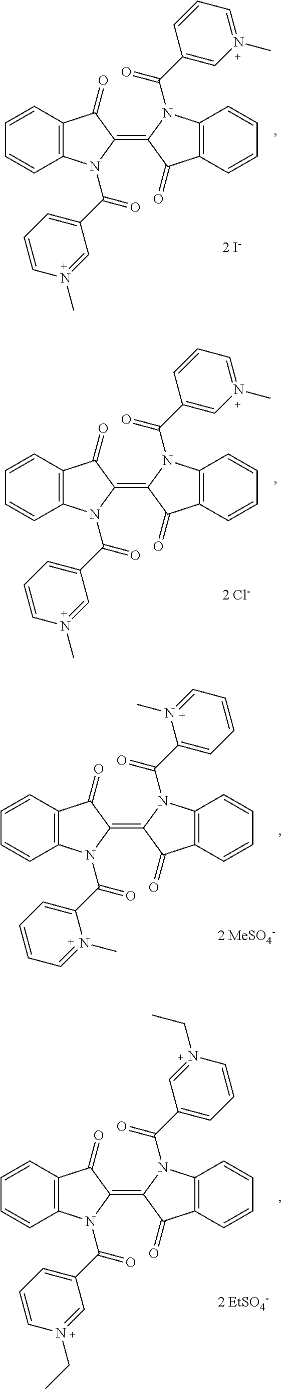

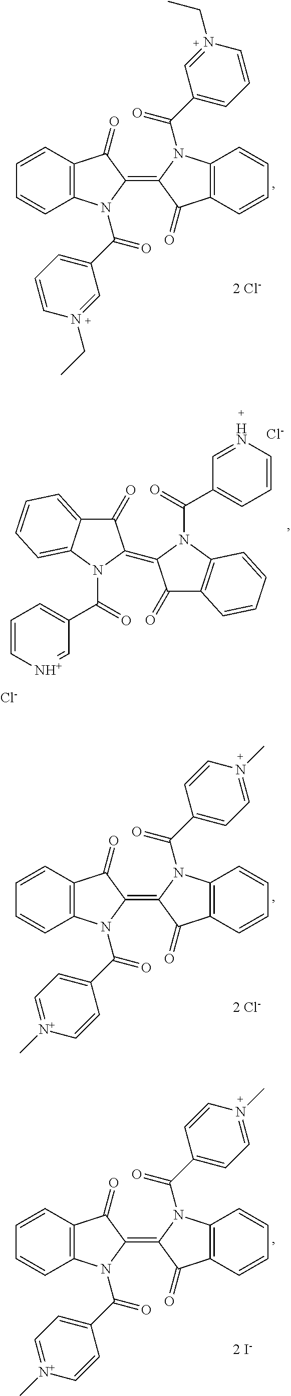

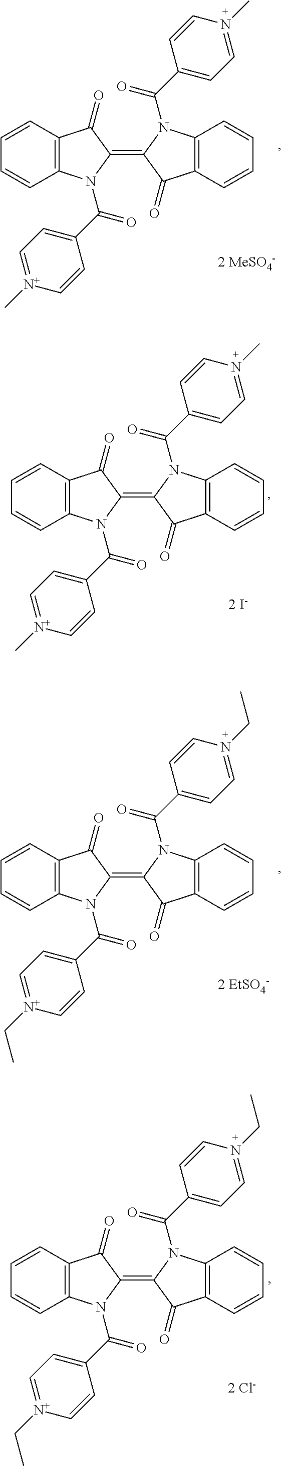

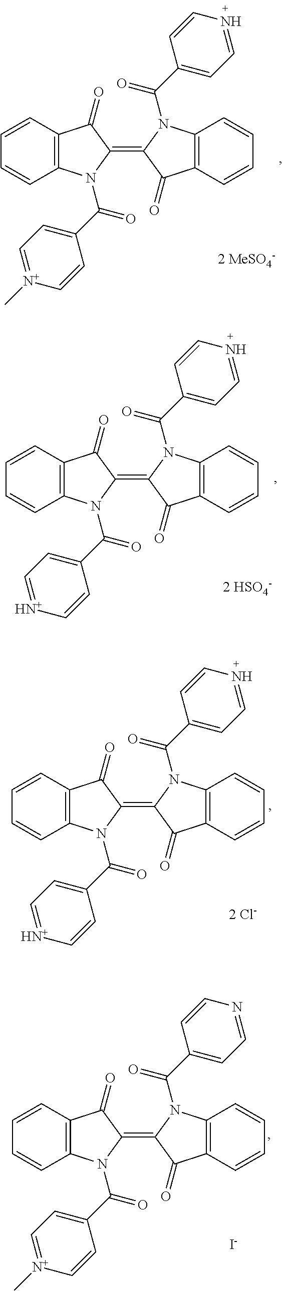 [SMILES: C[n+]1ccc(C(=O)N2/C(=C3\C(=O)c4ccccc4N3C(=O)c3ccncc3)C(=O)c3ccccc32)cc1 ; O=C1/C(=C2/C(=O)c3ccccc3N2C(=O)c2cc[nH+]cc2)N(C(=O)c2ccncc2)c2ccccc21 ; O=C1/C(=C2/C(=O)c3ccccc3N2C(=O)c2cc[nH+]cc2)N(C(=O)c2ccncc2)c2ccccc21 ; C[n+]1ccc(C(=O)N2/C(=C3\C(=O)c4ccccc4N3C(=O)c3ccncc3)C(=O)c3ccccc32)cc1 ; [I-]]

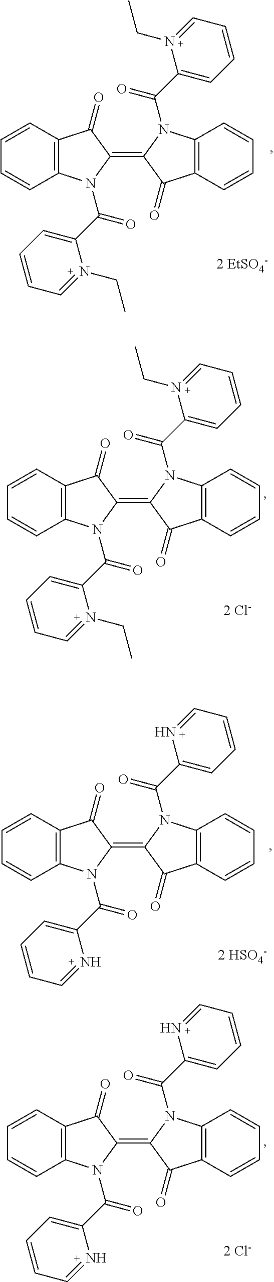

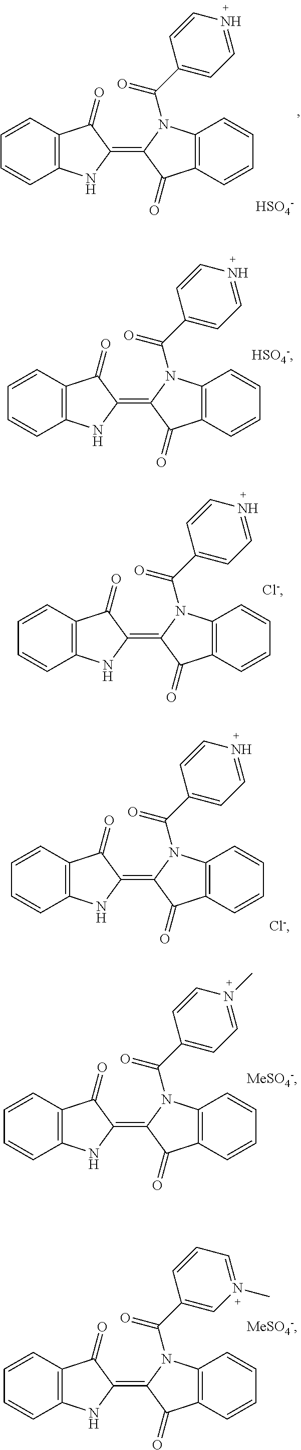

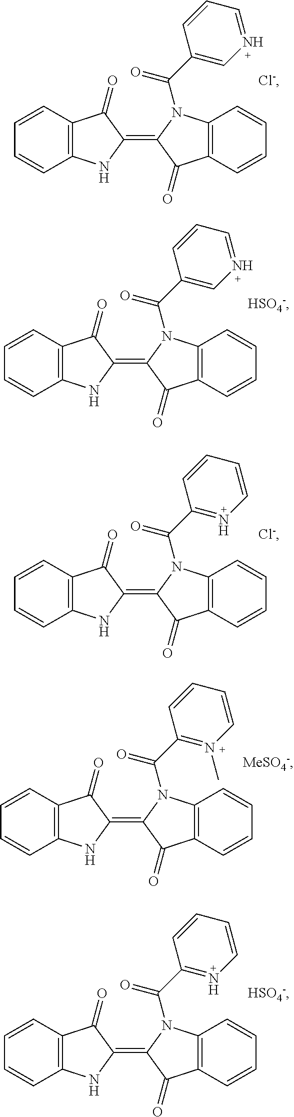

or a salt thereof.
Aspect 83. The method of Aspect 1, wherein the dye compound is:

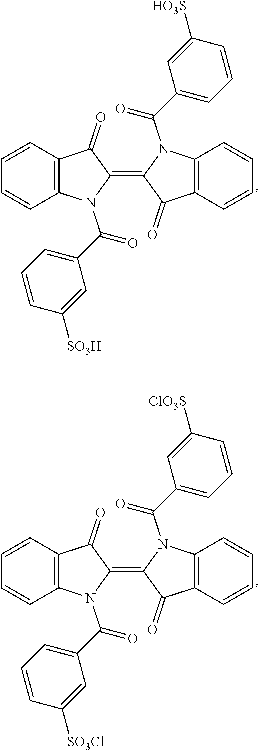

or salt thereof.
Aspect 84. The method of Aspect 1, wherein the dye compound is:

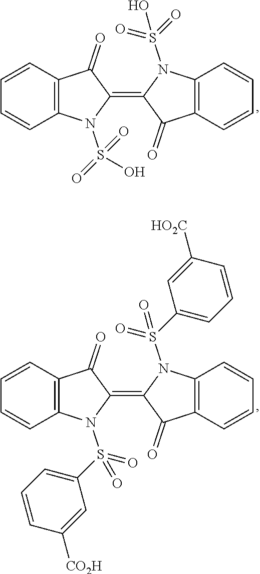 [SMILES: O=C1/C(=C2/C(=O)c3ccccc3N2S(=O)(=O)O)N(S(=O)(=O)O)c2ccccc21 ; O=C(O)c1cccc(S(=O)(=O)N2/C(=C3\C(=O)c4ccccc4N3S(=O)(=O)c3cccc(C(=O)O)c3)C(=O)c3ccccc32)c1]

or a salt thereof
Aspect 85. The method of Aspect 1, wherein the dye compound is:

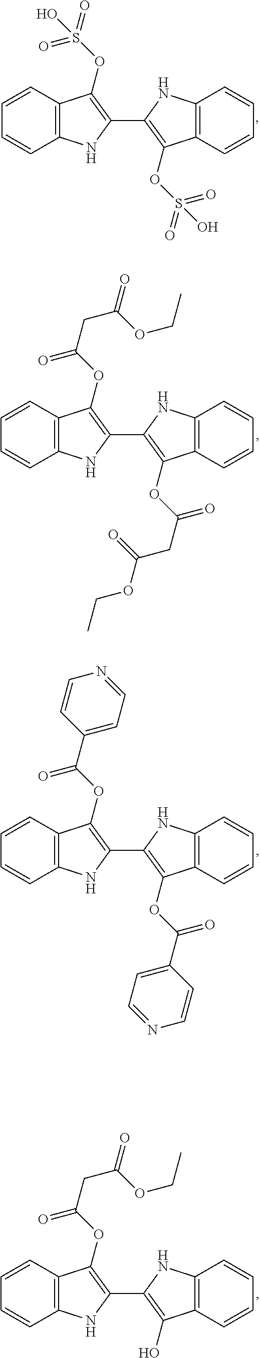

or a salt thereof.
Aspect 86. The method of Aspect 1, wherein the dye compound is:

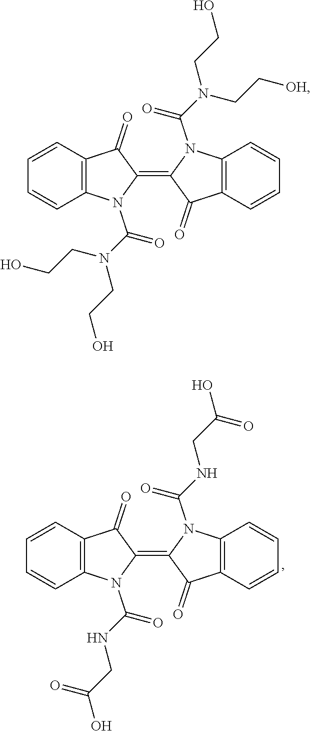 [SMILES: O=C1/C(=C2/C(=O)c3ccccc3N2C(=O)N(CCO)CCO)N(C(=O)N(CCO)CCO)c2ccccc21 ; O=C(O)CNC(=O)N1/C(=C2\C(=O)c3ccccc3N2C(=O)NCC(=O)O)C(=O)c2ccccc21]

or a salt thereof
Aspect 87. The method of Aspect 1, wherein the dye compound is:

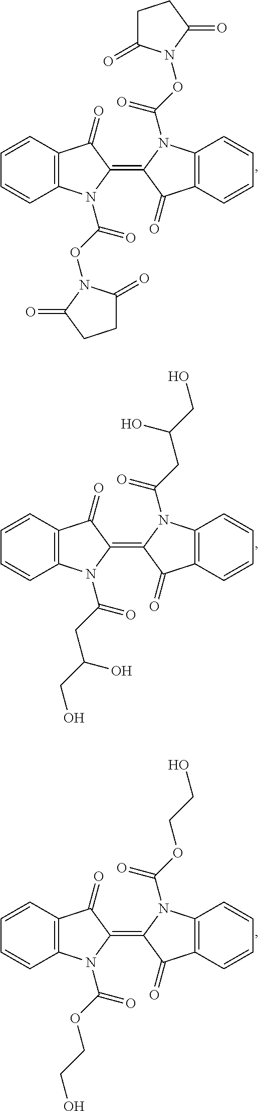 [SMILES: O=C1/C(=C2/C(=O)c3ccccc3N2C(=O)ON2C(=O)CCC2=O)N(C(=O)ON2C(=O)CCC2=O)c2ccccc21 ; O=C1/C(=C2/C(=O)c3ccccc3N2C(=O)CC(O)CO)N(C(=O)CC(O)CO)c2ccccc21 ; O=C1/C(=C2/C(=O)c3ccccc3N2C(=O)OCCO)N(C(=O)OCCO)c2ccccc21]

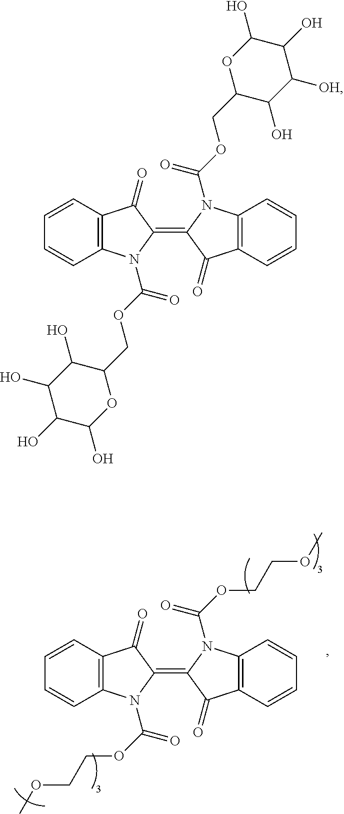

or a salt thereof.
Aspect 88. A printed substrate prepared according to the methods of any one of the preceding Aspects.
Aspect 89. A digital printing ink cartridge, comprising (i) water or a solvent and (ii) a dye compound of Formula (I) or (II):

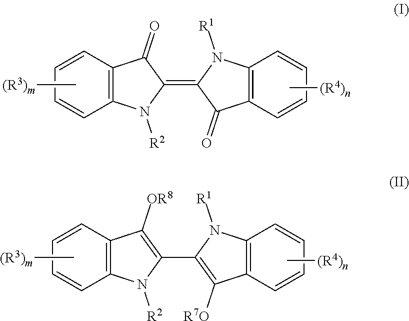

wherein:
   R¹ and R² are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted heteroaryl), C(O)-(optionally substituted heterocyclyl), C(O)-(optionally substituted C₁₋₆hydroxyalkyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), C(O)O-(optionally substituted heterocyclyl); or
   R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
   R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl);
   R^{A} and R^{B} are, independently, H or optionally substituted C₁₋₆alkyl, or optionally substituted aryl;
   R^{C} is H, optionally substituted C₁₋₆alkyl, optionally substituted C₃₋₈cycloalkyl, optionally substituted aryl, optionally substituted heteroaryl, or optionally substituted heterocyclyl;
   m and n are, independently, 0 to 4;
or a salt thereof.
Aspect 90. The ink cartridge of Aspect 89, wherein the dye compound is of Formula (I):

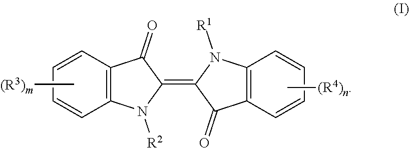

Aspect 91. The ink cartridge of Aspect 89, wherein the dye compound is of Formula (II):

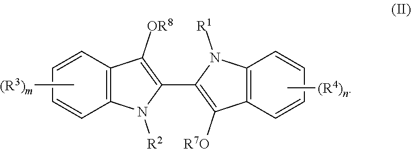

Aspect 92. The ink cartridge of Aspect 89, wherein the dye compound is of Formula (IA):

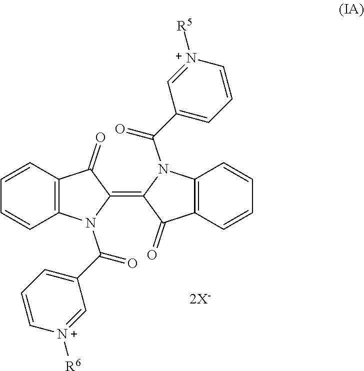

wherein:
   (i) R⁵ and R⁶ are, independently, H or C₁₋₆alkyl; and
   (ii) X is halide, sulfate, C₁₋₆alkylsulfate, bisulfate, or phosphate;
   (iii) with the proviso that both R⁵ and R⁶ are not CH₃ when X is CH₃SO₄⁻.
Aspect 93. The ink cartridge of Aspect 89, wherein the dye compound is of Formula (IB) or (IC):

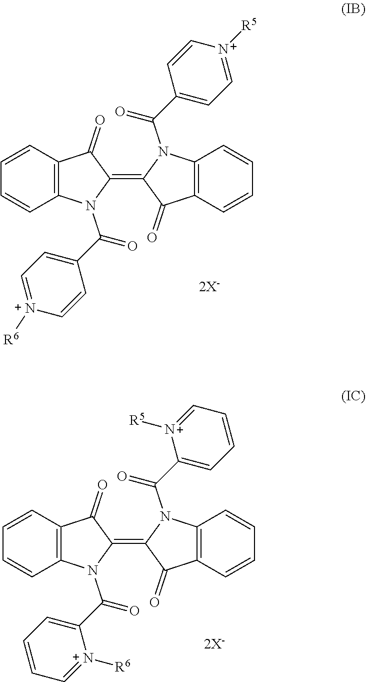

wherein:
   (i) R⁵ and R⁶ are, independently, H or C₁₋₆alkyl; and
   (ii) X is halide, sulfate, C₁₋₆alkylsulfate, bisulfate, or phosphate.
Aspect 94. The ink cartridge of Aspect 89, wherein the dye compound is:

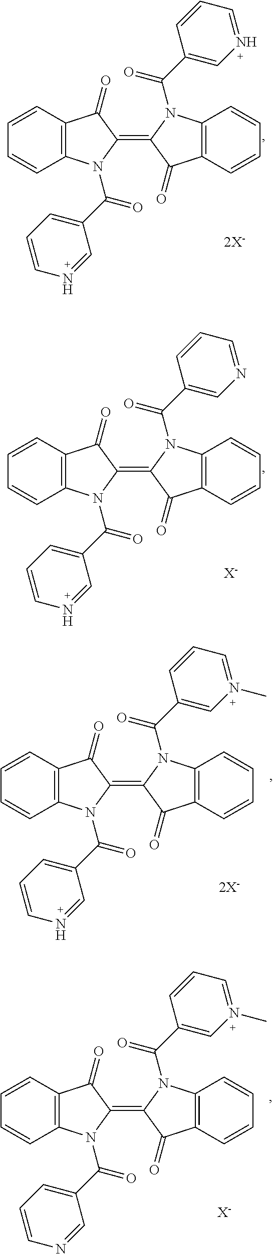

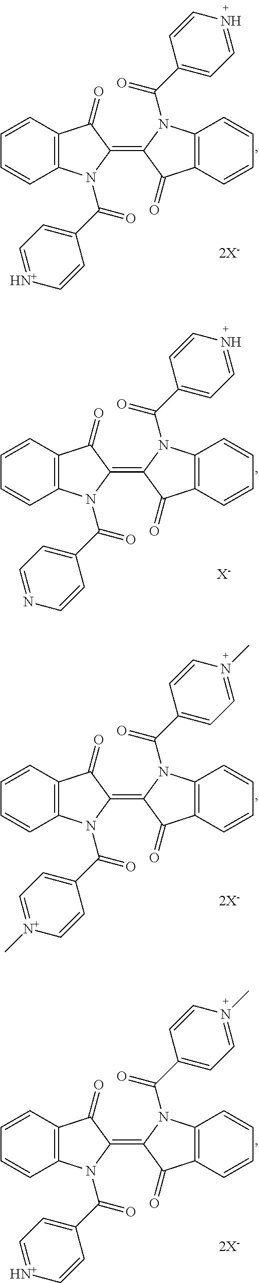

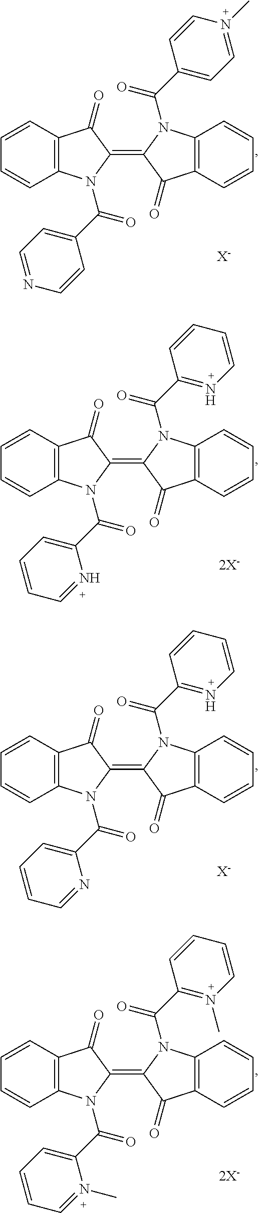

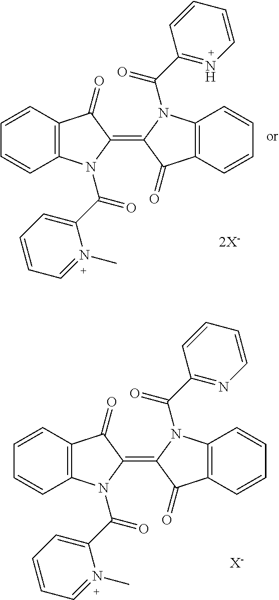

wherein X is a counteranion.
Aspect 95. The ink cartridge of Aspect 89, wherein the dye compound is:

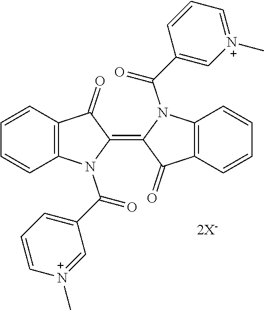

wherein X is acetate, propionate, lactate, citrate, tartrate, succinate, fumarate, maleate, malonate, mandelate, phthalate, Cl, Br, I, F, phosphate, nitrate, sulfate, ethanesulfonate, phosphonate, naphthalenesulfonate, benzenesulfonate, toluenesulfonate, camphorsulfonate, methanesulfate, ethanesulfonate, naphthalenesulfate, benzenesulfate, toluenesulfate, camphorsulfate, bisulfate, sulfite, or bisulfite.
Aspect 96. The ink cartridge of Aspect 89, wherein the dye compound is:

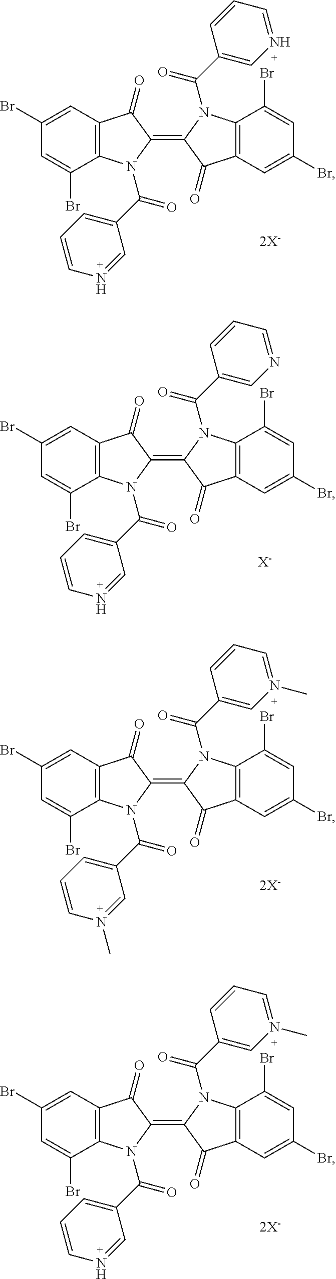

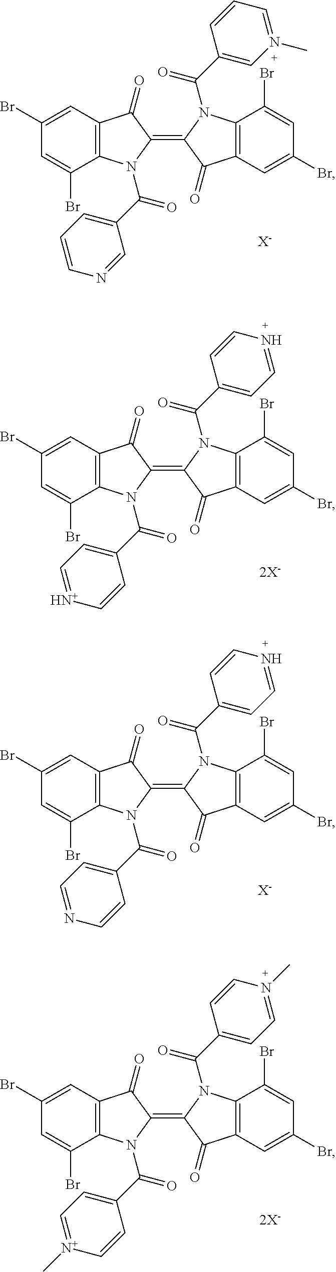

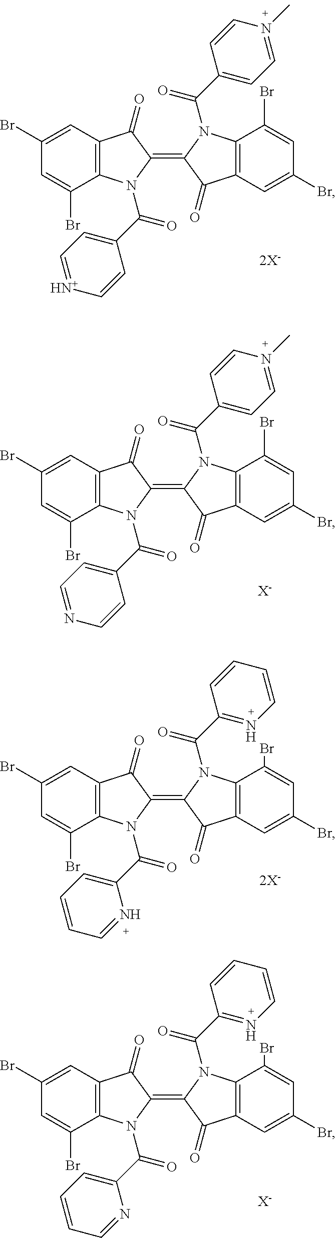

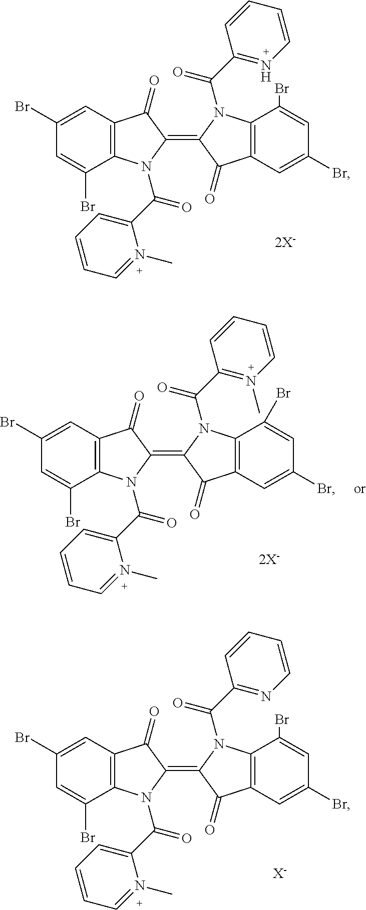

wherein, X is a counteranion.
Aspect 97. The ink cartridge of Aspect 89, wherein the dye compound is:

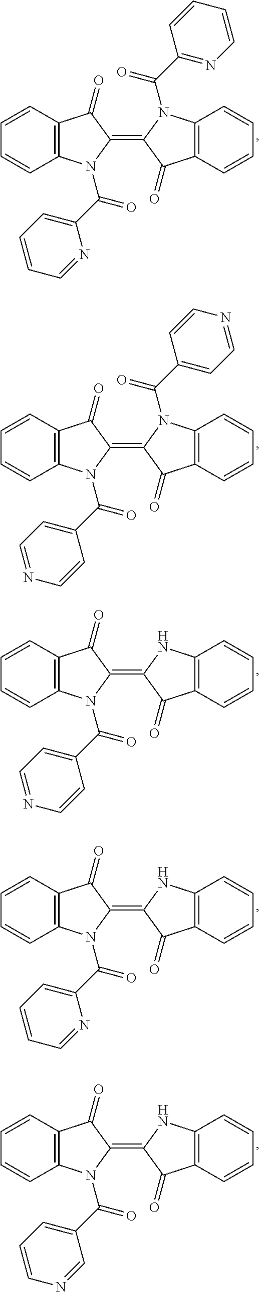 [SMILES: O=C1/C(=C2/C(=O)c3ccccc3N2C(=O)c2ccccn2)N(C(=O)c2ccccn2)c2ccccc21 ; O=C1/C(=C2/C(=O)c3ccccc3N2C(=O)c2ccncc2)N(C(=O)c2ccncc2)c2ccccc21 ; O=C1/C(=C2/C(=O)c3ccccc3N2C(=O)c2ccncc2)Nc2ccccc21 ; O=C1/C(=C2/C(=O)c3ccccc3N2C(=O)c2ccccn2)Nc2ccccc21 ; O=C1/C(=C2/C(=O)c3ccccc3N2C(=O)c2cccnc2)Nc2ccccc21]

or a salt thereof.
Aspect 98. The ink cartridge of Aspect 89, wherein the dye compound is:

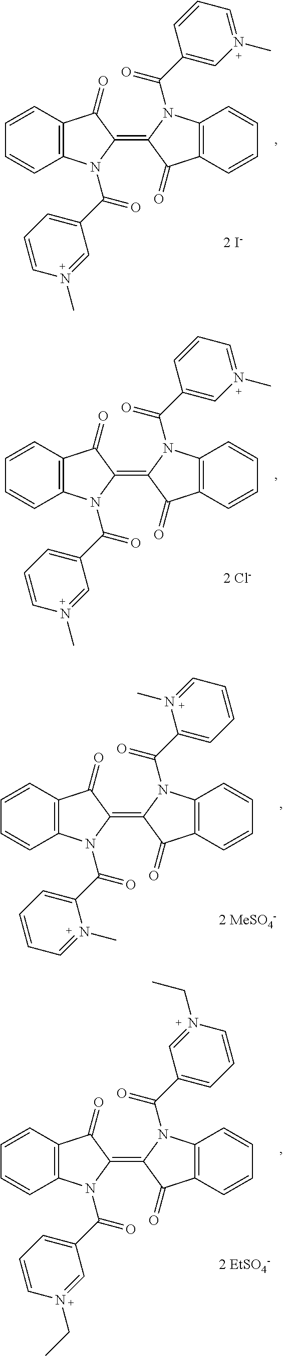

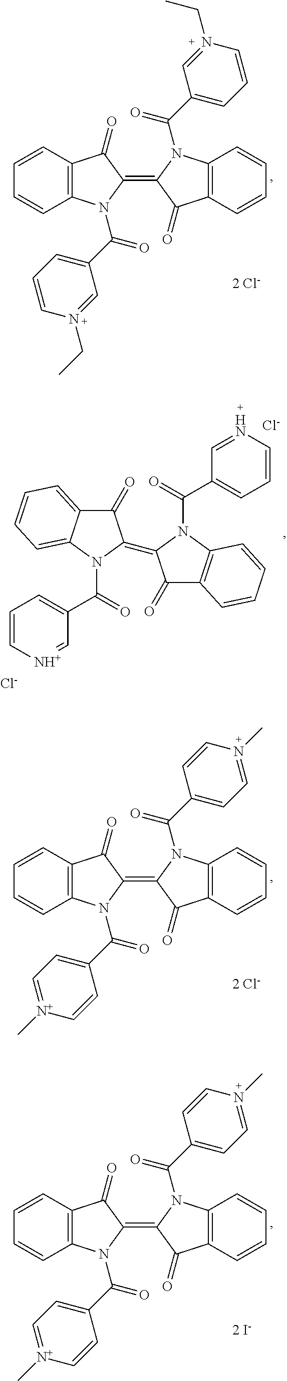

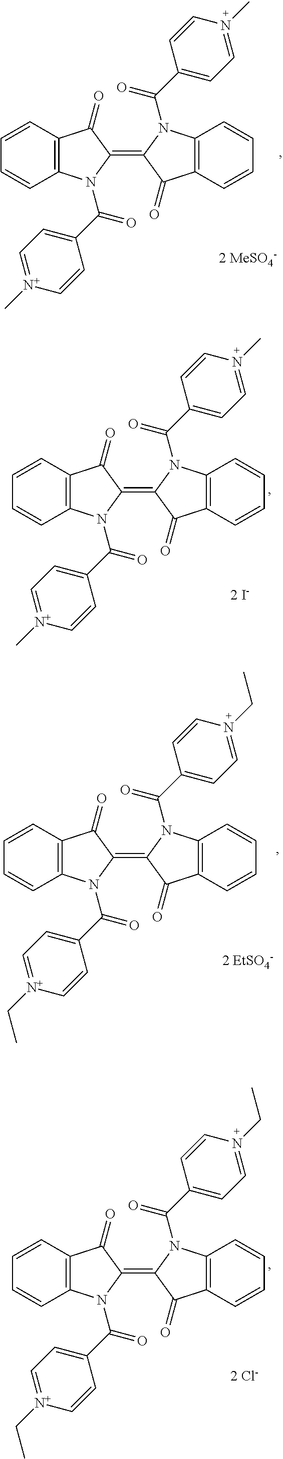

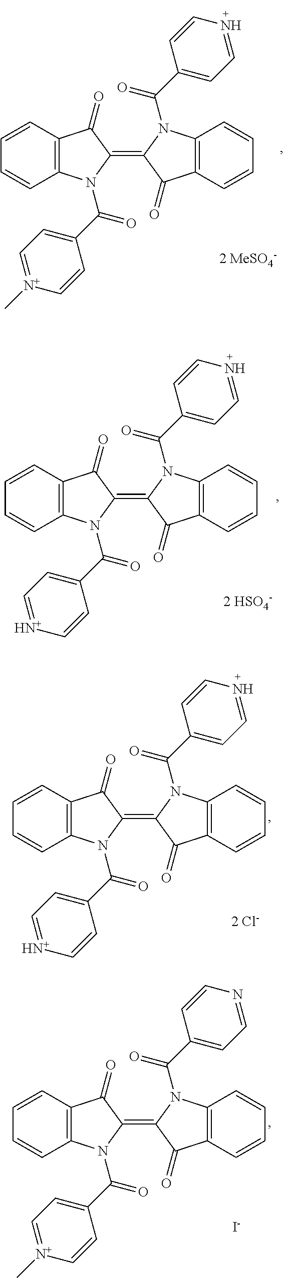

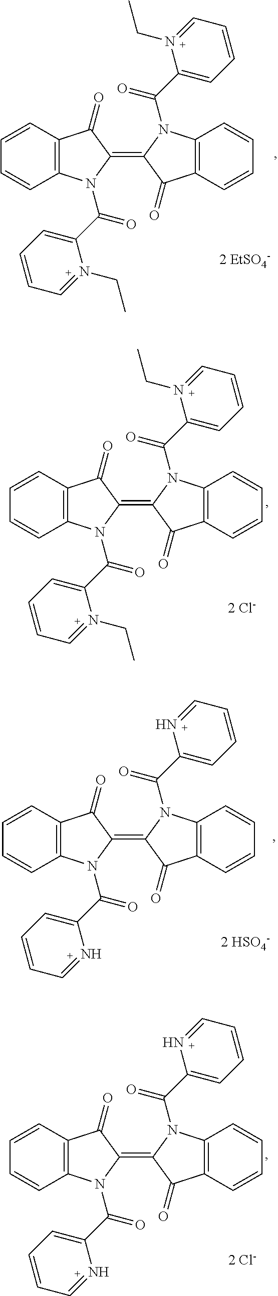

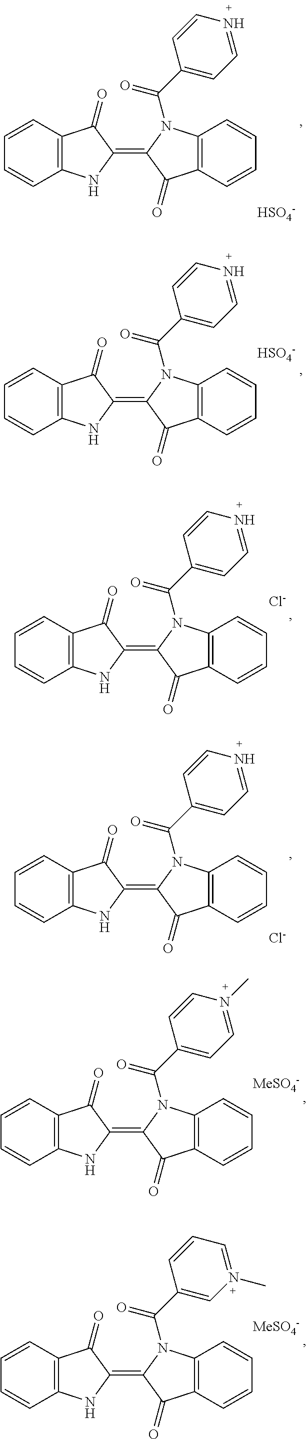

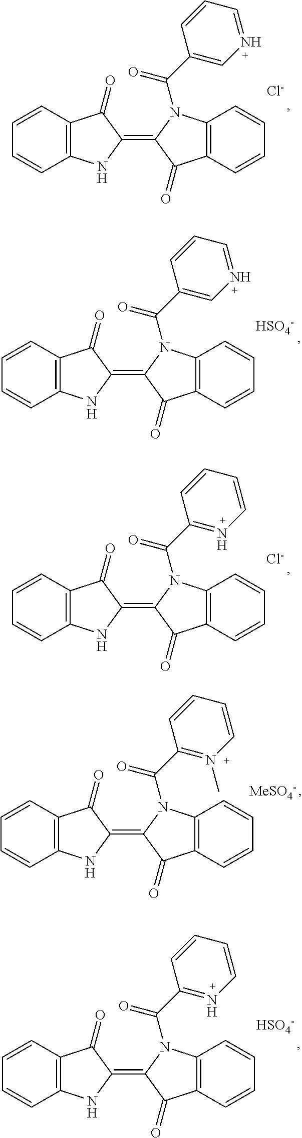

or a salt thereof.
Aspect 99. The ink cartridge of Aspect 89, wherein the dye compound is:

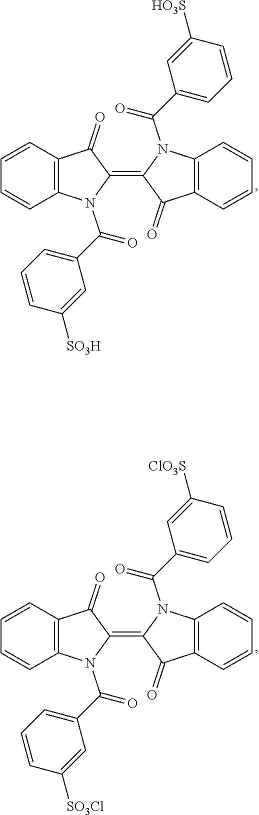

or salt thereof.
Aspect 100. The ink cartridge of Aspect 89, wherein the dye compound is:

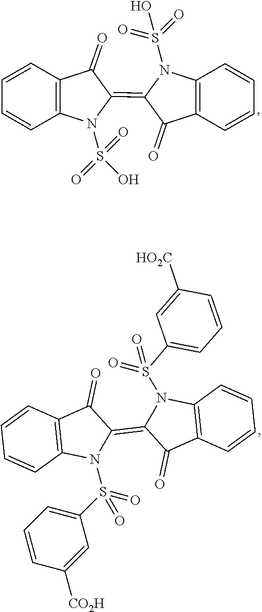

or a salt thereof.
Aspect 101. The ink cartridge of Aspect 89, wherein the dye compound is:

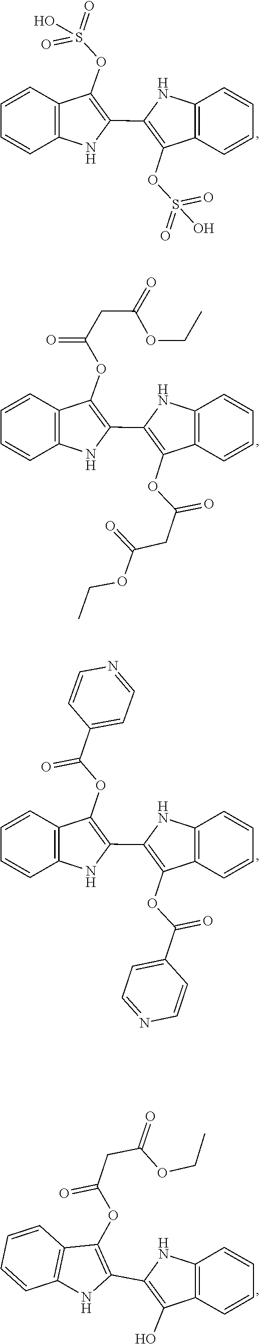 [SMILES: O=S(=O)(O)Oc1c(-c2[nH]c3ccccc3c2OS(=O)(=O)O)[nH]c2ccccc12 ; CCOC(=O)CC(=O)Oc1c(-c2[nH]c3ccccc3c2OC(=O)CC(=O)OCC)[nH]c2ccccc12 ; O=C(Oc1c(-c2[nH]c3ccccc3c2OC(=O)c2ccncc2)[nH]c2ccccc12)c1ccncc1 ; CCOC(=O)CC(=O)Oc1c(-c2[nH]c3ccccc3c2O)[nH]c2ccccc12]

or a salt thereof.
Aspect 102. The ink cartridge of Aspect 89, wherein the dye compound is:

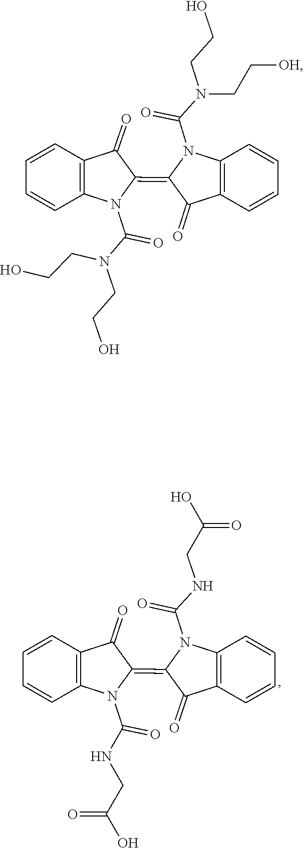 [SMILES: O=C1/C(=C2/C(=O)c3ccccc3N2C(=O)N(CCO)CCO)N(C(=O)N(CCO)CCO)c2ccccc21 ; O=C(O)CNC(=O)N1/C(=C2\C(=O)c3ccccc3N2C(=O)NCC(=O)O)C(=O)c2ccccc21]

or a salt thereof.
Aspect 103. The ink cartridge of Aspect 89, wherein the dye compound is:

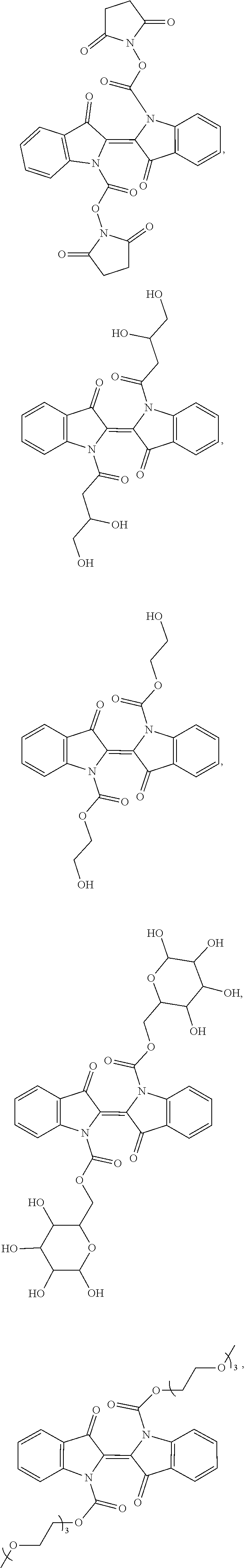

or a salt thereof.

### VII. Examples

All UV-Vis spectra were obtained using a Varian Cary 6000i UV-Vis spectrophotometer.

Reactions of Indigo with Nicotinoyl Chloride/Isonicotinoyl Chloride

### Example 1: Synthesis of Compounds 2 and 6

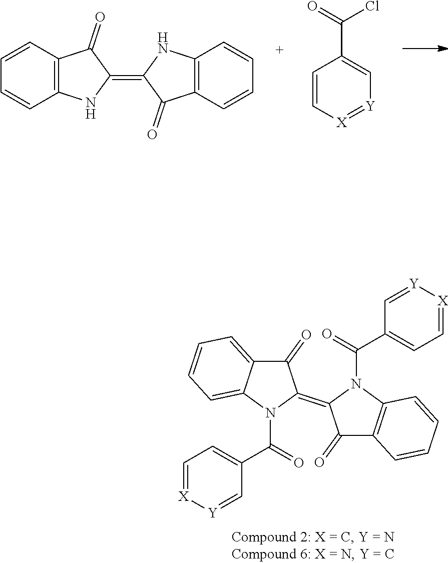

To a suspension of indigo (54 g, 0.206 mol) in anhydrous pyridine (200 mL) in a 1.0 L flask fitted with a condenser and mechanical stirrer, under an inert atmosphere (Ar or N₂) was added isonicotinoyl chloride (92 g, 0.515 mol, 2.5 equivalents) portion wise with efficient stirring. The reaction mixture was heated to 50° C. for 6 hours (the progress of the reaction was followed by TLC (5% MeOH in DCM, Rf 0.5). After this time, the deep red/pink reaction mixture was allowed to cool and most of the pyridine was removed under vacuum. The resulting reaction mixture was quenched by pouring into cold water (500 mL) with stirring for 30 minutes. The solid precipitate thus formed was isolated by filtration and washed thoroughly with cold water. The deep red solid was dried under vacuum and then dissolved in dichloromethane (1 L); this solution was further dried using anhydrous sodium sulfate. The deep red solution was filtered and concentrated under vacuum until dry to afford a deep purple/red solid (60 g, 61.8% yield). Characterization by ¹HNMR and MS confirmed the desired compounds.

Compound 2: Mw=C₂₈H₁₆N₄O₄, 472.45; ¹H NMR (400 MHz, DMSO) δ 9.02 (s, 2H), 8.81-8.75 (m, 2H), 8.62-8.61 (m, 2H), 7.71 (d, J=7.4 Hz, 1H), 7.69-7.63 (m, 1H), 7.61 (dd, J=7.8, 4.9 Hz, 4H), 7.48 (dd, J=9.3, 5.8 Hz, 2H), 7.28 (t, J=7.8 Hz, 2H), 7.28 (t, J=7.8 Hz, 2H).

Compound 6: Mw=C₂₈H₁₆N₄O₄, 472.45; ¹H NMR (400 MHz, DMSO) δ 8.82 (d, J=5.7 Hz, 4H), 7.80 (d, J=18.1 Hz, 4H), 7.70 (d, J=7.5 Hz, 2H), 7.65 (t, J=7.6 Hz, 2H), 7.60-7.35 (m, 2H), 7.28 (t, J=7.6 Hz, 2H).

### Example 2: Synthesis of Compound 28

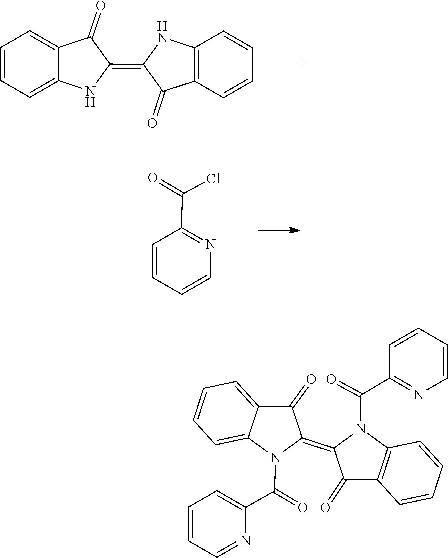 [SMILES: O=C1/C(=C2\Nc3ccccc3C2=O)Nc2ccccc21 ; O=C(Cl)c1ccccn1 ; O=C1/C(=C2/C(=O)c3ccccc3N2C(=O)c2ccccn2)N(C(=O)c2ccccn2)c2ccccc21]

To a suspension of indigo (5.2 g, 20 mmol) in anhydrous pyridine (50 mL) in a flask fitted with a condenser and mechanical stirrer, under an inert atmosphere (Ar or N₂) was added 2-nicotinoyl chloride (14.2 g, 80 mmol, 4 equiv) portion wise with efficient stirring. The brown reaction mixture became quite thick and warm and was allowed to stir at room temperature for 30 mins and then gradually heated to 50° C. hours (the progress of the reaction was followed by TLC (5% MeOH in DCM, Rf 0.3). The resulting reaction mixture was quenched by pouring into cold water (200 mL) with stirring for 30 minutes. The solid precipitate isolated by filtration proved to be un-reacted indigo. The aqueous was extracted into dichloromethane (3×50 mL), dried and concentrated to a give a brown solid which was purified using flash column chromatography. The main product isolated (stained yellow on TLC, Rf=0.3 as above) as a yellow solid and was characterised by NMR. The analysis was not consistent with the above structure indicating that the 2-derivative behaves quite differently from the 3 and 4-derivatives when reacted with indigo.

¹H NMR (400 MHz, DMSO) δ 8.82 (d, J=4.7 Hz, 1H), 8.71 (d, J=4.1 Hz, 1H), 8.31 (t, J=7.7 Hz, 1H), 8.09-7.95 (m, 1H), 7.88-7.79 (m, 1H), 7.68-7.59 (m, 1H), 7.47-7.39 (m, 1H), 7.36 (dd, J=6.5, 1.7 Hz, 1H), 6.32 (d, J=9.2 Hz, 1H), 6.19-6.14 (m, 1H).

### Example 3: Synthesis of Compound 15

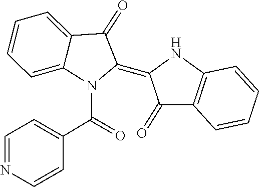 [SMILES: O=C1/C(=C2/C(=O)c3ccccc3N2C(=O)c2ccncc2)Nc2ccccc21]

To a suspension of indigo (20 g, 0.076 mol) in anhydrous pyridine (100 mL) in a flask fitted with a condenser and mechanical stirrer, under an inert atmosphere (Ar or N₂) was added isonicotinoyl chloride (13 g, 0.076 mol, 1 equiv) portion wise with efficient stirring. The reaction mixture was heated to 50° C. for 6 hours (the progress of the reaction was followed by TLC (5% MeOH in DCM, Rf 0.6; TLC also showed the presence of some di-substituted product). After this time, the deep red/pink reaction mixture was allowed to cool and most of the pyridine was removed under vacuum. The resulting reaction mixture was quenched by pouring into cold water (500 ml) with stirring for 30 minutes. The solid precipitate thus formed was isolated by filtration and washed thoroughly with cold water. The deep red solid was dried under vacuum and then dissolved in dichloromethane (1 L); this solution was further dried using anhydrous sodium sulphate. The deep red solution was filtered and concentrated under vacuum until dry to afford a deep purple/red solid. The crude material was separated by flash column chromatography (1% MeOH/dichloromethane). The pure product was separated as a bright pink solid in 25% yield (7 g).

Mw, C₂₂H₁₃N₃O₃, 367.36; ¹H NMR (400 MHz, DMSO) δ 11.05 (s, 1H), 8.67 (d, J=5.9 Hz, 2H), 7.88 (d, J=7.5 Hz, 1H), 7.80-7.68 (m, 4H), 7.52 (t, J=7.7 Hz, 1H), 7.39 (dd, J=12.4, 7.2 Hz, 2H), 7.29 (d, J=8.1 Hz, 1H), 6.92 (t, J=7.4 Hz, 1H).

Quaternization of Nicotinoyl/Isonicotinoyl Derivatives

### Example 4: Synthesis of Compounds 3 and 7

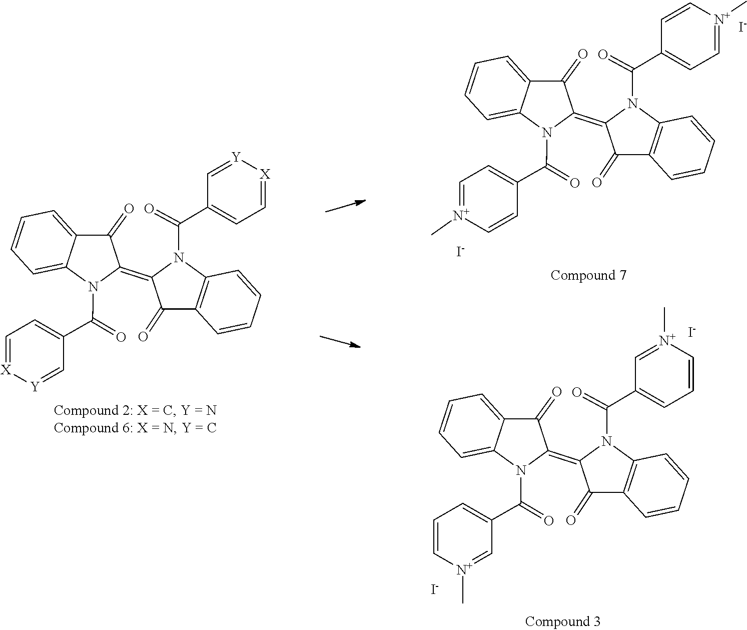

To a refluxing solution of the precursor (Compound 2 or 6) in acetone, methyl iodide (3.2 equiv) was added drop-wise over 20 mins. The mixture was allowed to reflux for a further 5 hours and then allowed to cool to 0° C.; the precipitated product was isolated by filtration and washed with ethyl acetate:pet ether (1:1) and dried. The brown solid was isolated in quantitative yield.

Compound 3: Mw, 756.33, C₃₀H₂₂I₂N₄O₄

Compound 7: Mw, 756.33, C₃₀H₂₂I₂N₄O₄; ¹H NMR (400 MHz, DMSO) δ 9.28 (d, J=6.5 Hz, 4H), 8.50-8.38 (m, 4H), 8.14 (d, J=8.2 Hz, 2H), 7.85-7.76 (m, 4H), 7.41 (t, J=7.5 Hz, 2H). 4.64 (s, 6H).

### Example 5: Synthesis of Compound 16

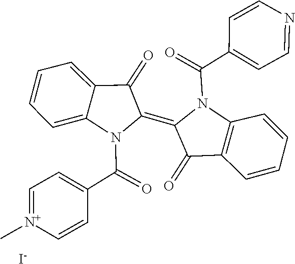 [SMILES: C[n+]1ccc(C(=O)N2/C(=C3\C(=O)c4ccccc4N3C(=O)c3ccncc3)C(=O)c3ccccc32)cc1 ; [I-]]

To a refluxing solution of the precursor in acetone, methyl iodide (1.25 equiv) was added drop-wise over 20 mins. The mixture was allowed to reflux for a further 18 hours and then allowed to cool to 0° C.; the precipitated product was isolated by filtration and washed with ethyl acetate:pet ether (1:1) and dried.

Mw, 614.14, C₂₉H₁₉IN₄O₄

### Example 6: Synthesis of Compound 18

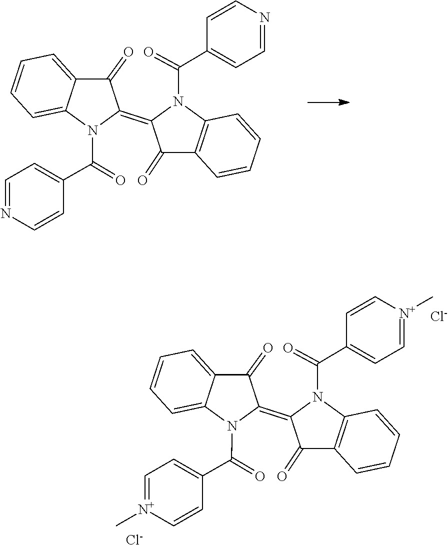

Compound 6 (0.05 mol) was introduced into a pressure flask to which was added acetone (250 mL). The solution was saturated with chloromethane gas and sealed. The flask was heated to 100° C. for 48 hours with stirring. After this time, the flask was allowed to cool to room temperature (TLC indicated complete consumption of the starting material). The product, which precipitated out, was isolated by filtration and washed with acetone and dried to constant weight. After drying, a purple solid was isolated which was characterized by ¹H NMR (59% yield).

Mw 573.0, C₃₀H₂₂N₄O₄Cl₂; ¹H NMR (DMSO): δ 9.2 (d, 4H, J=6.5 Hz), 8.5 (d, 4H, J=6.5 Hz), 8.1 (d, 2H, J=8.2 Hz), 67.8 (m, 4H) 7.4 (d, 2H, J=11 Hz), 4.4 (6H s).

### Example 7: Synthesis of Compound 3B

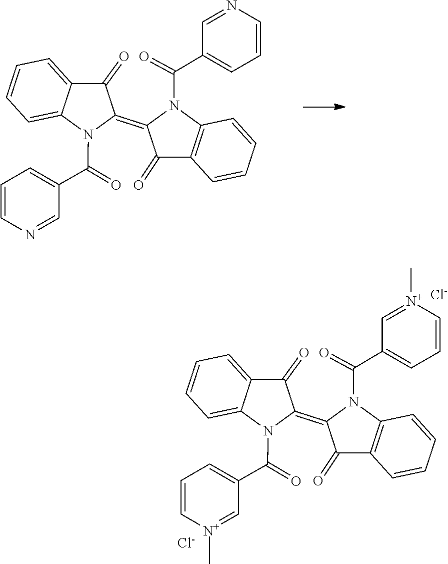 [SMILES: O=C1/C(=C2/C(=O)c3ccccc3N2C(=O)c2cccnc2)N(C(=O)c2cccnc2)c2ccccc21 ; C[n+]1cccc(C(=O)N2/C(=C3\C(=O)c4ccccc4N3C(=O)c3ccc[n+](C)c3)C(=O)c3ccccc32)c1 ; [Cl-] ; [Cl-]]

Compound 2 (0.05 mol) is introduced into a pressure flask to which is added acetone (250 mL). The solution is saturated with chloromethane gas and sealed. The flask is heated to 100° C. for 48 hours with stirring. After this time, the flask is allowed to cool to room temperature. The product, which precipitates out, is isolated by filtration and washed with acetone and dried to constant weight. After drying, a purple solid is isolated.

### Example 8: Synthesis of Compounds 4, 8 and 41

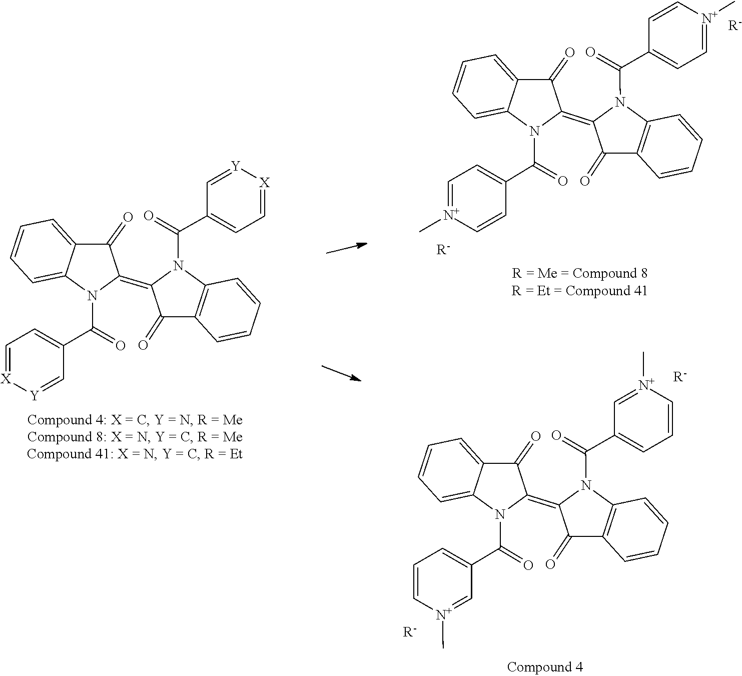

Compound 2 or 6 was heated with anhydrous dialkylsulfate (R₂SO₄, R=Me, Et; 5 equiv) with stirring at 50° C. for 18 hours under an inert atmosphere. TLC after this time showed the complete consumption of starting material. Once the reaction mixture was allowed to cool to room temperature, anhydrous diethyl ether (20 equiv) was added and the mixture stirred for 30 minutes. After this time, stirring was stopped and the precipitated compound was allowed to settle. The supernatant was removed via a filtered cannula under argon pressure. This process was repeated twice more to ensure removal of residual dimethyl sulfate. The solid residue was dried under a stream of Ar and stored under Ar, giving the product in almost quantitative yield

Compound 4 (J. Chem. Perk. Trans. 1984 2305-2309); Mw, 724.11, C₃₂H₂₈N₄O₁₂S₂; ¹H NMR (400 MHz, CDCl₃) δ 9.56 (s, 2H), 9.11 (d, 4H), 8.43 (dd, 2H), 8.0-7.4 (m, 8H). 4.51 (s, 6H).

Compound 8: Mw, 724.11, C₃₂H₂₈N₄O₁₂S₂; ¹H NMR (DMSO): δ 9.2 (d, 4H, J=6.6 Hz), 8.4 (d, 4H, J=6.6 Hz), 8.1 (d, 2H, J=7.4 Hz), 7.8 (t, 4H, J=8.1 Hz), 7.4 (d, 2H, J=7.4 Hz), 4.5 (s, 6H).

Compound 41: Mw, 724.11, C₃₂H₂₈N₄O₁₂S₂; ¹H NMR (400 MHz, DMSO) δ 9.35 (d, J=10.0 Hz, 4H), 8.54-8.38 (m, 4H), 8.14 (d, J=8.3 Hz, 2H), 7.78 (m, 6H), 7.48-7.34 (t, J=12.1 Hz, 2H), 4.34 (q, J=7.1 Hz, 4H), 3.74 (q, J=7.1 Hz, 4H), 1.34 (t, J=7.1 Hz, 6H), 1.1 (t, J=7.1 Hz, 6H).

### Example 9: Synthesis of Compound 17

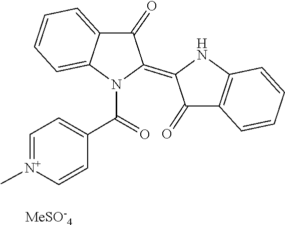 [SMILES: "MeSO-4" ; C[n+]1ccc(C(=O)N2/C(=C3/Nc4ccccc4C3=O)C(=O)c3ccccc32)cc1]

Compound 15 was heated with anhydrous dimethyl sulfate (5 equiv) with stirring at 50° C. for 18 hours under an inert atmosphere. TLC after this time showed the complete consumption of starting material. Once the reaction mixture was allowed to cool to room temperature, anhydrous diethyl ether (20 equiv) was added and the mixture stirred for 30 minutes. After this time, stirring was stopped and the precipitated compound was allowed to settle. The supernatant was removed via a filtered cannula under argon pressure. This process was repeated twice more to ensure removal of residual dimethyl sulfate. The solid residue was dried under a stream of Ar and stored under Ar, giving the product in almost quantitative yield

Mw C₂₄H₁₉N₃O₇S, 493.43; ¹H NMR (400 MHz, DMSO) δ 11.08 (s, 1H), 9.01 (d, J=6.5 Hz, 2H), 8.51 (d, J=6.5 Hz, 2H), 8.03 (d, J=8.3 Hz, 1H), 7.93 (d, J=7.5 Hz, 1H), 7.78 (t, J=7.8 Hz, 1H), 7.53 (t, J=7.5 Hz, 1H), 7.46 (d, J=7.4 Hz, 1H), 7.41 (d, J=7.5 Hz, 1H), 7.30 (d, J=8.1 Hz, 1H), 6.94 (t, J=7.4 Hz, 1H), 4.29 (s, 3H), 3.95 (s, 3H).

Protonation of Nicotinoyl/Isonicotinoyl Derivatives

### Example 10: Synthesis of Compound 35

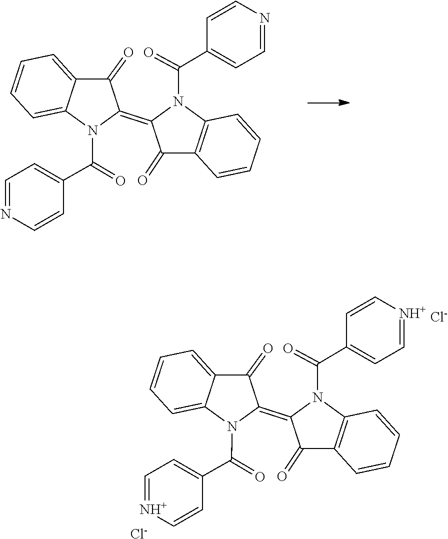 [SMILES: O=C1/C(=C2/C(=O)c3ccccc3N2C(=O)c2ccncc2)N(C(=O)c2ccncc2)c2ccccc21 ; O=C1/C(=C2/C(=O)c3ccccc3N2C(=O)c2cc[nH+]cc2)N(C(=O)c2cc[nH+]cc2)c2ccccc21 ; [Cl-] ; [Cl-]]

Compound 6 (0.060 mol; as prepared above) was introduced into a flask to which was added dichloromethane (1 L). A stream of hydrogen chloride gas was passed through the solution so formed at room temperature with occasional stirring. After a few minutes, the reaction mixture thickened and a precipitate formed. The mixture was allowed to stand under an atmosphere of HCl gas for 1 hour. The solvent was removed under vacuum and the product was co-evaporated with anhydrous DCM (2×50 mL) and dried to constant weight to afford a purple solid, compound 35 (quantitative yield).

Mw, C₂₈H₁₈N₄O₁₂Cl₂, 545; ¹H NMR (400 MHz, DMSO) δ 9.22 (bs, 4H), 8.28 (d, J=5.3 Hz, 4H), 8.08 (bs, 2H), 7.82-7.68 (m, 4H), 7.35 (t, J=12.7 Hz, 2H).

### Example 11: Synthesis of Compound 44

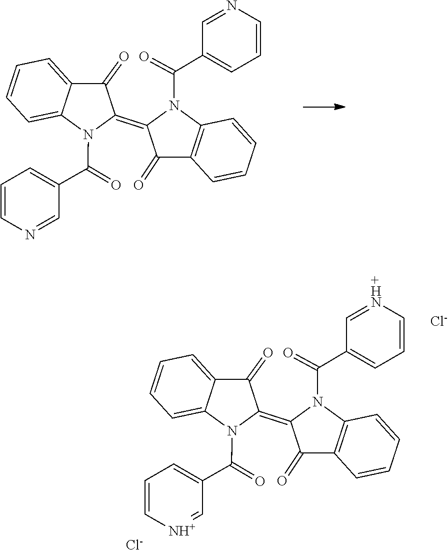

Compound 2 (0.060 mol; as prepared above) is introduced into a flask to which is added dichloromethane (1 L). A stream of hydrogen chloride gas is passed through the solution at room temperature with occasional stirring. After a few minutes, the reaction mixture thickens and a precipitate forms. The mixture is allowed to stand under an atmosphere of HCl gas for 1 hour. The solvent is removed under vacuum and the product is co-evaporated with anhydrous DCM (2×50 mL) and dries to constant weight.

### Example 12: Synthesis of Compound 37

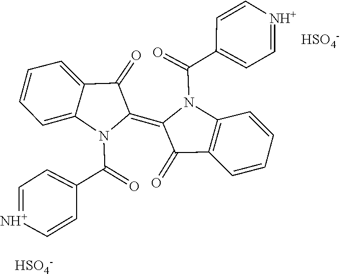

To a solution of compound 6 (5.0 g, 10.6 mmol) in dichloromethane (30 mL) at 0° C. under an atmosphere of argon was added a solution of anhydrous sulphuric acid (0.021 mol, 2.1 g) in methanol (25 mL) drop-wise with stirring over 30 mins. The mixture was allowed to stir at 0° C. for a further 30 mins and then allowed to warm to room temperature. After 1 hour, anhydrous diethyl ether (100 mL) was added and the mixture stirred for 10 mins and then stirring was stopped and the precipitated solid was allowed to settle. The supernatant was removed by a filtered cannula under argon pressure; this process was repeated twice using 50 mL of diethyl ether each time. The product was isolated in quantitative yield as a bright red solid (7.0 g).

Mw C₂₈H₂₀N₄O₁₂S₂, 668.47; mass analysis was consistent with the formation of the corresponding ion.

Compound 37 hydrolyzes to indigo under hydrolyzing conditions.

Reactions of Indigo with Alkoxy Ethers

### Example 13: Synthesis of Compound 13

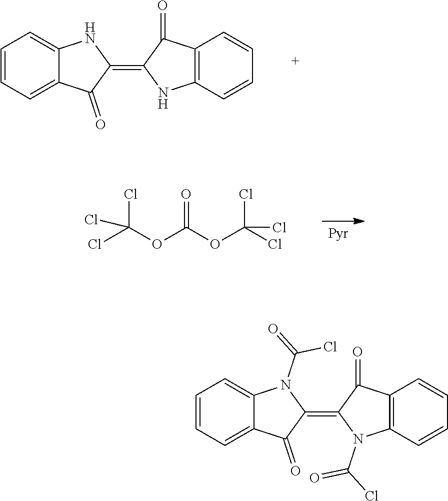 [SMILES: O=C1/C(=C2\Nc3ccccc3C2=O)Nc2ccccc21 ; O=C(OC(Cl)(Cl)Cl)OC(Cl)(Cl)Cl ; O=C1/C(=C2/C(=O)c3ccccc3N2C(=O)Cl)N(C(=O)Cl)c2ccccc21]

Triphosgene (23.8 g, 80 mmol) was added to pyridine at 0° C. and the mixture then allowed to warm to room temperature. After stirring for 30 mins at room temperature, indigo (10.5 g, 40 mmol) was added in one portion and the reaction allowed to stir overnight at room temperature. The mixture was then cooled in an ice bath and poured into ice cooled 4M HCl_{aq} with vigorous stirring and the precipitated solid was isolated by filtration. The solid was further washed with cold 4M HCl_{aq} followed by H₂O. The solid was then dried under vacuum at 40° C. to give a grey solid. This crude material was used for the following reactions.

### Example 14: Synthesis of Compounds 14, 25, 29, 30, and 33

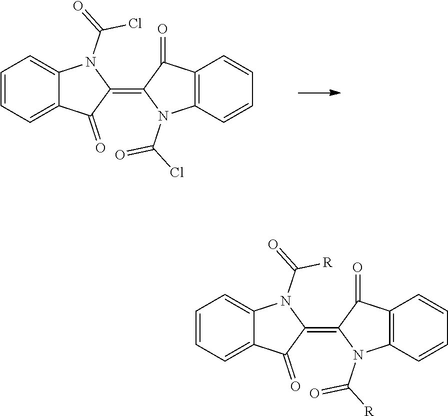

Compound 13 (3.0 g, 7.7 mmol) as prepared above) was suspended in the appropriate solvent (30 mL) and cooled in an ice-bath under an inert atmosphere. To this was added a THE solution of the alkoxy compound drop-wise (noted as “R” in Table 1) with stirring over 15 mins. The reaction mixture was allowed to stir at 0° C. for 1 hour and then allowed to warm to room temperature over 18 hours (the progress of the reaction was followed by TLC 5% MeOH/DCM). The solvents were removed under vacuum followed by addition of diethyl ether (200 ml) and stirred for 30 mins before decanting. The brown residue was taken up in DCM and purified using flash column chromatography. Fractions were characterized by ¹H NMR.

TABLE 1

| Compound | R | Solvent |
|---|---|---|
| 14 | 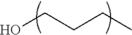 | Pyridine:THF (1:1) |
| 25 | 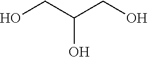 | Pyridine:THF (1:1) |
| 29 | 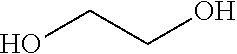 | Pyridine, 2 equiv Et₃N |
| 30 | 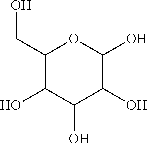 | Pyridine, 2 equiv Et₃N |
| 31 | 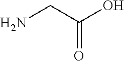 | THF |

Reactions of Leuco-Indigo

These reactions were carried out by generating leuco-indigo in-situ by oxidation of indigo by zinc and sodium acetate in the presence of acid chloride.

### Example 15: Synthesis of Compound 24B

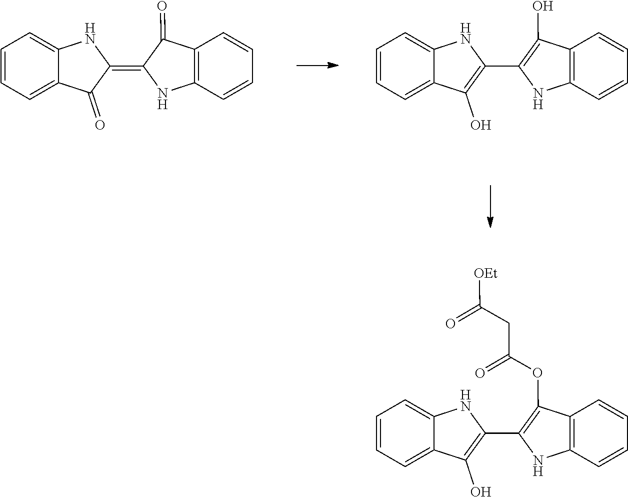 [SMILES: O=C1/C(=C2\Nc3ccccc3C2=O)Nc2ccccc21 ; Oc1c(-c2[nH]c3ccccc3c2O)[nH]c2ccccc12 ; CCOC(=O)CC(=O)Oc1c(-c2[nH]c3ccccc3c2O)[nH]c2ccccc12]

To a suspension of indigo (1.31 g, 5 mmol) in anhydrous ethyl acetate (50 mL) containing sodium acetate (1.03 g, 12.5 mmol) and zinc (3.25 g, 50 mmol) was added ethyl malonyl chloride (8.3 g, 50 mmol). The reaction mixture was allowed to stir for 30 mins at 40° C. The suspension was allowed to cool to room temperature and then concentrated to dryness. The residue was extracted with hot acetone. The crude material was purified using flash column chromatography eluting with 20% ethyl acetate:pet ether. The product was isolated as a pale yellow solid (0.5 g, 26%).

Mw=C₂₁H₁₈N₂O₅, 378.38; ¹H NMR (400 MHz, DMSO) δ 12.17 (s, 1H), 11.90 (s, 1H), 8.27 (d, 7.5 Hz, 1H), 7.57-7.45 (m, 3H), 7.32-7.20 (m, 3H), 7.15 (ddd, J=8.0, 7.0, 1.0 Hz, 1H), 4.05 (q, J=7.1 Hz, 2H), 3.82 (s, 2H), 1.12-1.05 (t, 7.1 Hz, 3H).

### Example 16: Synthesis of Compound 22

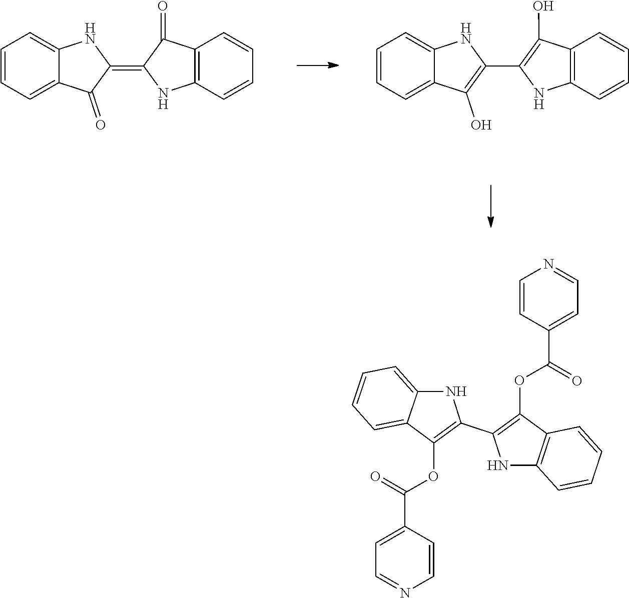 [SMILES: O=C1/C(=C2\Nc3ccccc3C2=O)Nc2ccccc21 ; Oc1c(-c2[nH]c3ccccc3c2O)[nH]c2ccccc12 ; O=C(Oc1c(-c2[nH]c3ccccc3c2OC(=O)c2ccncc2)[nH]c2ccccc12)c1ccncc1]

To a suspension of indigo (1.0 g, 3.8 mmol) in anhydrous ethyl acetate (50 ml) containing sodium acetate (0.8 g, 9.5 mmol) and zinc (2.49 g, 38 mmol) was added isonicotinoyl chloride (2.0 g, 11.4 mmol). The reaction mixture was allowed to stir for 30 mins at 40° C. The suspension was allowed to cool to room temperature and then concentrated to dryness. The residue was extracted with hot acetone. The crude material was purified using flash column chromatography eluting with 20% ethyl acetate:pet ether. The product was isolated as a pale yellow solid and was confirmed by ¹H NMR to be the di-substituted product, Compound 22 (0.4 g, 22%).

Mw, C₂₈H₁₈N₄O₄, 474.47; ¹H NMR (400 MHz, DMSO) δ 11.36 (s, 1H), 11.12 (s, 1H), 7.59 (d, J=8.0 Hz, 1H), 7.50 (dd, J=8.1, 0.9 Hz, 1H), 7.46-7.41 (d, 8.1 Hz, 1H), 7.36 (d, J=8.1 Hz, 1H), 7.16 (dddd, J=12.9, 8.2, 7.0, 1.2 Hz, 2H), 7.05 (ddt, J=8.1, 7.0, 1.1 Hz, 2H), 6.84 (dd, J=2.1, 0.8 Hz, 1H).

### Example 17: Synthesis of Compound 20

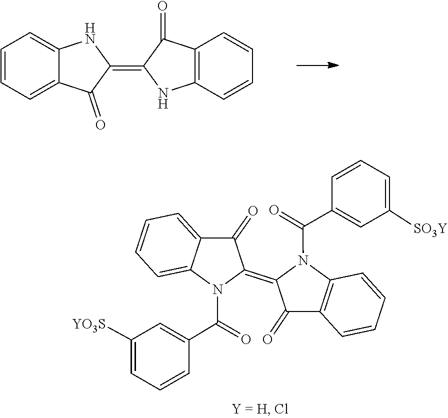

Indigo (0.824 g, 3.1 mmol) was dissolved in pyridine and to this was added 3-benzoyl chloride sulfonyl chloride (3 g, 12.4 mmol). The mixture was heated to 50° C. for 18 hours. After this time, the deep red mixture was poured onto cold water (100 ml) and stirred for 30 mins. The solid was isolated by filtration, dried under vacuum (1.98 g, 69% yield) and characterised.

### Example 18: Synthesis of Compound 27

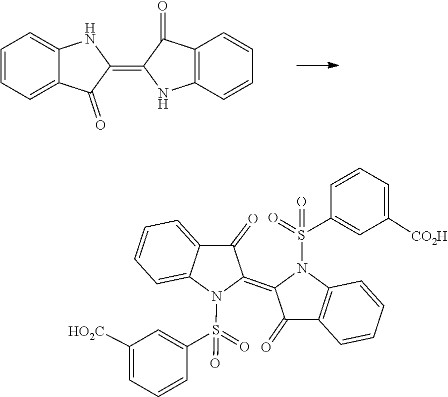 [SMILES: O=C1/C(=C2\Nc3ccccc3C2=O)Nc2ccccc21 ; O=C(O)c1cccc(S(=O)(=O)N2/C(=C3\C(=O)c4ccccc4N3S(=O)(=O)c3cccc(C(=O)O)c3)C(=O)c3ccccc32)c1]

Indigo (5.2 g, 20 mmol) was dissolved in pyridine and to this was added 3-sulphoyll chloride benzoic acid (17.4 g, 80 mmol). The mixture was heated to 50° C. for 18 hours. After this time, the deep red mixture was poured onto cold water (100 ml) and stirred for 30 mins. The mixture was concentrated under vacuum to remove pyridine and the crude material was purified by column chromatography. The main fraction isolated by characterised by ¹H NMR.

### Example 19: Synthesis of Compound 11

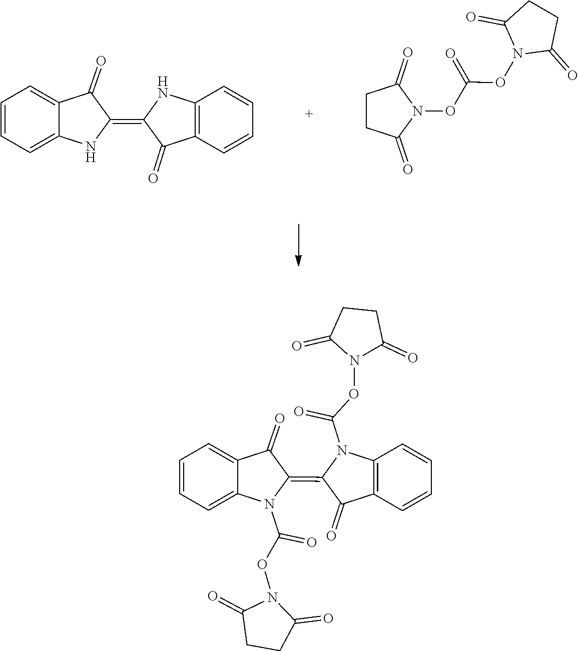 [SMILES: O=C1/C(=C2\Nc3ccccc3C2=O)Nc2ccccc21 ; O=C(ON1C(=O)CCC1=O)ON1C(=O)CCC1=O ; O=C1/C(=C2/C(=O)c3ccccc3N2C(=O)ON2C(=O)CCC2=O)N(C(=O)ON2C(=O)CCC2=O)c2ccccc21]

Indigo (2.62 g, 10 mmol) was added portion-wise to a suspension of N,N′-Disuccinimidyl carbonate (7.68 g, 30 mmol) in THE containing pyridine (0.125 mL) at 45° C. with rapid stirring. The reaction mixture was allowed to stir at this temperature for 48 hours (the progress of the reaction was monitored by TLC, 500 MeOH/DCM). After this time, TLC showed a considerable amount of un-reacted indigo was still present; this was removed by filtration and the solid washed with DCM. The organic filtrate was concentrated to dryness and re-dissolved in DCM, washed with NaHCO₃ followed by H₂O and then dried. Concentration under vacuum afforded a dark brown oil which was purified by column chromatography.

### Example 20: Synthesis of Compound 23

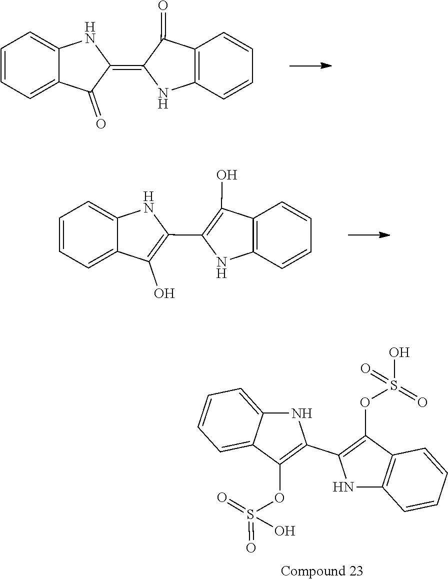 [SMILES: O=C1/C(=C2\Nc3ccccc3C2=O)Nc2ccccc21 ; Oc1c(-c2[nH]c3ccccc3c2O)[nH]c2ccccc12 ; O=S(=O)(O)Oc1c(-c2[nH]c3ccccc3c2OS(=O)(=O)O)[nH]c2ccccc12]

To a suspension of indigo (1.0 g, 3.8 mmol) in anhydrous ethyl acetate (50 mL) containing sodium acetate (0.8 g, 9.5 mmol) and zinc (2.49 g, 38 mmol) was added chlorosulfonic acid (2.2 g, 19 mmol). The reaction mixture was allowed to stir for 30 mins at 40° C. The suspension was allowed to cool to room temperature and then filtered to remove zinc. The yellow brown filtrate was concentrated to dryness to give dark yellow oil.

### Example 21: Synthesis of Compound 24A

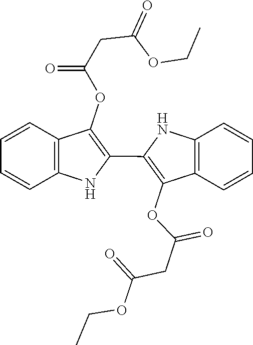 [SMILES: CCOC(=O)CC(=O)Oc1c(-c2[nH]c3ccccc3c2OC(=O)CC(=O)OCC)[nH]c2ccccc12]

To a suspension of indigo (1.31 g, 5 mmol) in anhydrous ethyl acetate (50 mL) containing sodium acetate (1.03 g, 12.5 mmol) and zinc (3.25 g, 50 mmol) is added ethyl malonyl chloride (8.3 g, 50 mmol). The reaction mixture is allowed to stir at 40° C. for at least 1 hour. The suspension is allowed to cool to room temperature and then concentrates to dryness. The residue is extracted with hot acetone. The crude material is purified using flash column chromatography eluting with 20% ethyl acetate:pet ether.

### Example 22: Synthesis of Compound 38

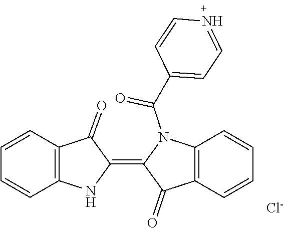 [SMILES: O=C1/C(=C2/C(=O)c3ccccc3N2C(=O)c2ccncc2)Nc2ccccc21 ; [Cl-]]

This compound is prepared using the procedure for Compound 18 in Example 6 using the corresponding free base.

### Example 23: Synthesis of Compound 39

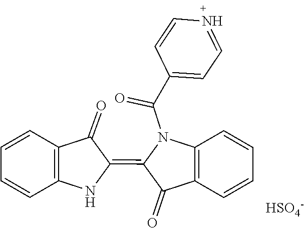

This compound is prepared using the procedure for Compound 37 in Example 12 using the corresponding free base.

### Example 24: Synthesis of Compound 43

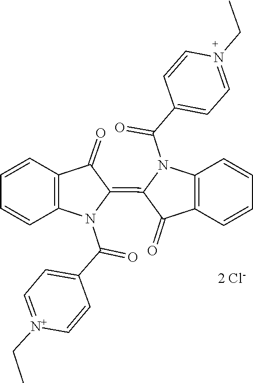

This compound is prepared by dissolving Compound 6 in DCM, followed by addition of chloroethane gas in dichloromethane/ethanol, dichloromethane/Bu₄N⁺Br⁻, ethanol, ethanol/pyridine, or isopropanol in a sealed pressure tube at 100° C. The compound was then purified and isolated.

### Example 25

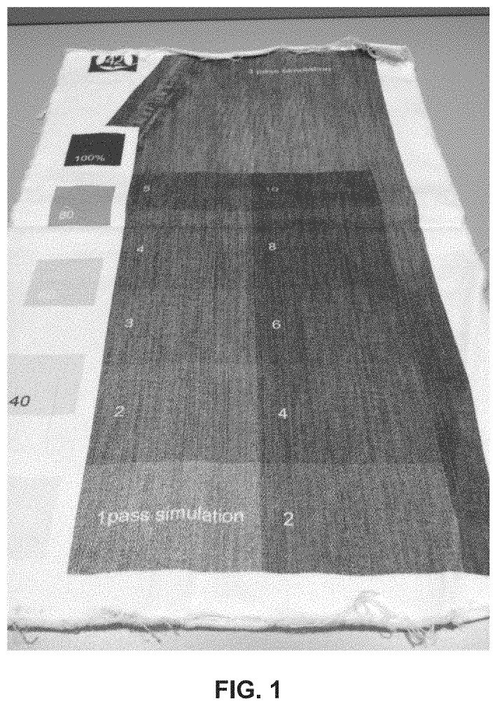

Digitally printed denim sample prepared using an aqueous-based ink containing 12% Compound 8. The formulation consisted of 20 g of distilled water, 2.4 g compound 8, 1 g hydroxypropylcellulose, 1.42 g sodium sulfate, and 0.4 g Ecosurf EH-9 surfactant. The ink was printed using an Epson Artisan 1430 digital printer in which two of the four cartridges were loaded with the ink formulation above. The remaining two cartridges were filled with the following clear formulation: 2 g glycerol, 18 g 0.01 M sulfuric acid, 0.2 g Ecosurf EH-9 surfactant. See, FIG. 1.

### Example 26

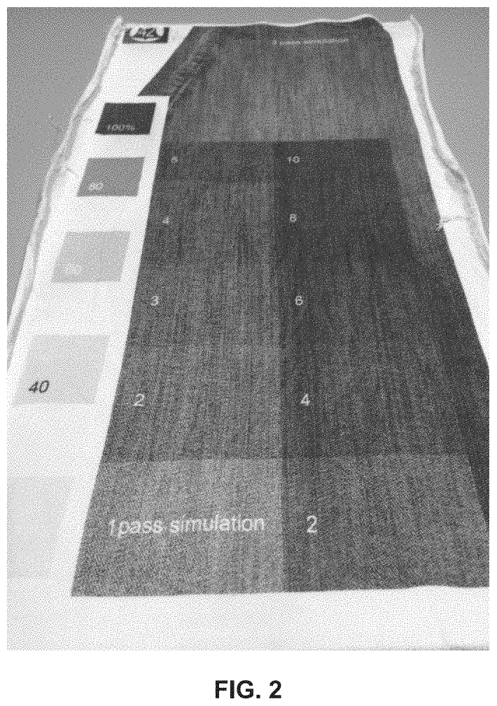

Digitally printed denim sample prepared using a solvent-based ink containing 20% Compound 8. The formulation consisted of 7.5 g diethyleneglycol ethyl ether, 7.5 g butyrolactone, 5 g triethyleneglycol monomethylether, 2.4 g compound 8, and 0.5 g hydroxypropylcellulose. The ink was printed using an Epson Artisan 1430 digital printer in which two of the four cartridges were loaded with the ink formulation above. The remaining two cartridges were filled with the following clear formulation: 20 g 0.01 M sulfuric acid, 0.6 g hydroxypropylcellulose, 0.2 g Ecosurf EH-9 surfactant. See, FIG. 2.

### Example 27

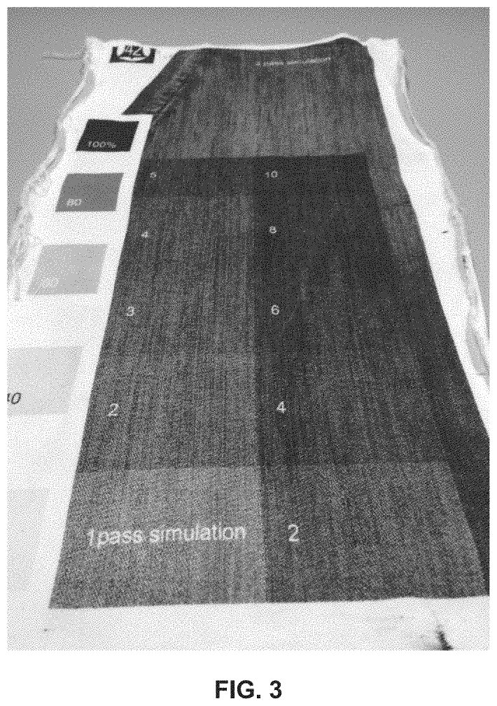

Digitally printed denim sample prepared using a solvent-based ink containing 40% Compound 8. The formulation consisted of 7.5 g diethyleneglycol ethyl ether, 7.5 g butyrolactone, 5 g triethyleneglycol monomethylether, 8 g compound 8, and 0.3 g hydroxypropylcellulose. The ink was printed using an Epson Artisan 1430 digital printer in which two of the four cartridges were loaded with the ink formulation above. The remaining two cartridges were filled with the following clear formulation: 20 g 0.01 M sulfuric acid, 0.6 g hydroxypropylcellulose, 0.2 g Ecosurf EH-9 surfactant. See, FIG. 3.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

1.-103. (canceled)

104. A method of digital printing on a substrate, comprising applying an ink formulation comprising a dye compound to a substrate, the dye compound comprising an indigo derivative, or a salt thereof, wherein the compound is of Formula (I): 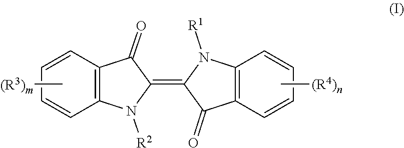
wherein:
R¹ and R² are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted heteroaryl), C(O)-(optionally substituted heterocyclyl), C(O)-(optionally substituted C₁₋₆hydroxyalkyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), C(O)O-(optionally substituted heterocyclyl); or
R³ and R⁴ are, independently, H, halide, optionally substituted C₁₋₆alkyl, optionally substituted C₁₋₆hydroxyalkyl, optionally substituted C₁₋₆alkoxy, optionally substituted aryl, or SO₃H;
R⁷ and R⁸ are, independently, H, SO₃R^{C}, SO₂R^{C}, PO₃(R^{C})₂, C(O)NR^{A}R^{B}, C(O)-(optionally substituted C₁₋₆alkyl), C(O)-(optionally substituted aryl), C(O)-(optionally substituted C₁₋₉glycolyl), C(O)-(optionally substituted C₁₋₆hydroxyalkyl), C(O)-(optionally substituted heteroaryl), C(O)-(optionally substituted heterocyclyl), C(O)O-(optionally substituted C₁₋₆alkyl), C(O)O-(optionally substituted aryl), C(O)O-(optionally substituted C₁₋₉glycolyl), C(O)O-(optionally substituted C₁₋₆hydroxyalkyl), C(O)O-(optionally substituted heteroaryl), or C(O)O-(optionally substituted heterocyclyl);
R^{A} and R^{B} are, independently, H or optionally substituted C₁₋₆alkyl, or optionally substituted aryl;
R^{C} is H, optionally substituted C₁₋₆alkyl, optionally substituted C₃₋₈cycloalkyl, optionally substituted aryl, optionally substituted heteroaryl, or optionally substituted heterocyclyl;
m and n are, independently, 0 to 4;
or a salt thereof,
wherein the indigo derivative has a water-solubility of greater than 0.2% w/v in the absence of a reducing agent and in the presence of oxygen, and converts to indigo upon removing the modification, wherein the chemical structure of indigo is the following:

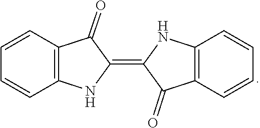 [SMILES: O=C1/C(=C2\Nc3ccccc3C2=O)Nc2ccccc21]

105. The method of claim 1, wherein the formulation comprises an organic solvent selected from the group consisting of ethylene glycol, propylene glycol, glycerol, diethylene glycol dimethyl ether, diethylene glycol monomethyl ether, diethylene glycol monoethyl ether, diethylene glycol monobutyl ether, ethylene glycol monopropyl ether, triethylene glycol monomethyl ether, triethylene glycol monoethyl ether, tripropylene glycol monomethylether, tripropylene glycol monoethylether, 2-butoxyethanol, 2-ethoxyethanol, 2-methoxyethanol, ethyl lactate, N-propyl lactate, butyrolactone, and combinations thereof.

106. The method of claim 1, wherein the formulation further comprises one or more of a component for digital printing, water, surfactant, viscosity modifier, wetting agent, thickening agent, chelating agent, color retention agent, penetration enhancer, pH buffering agent, salt, solubilizing agent, colorant, or stabilizing agent.

107. The method of claim 1, further comprising pretreating the substrate, wherein the pretreating comprises contacting the substrate with one or more of an anti-migrant, pH buffering agent, cationic agent, anionic agent, humectant, hydrolysis catalyst, agent that improves color yield, or alkali agent.

108. The method of claim 1, further comprising drying the substrate, wherein the substrate is dried at a temperature of about 50 to about 120° C.

109. The method of claim 1, further comprising hydrolyzing the substrate to convert the dye compound to indigo.

110. The method of claim 6, wherein the hydrolyzing is performed using a spray or by submersing the dye substrate into a hydrolysis bath.

111. The method of any one of claim 7, wherein the hydrolyzing is performed using steam, heat, or a combination thereof.

112. The method of claim 1, further comprising applying a clear aqueous ink to the substrate, wherein the clear aqueous ink comprises one or more of an anti-migrant, pH buffering agent, cationic agent, anionic agent, viscosity modifier, hydrolysis catalyst, alkali agent, chelating agent, salt, surfactant, thickening agent, or wetting agent.

113. The method of claim 9, wherein the clear aqueous ink is an anti-migrant that is applied concurrently with the dye compound or after the dye compound.

114. The method of claim 1, further comprising depositing the dye compound concurrently with one or more of a textile digital printing ink, the textile digital printing ink being selected from the group consisting of a pigment, reactive dye, acid dye, vat dye, direct dye, sulfur dye, natural dye, basic dye, and combinations thereof.

115. The method of claim 1, wherein the ink formulation comprising the dye compound is jetted from a digital printer.

116. The method of claim 1, wherein the dye compound is not:
(i) N,N′-dinicotinoyl-[2,2′-biindolinylidene]-3,3′-dione;
(ii) the N″,N′″-methylpyridinium bis(methylsulfate) salt of N,N′-dinicotinoyl-[2,2′-biindolinylidene]-3,3′-dione;
(iii) N,N′-diacetyl-[2,2′-biindolinylidene]-3,3′-dione;
(iv) N,N′-dipropionyl-[2,2′-bi-indolinylidene]-3,3′-dione;
(v) N,N′-di-isobutyryl-[2,2′-biindolinylidene]-3,3′-dione;
(vi) N,N′-dipivaloyl-[2,2′-biindolinylidene]-3,3′-dione;
(vii) N,N′-bis(cyclohexylcarbonyl)-2,2′-bi-indolinylidene-3,3′-dione;
(viii) N,N′-bis(3-phenylpropionyl)-2,2′-bi-indolinylidene-3,3′-dione;
(ix) N,N′-bis(ethoxycarbonylacetyl)-2,2′-bi-indolinylidene-3,3′-dione;
(x) N,N′-bis(2-phenylacetyl)-[2,2′-bi-indolinylidene]-3,3′-dione;
(xi) N,N′-bis-(p-methoxyphenylacetyl)2,2′-bi-indolinylidene-3,3′-dione;
(xii) N,N′-bis(1-naphthylacetyl)-2,2′-bi-indolinylidene-3,3′-dione;
(xiii) N,N′-bis(2-phenylbutyryl)-2,2′-indolinylidene-3,3′-dione;
(xiv) (E)-1,1′-di(adamantane-1-carbonyl)-[2,2′-biindolinylidene]-3,3′-dione;
(xv) 1H,1′H-[2,2′-biindole]-3,3′-diyl diacetate;
(xvi) 3,3′-bis(phenylacetoxy)-2,2′-bi-indolyl;
(xvii) 3,3′-bis(p-methoxyphenylacetoxy)-2,2′-bi-indolyl;
(xviii) 3,3′-bis(1-napthylacetoxy)-2,2′-bi-indolyl;
(xix) 3,3′-bis(phenylbutyryloxy)-2,2′-bi-indolyl;
(xx) 3,3′-bis(pivaloyloxy)-2,2′-bi-indolyl;
(xxi) 3,3′-bis(1-adamantylcarbonyloxy)-2,2′-bi-indolyl; or
(xxii) 3,3′-bis(ethoxycarbonylacetoxy)-2,2′-bi-indolyl.

117. The method of claim 1, wherein when the compound is of Formula (I), R³ and R⁴ are not H, when R¹ and R² are both 1-methyl-pyridyl-3-yl.

118. The method of claim 1, wherein one or both of R¹ and R² is H.

119. The method of claim 1, wherein one or both of R¹ and R² is C(O)-(optionally substituted pyridyl).

120. The method of claim 16, wherein the optionally substituted pyridyl is substituted on the N-atom with C₁₋₆alkyl.

121. The method of claim 1, wherein the dye compound is of Formula (IB) or (IC): 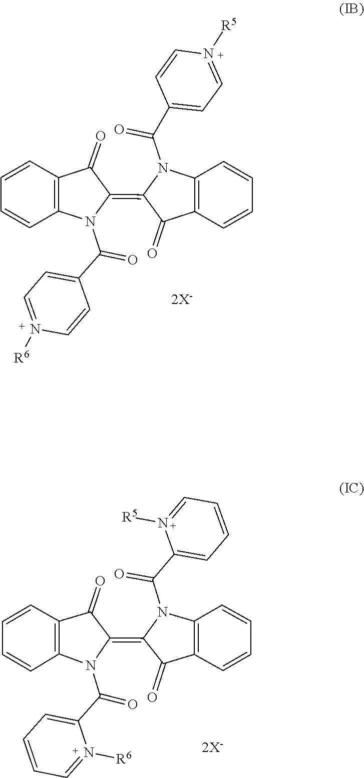
wherein:
R⁵ and R⁶ are, independently, H or C₁₋₆alkyl; and
X is halide, sulfate, C₁₋₆alkylsulfate, bisulfate, or phosphate.

122. The method of claim 1, wherein the dye compound is: 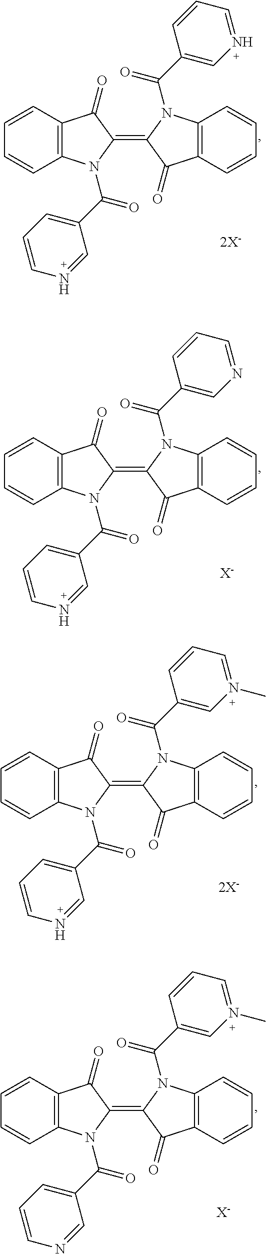 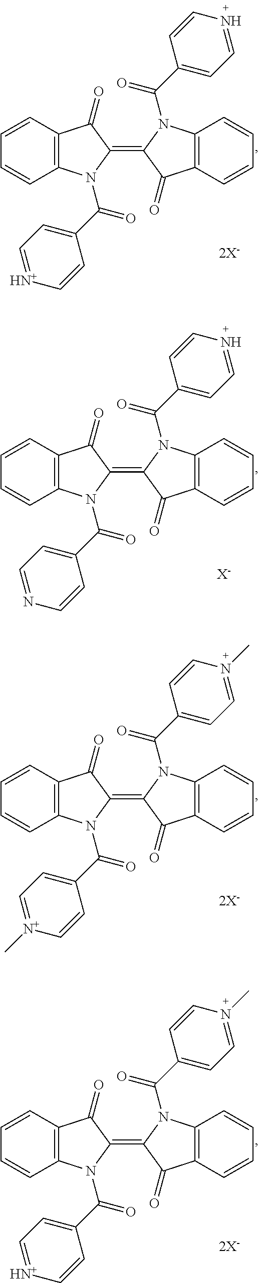 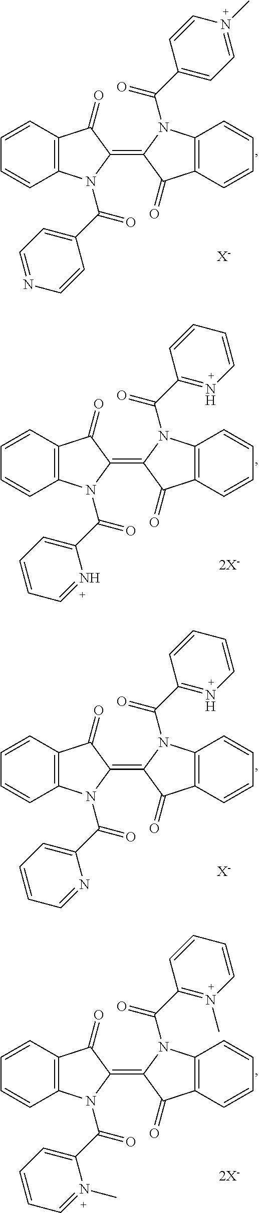 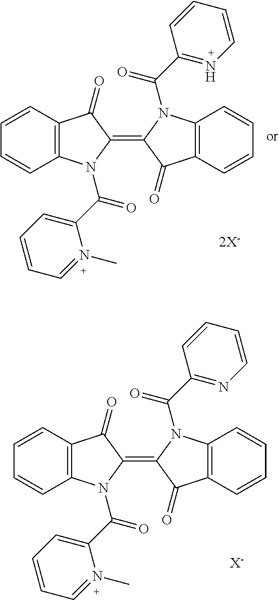
wherein X is a counteranion.

123. The method of claim 1, wherein the dye compound is: 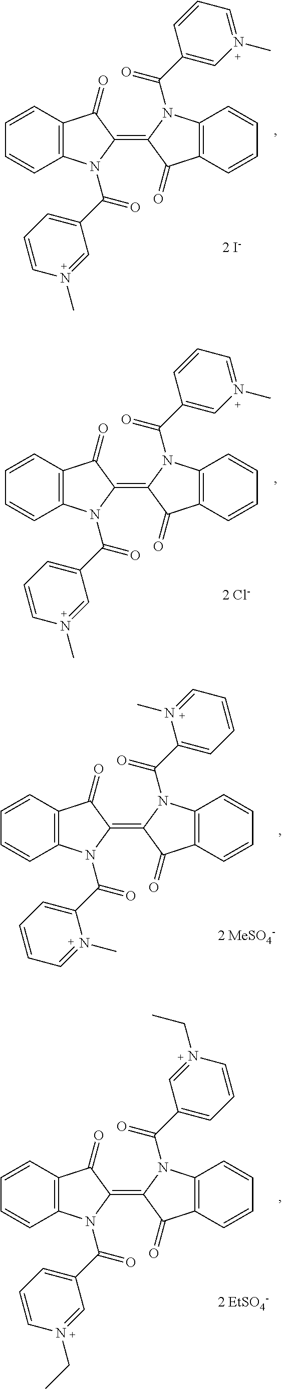 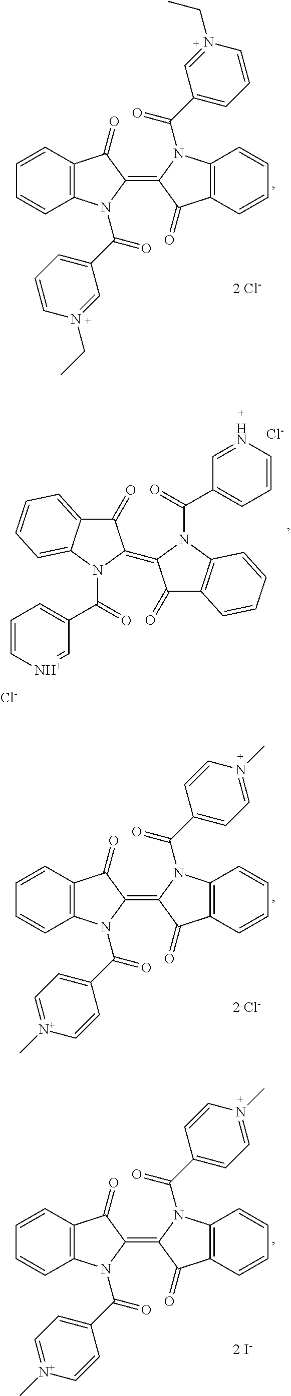 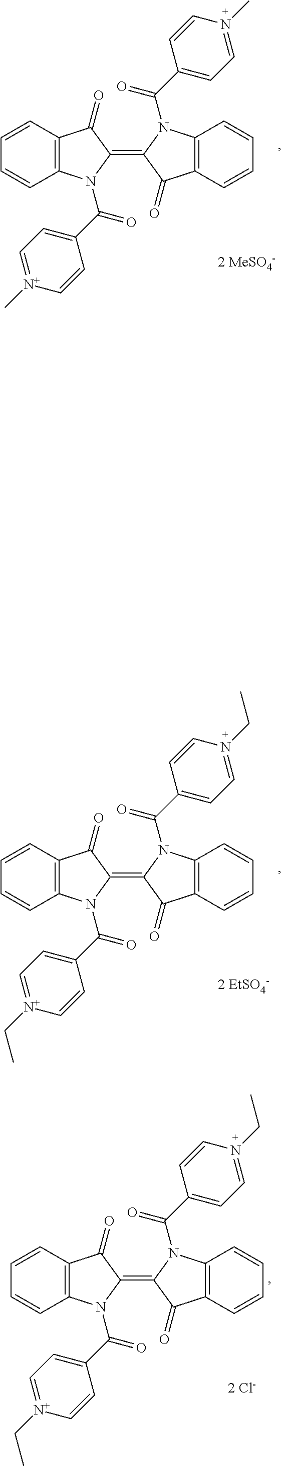 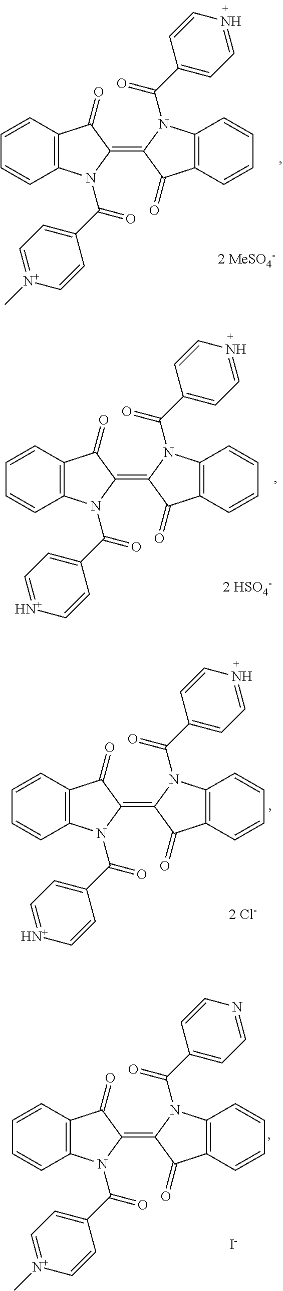 [SMILES: C[n+]1ccc(C(=O)N2/C(=C3\C(=O)c4ccccc4N3C(=O)c3ccncc3)C(=O)c3ccccc32)cc1 ; O=C1/C(=C2/C(=O)c3ccccc3N2C(=O)c2cc[nH+]cc2)N(C(=O)c2ccncc2)c2ccccc21 ; O=C1/C(=C2/C(=O)c3ccccc3N2C(=O)c2cc[nH+]cc2)N(C(=O)c2ccncc2)c2ccccc21 ; C[n+]1ccc(C(=O)N2/C(=C3\C(=O)c4ccccc4N3C(=O)c3ccncc3)C(=O)c3ccccc32)cc1 ; [I-]] 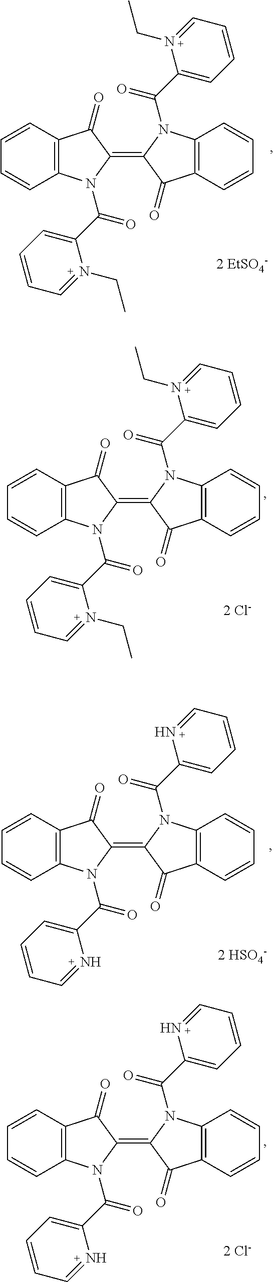 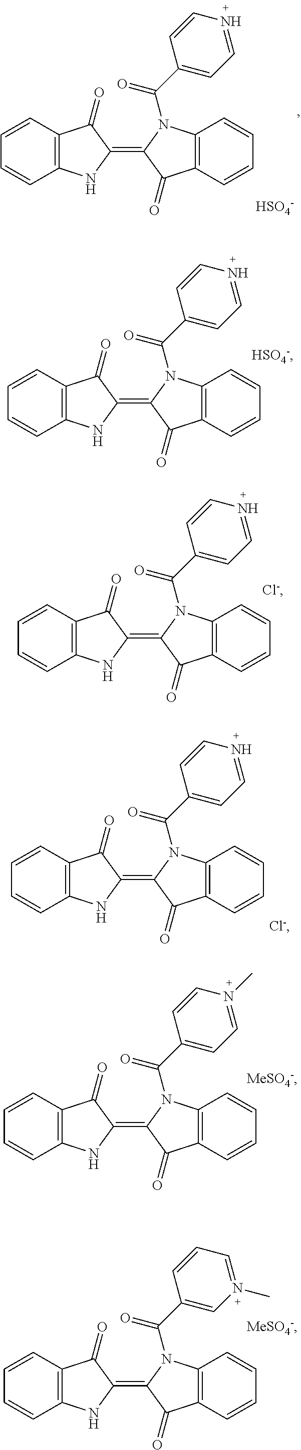 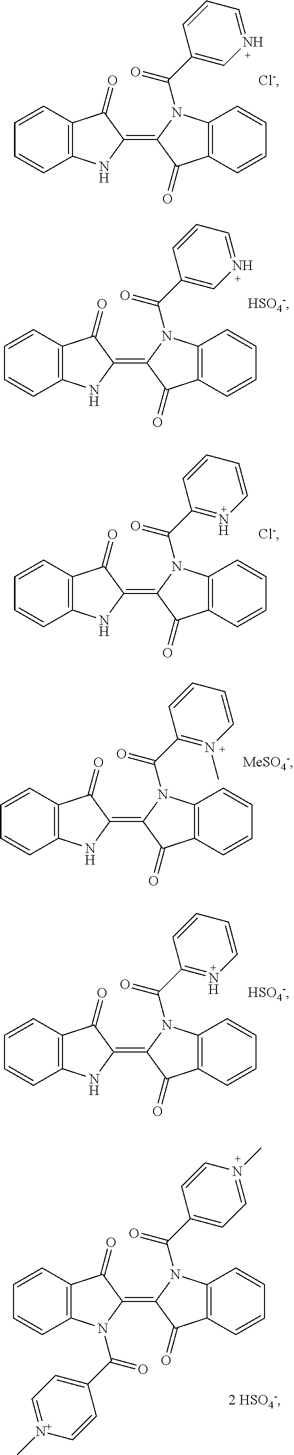
or a salt thereof.
